(19) United States
(12) Patent Application Publication
(10) Pub. No.: US 2025/0072428 A1
(43) Pub. Date: Mar. 6, 2025

(54) CONTROL OF PYROLYSIS CONDITIONS FOR THE PRODUCTION OF DESIRABLE COMPOUNDS

(71) Applicant: Talipot Cool Extract (IP), LLC, La Jolla, CA (US)

(72) Inventors: Matthew William Smith, Camarillo, CA (US); Haijun Wan, Camarillo, CA (US); Kevin Daniel Dolinar, Ventura, CA (US); Juliette MacKay, Newbury Park, CA (US)

(21) Appl. No.: 18/732,435

(22) Filed: Jun. 3, 2024

Related U.S. Application Data
(63) Continuation-in-part of application No. 17/891,091, filed on Aug. 18, 2022.
(63) Continuation-in-part of application No. 17/531,663, filed on Nov. 19, 2021.
(63) Continuation-in-part of application No. 17/409,770, filed on Aug. 23, 2021.
(63) Continuation-in-part of application No. 17/485,440, filed on Sep. 26, 2021.
(60) Provisional application No. 63/470,410, filed on Jun. 1, 2023.

(51) Int. Cl. A01N 61/00; A01P 21/00; C10B 53/02

(52) U.S. Cl. CPC A01N 61/00; A01P 21/00; C10B 53/02

(57) ABSTRACT

The present invention relates to (1) a method for producing biochar having bio stimulating effects, (2) biochar that has been produced to having increased bio stimulating effects, (3) a method for capturing material extracted from biochar and (4) biochar extracts, comprising desired compounds extracted from biochar and suspended in an extract solution. The methods above all involve obtaining a particular biomass source and pyrolyzing the biomass source under specific conditions to increase the bio stimulating effects of the biochar. The method for capturing the material extracted from the biochar produced to have such stimulating effects includes contacting the biochar with a treating liquid, separating the biochar from the biochar extract, collecting the biochar extract from which the biochar has been separated and resuspending the biochar extract in an modified aqueous solution for further use and/or processing separate from, or prior to, disposal. The biochar extract suspended in solution then includes desired compounds (a) at least 0.1 ppm of one or more of the following phenylpropanoid, phenylalanine, flavonoids, sterols, terpenes, terpenoids, tannins, coumarins, benzaldehydes and phenols; (b) at least 0.1 g/L of humics, fulvics or a combination of both humics and fulvics and/or (c) one or more of the following salicylic acid, jasmonic acid, abscisic acid, cytokinin, gibberellic acid and ethylene, by way of example.

### CROSS-REFERENCE TO RELATED APPLICATIONS

This application claims priority to U.S. Provisional Appln. No. 63/470,410, filed Jun. 1, 2023, titled Control of Pyrolysis Conditions the Production of Desirable Compounds; this application is also a continuation-in-part of U.S. patent application Ser. No. 17/891,091, filed on Aug. 18, 2022, titled Control of Pyrolysis Conditions and Feedstock for the Production of Desirable Compounds; this application is also a continuation-in-part of U.S. patent application Ser. No. 17/531,663, filed on Nov. 19, 2021, titled Biochar Suspended Solution; this application is also a continuation-in-part of U.S. patent application Ser. No. 17/409,770, filed on Aug. 23, 2021, titled Biochars, Biochar Extracts and Biochar Extracts Having Soluble Signaling Compounds and Method for Capturing Material Extracted from Biochar; this application is also a continuation-in-part of U.S. patent application Ser. No. 17/485,440, filed on Sep. 26, 2021, titled Biochar Coated Seeds; all of the above applications and patents of what are incorporated into this application in their entirety by reference.

### FIELD OF INVENTION

The invention relates to the production of biochars having desirable organic compounds through controlled pyrolysis of selected biomass. This invention also relates to using these biochars to improve and support plant health, growth, and yield. This invention additionally relates to extracting the desirable residual organic compounds, particularly soluble signaling compounds, from these biochars to produce a biochar extract with the desired compounds to be used to improve and support plant health, growth, and yield.

### BACKGROUND

Biochar is most commonly created by the pyrolysis of biomass, which generally involves heating and/or burning of organic matter, in a reduced oxygen environment, at a predetermined rate. Such heating and/or burning is stopped when the matter reaches a charcoal like stage-resulting in biochar. Biochars include porous carbonaceous materials, such as charcoal, and have been used for many years as a soil amendment or enhancer. Due to its highly porous structure, biochars can host beneficial microbes, retain nutrients and supplements, and hold liquids for agricultural applications, and improve plant growth.

In addition to the benefits to plant growth, yield and quality, etc.; biochar provides the benefit of reducing carbon dioxide (CO₂) in the atmosphere by serving as a method of carbon sequestration. Thus, biochar has the potential to help mitigate climate change, via carbon sequestration. In particular, biochar is unique in its ability to increase agricultural production, without increasing carbon dioxide emission, and preferably reducing the amount of carbon dioxide in the atmosphere.

Using biochar at high rates (5-50 tons/ha) has been shown to have beneficial impacts on plant growth and yield, due to the improved soil health properties. However, currently the use of biochar has mostly been a scientific curiosity, not found in widespread agricultural use or large-scale commercial applications, and instead has been relegated to small niche applications. As such, this unique ability of biochar has not been realized, or seen, because of both the inherent problems and failings of prior biochars including, high volumes of use needed (and thus high cost), difficulties in application (granular product with dust and/or flow issues), and dramatic product inconsistencies. Methods are needed to overcome these inherent problems with the use of biochar so that the benefits of biochar can be realized.

Due to various factors, including but not limited to compounds added before, during or after pyrolysis, feedstock, pyrolysis method, pyrolysis conditions, post-pyrolysis storage, and post-pyrolysis treatment, biochars may contain significant or important residual compounds, many of which are organic. The amount and type of residual organic compounds will vary between biochars, but often include a mixture of fatty acids, aromatics, phenolics, and ketones. Similarly, inorganic compounds potentially containing plant macro- and micronutrients as well as other substances that may be beneficial to plants or microbial life may be present on or in the carbon matrix of the biochar. In some cases, extracting residual compounds from the biochar can improve the resulting biochar properties for various applications, especially for example when the compounds are deleterious. In other cases, the extracted residual compounds are themselves desirable for various applications, thus the extraction of residual compounds from the biochar allows for the production of a mixture of these residual compounds, preferably in a solution. A method to collect specific residual compounds of interest or of use is particularly desirable.

### SUMMARY

The present invention relates to methods for creating a biochar with desirable residual compounds, extracting these compounds, and then using these extracted compounds in various forms in agriculture and horticulture to support plant health, growth, and yield. The present invention also relates to the composition of the resulting desirable biochar and the composition of the resulting biochar extract with desirable compounds.

The method includes ways to selectively pyrolyze biomass to create biochars with desired residual compounds, particularly residual organic compounds. The method also includes ways to post treat the biochar to adjust the residual compounds to be more desirable. For example, the resulting biochar may include one or more of the following types of desirable compounds: soluble signaling compounds, plant growth promoting regulator compounds (PGRs), or active biostimulant compounds, such as humic & fulvic acids. Desirable soluble signaling compounds may include, for example, phenylpropanoid, phenylalanine, flavonoids, sterols, terpenes, terpenoids, tannins, coumarins, phenols, cyanohydrins, butenolides and/or karrikins, where the karrikin levels may exceed 10 ng/g. Desirable plant growth regulating compounds may include salicylic acid, jasmonic acid, abscisic acid, cytokinin, gibberellic acid, and/or ethylene. Desirable biostimulant compounds may include humic and fulvic acids as well as carbohydrate derivatives that support microbial communities. For purposes of this application, all such desirable compounds, including but not limited to soluble signaling compounds, plant growth promoting regulator compounds (PGRs) and active biostimulant compounds, shall be referred to herein as “target compounds” or “desirable compounds.”

The invention also includes the resulting desirable biochar itself and methods for its use and application including seed coating and biochar slurries. For example, the biochar may be derived from a source of biomass that, together with predefined pyrolysis parameters, results in the biochar having karrikin levels that exceeds 10 ng/g, or in some cases, that exceeds 40 ng/g.

The method also includes ways to selectively extract certain compounds or certain groups of compounds from the biochar. The method may include ways to purify or concentrate the extracted organic and inorganic compounds into more useful products or mixtures. The invention also includes the resulting biochar extract itself and methods for its use and application, such as seed treatment, foliar, or soil application.

For example, according to one example, the method for capturing material extracted from biochar may include (i) providing or producing a biochar that includes target compounds; (ii) contacting the biochar with an extraction media, wherein the extraction media removes at least some of the target compounds from the biochar, thereby creating a biochar extract containing target compounds; and (iii) collecting the biochar extract.

The extraction media used may be water, acid solution, alkaline solution, alcohol, another polar solvent, or a combination thereof. The biochar extract, once collected, may be further processed to remove the majority of biochar particles or to concentrate the target compounds, or to remove inhibitory compounds. Compounds may be isolated by distillation, precipitation, liquid-liquid extraction using non-miscible solvents of varying polarity, or chromatography.

The biochar extract may also be combined with preservatives to retard microbial growth during storage. Potential preservatives used may include, but are not limited to, organic acids and their conjugate bases, such as: sorbic acid, acetic acid, benzoic acid, citric acid, and lactic acid; isothiazolinones, such as: benzisothiazolinone and methylisothiazolinone; glycols; alcohols; phenoxyethanol; and parabens. Final extract formulations may also include non-reactive compounds. These non-reactive compounds may be used to adjust density and solution polarity such as using polyethylene glycol (PEG) or to improve mixing and application properties such as using surfactants or other wetting agents. The biochar extract can be used alone or mixed with other agricultural products, such as fungicides, herbicides, insecticides, fertilizers, or other biostimulant products such as microbials, microbial metabolites, plant and algae extracts, humic acids and fulvic acids etc. The biochar extract or biochar extract mixture may be applied to seeds, plants or plant parts (e.g. leaves or roots), soils, or other substrates, including peat, coir, sand, or biochar.

One extraction method may optimize the remaining level of a specific residual compound, for example, karrikins on the residual char. Another iteration of this process may utilize two or more different extraction techniques to sequentially extract selected classes of compounds into multiple distinct extracts. The biochar extraction may be further processed to concentrate the amount of extracted compounds in the extract and/or to selectively isolate desired or undesired compounds substances. In some examples, the biochar extract may even be further treated with surfactant to improve the availability and effectiveness of the soluble signaling compounds.

In some examples, the biochar extract may include properties that improve seed germination and early plant development, may have karrikin levels that exceed 5 ppt or even 1 ppt, and/or have high levels of soluble signaling compounds that are known to increase seed germination rates and early plant growth. The biochar extract may include target compound, for example, signaling compounds like cyanohydrins, butenolides, and/or karrikins.

A further method is provided for applying biochar extract as a seed treatment at preferably low rates. Biochar extract may be applied to seeds, compounded into initial seed treatment package, or as an overtreatment at rates of less than 10 fl. oz/100 lb. seeds, or preferably at less than 5 fl. oz/100 lb. seeds, or even more preferably at less than 2 fl. oz/100 lb. seeds or most preferably at or below 1 fl. oz/100 lb. seeds.

Yet another method is provided for applying biochar extract to soil or other substrate either at planting near the seed, or at transplanting or after planting in the rhizosphere of plant at low use rates. Biochar extract may be applied as a stand-alone product or mixed with other liquid or granular inputs such as fertilizer or water at rates of less than 25 fl, oz/Acre, or preferably at less than 10 fl, oz/Acre, or even more preferably at less than 5 fl, oz/Acre, or most preferably at or below 2 fl, oz/Acre.

Yet another method is provided for applying biochar extract to the plant itself for example as a foliar spray, root dip, or as part of water irrigation system. This is particularly useful in systems such as hydroponics and vertical farming.

Other devices, apparatus, systems, methods, features and advantages of the invention are or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention.

FIG. 1 is a chart showing various pH ranges and germination for treated biochars.

FIG. 2 is a table showing the test results of various biochars for acid number and biostimulating effects.

FIG. 3 is a Thermogravimetric Analysis (TGA) plot showing the measurement of water content, heavy organics and light organics in a sample.

FIG. 4 is an example of a Thermogravimetric Analysis (TGA) plot which shows how the type and amount of residual organic compounds can vary for biochars from the same source.

FIG. 5 illustrates the deconvolution of a TGA spectrum.

FIG. 6 is a chart showing the compositional analysis of the resulting ash from two different raw biochars, from different feedstocks.

FIG. 7 illustrates the operation of a fixed bed batch reactor.

FIG. 8 is a charting showing the effect of torrefaction/pyrolysis temperatures between 275 and 375° C. on the composition of collected vapors.

FIG. 9 is a chart that shows the effect of pyrolysis temperature on the biochar/biomass mixture.

FIG. 10 illustrates the effect of biochar filter on pyrolysis vapors composition at 375° C.

FIG. 11 illustrates the effects of secondary heating on biochar saturated in pyrolysis vapors.

FIG. 12 is a TGA plot showing biochars produced in a fixed batch kiln.

FIG. 13 is a chart that shows a temperature series produced using a continuous rotary kiln.

FIG. 14 is a chart that shows the effect of the introduction of a carrier gas on pyrolysis.

FIGS. 15A and 15B are charts that show a comparison of extracts from several biochars produced at 400° C. in a rotary kiln furnace under different atmospheric conditions.

FIG. 16 is a chart showing the results of extracts tested as a seed treatment on hybrid corn at a rate of 1 oz per 100 lbs of seed extracts for each biochar tested.

FIG. 17 is a chart showing the effect of kiln pressure on extractable residual chemistry.

FIG. 18 is a chart showing the amount of extractable compounds from torrefied/pyrolyzed wood chips at various retention times, relative intensity and temperatures.

FIG. 19 is a flow chart process diagram of one implementation of a process for treating the raw biochar in accordance with the invention.

FIG. 20 illustrates a schematic of one example of an implementation of a biochar treat processes that that includes washing, pH adjustment and moisture adjustment.

FIG. 21 illustrates yet another example of an implementation of a biochar treatment processing that includes additive or reactant impregnation.

FIG. 22 is a schematic flow diagram of one example of a treatment system for use in accordance with the present invention.

FIG. 23 is a chart showing the results of treating raw biochar vs. treated biochar using the treatment process of the present invention to extract semi-volatile residual organic compounds in the biochar.

FIG. 24 is an image showing the resulting concentrated extracts using acetone as the extraction liquid from raw biochars sourced from coconut and pine feedstocks.

FIG. 25 is a flow chart illustrating that there can be from 1 to N extraction liquids and from 1 to N output streams resulting from a single stage of the treatment process of the present invention.

FIG. 26 illustrates two charts showing the results of biochar material before and post treatment and demonstrates inorganic removal through treatment where the extraction mechanism is generally physical.

FIG. 27 is a flow chart illustrating how multiple extracts may be generated from the same input material using the treatment process of the present invention.

FIG. 28 is a flow chart illustrating how solids and the liquids may also be separated from the extract resulting from the treatment process of the present invention.

FIG. 29 is a flow chart illustrating how raw or treated biochar can also be combined, reinfused, or treated with extracts from other biochars.

FIG. 30a-e illustrate how phytotoxic biochar can become harmless and a harmless biochar can become phytotoxic when the residual organic compounds are extracted from each of the biochars and then reinfused into the other biochar.

FIG. 31 are images showing the visual results of a lab test done to see the difference in microbial growth of a biochar extract during storage when sterilized at 121° C. and 21 psi for 45 minutes or not and when the extract was stored aerobically or anaerobically.

FIG. 32 illustrates charts showing the analysis results of Soxhlet extracts from the same biochar using three different solvents: water, ethanol, and ethyl acetate.

FIG. 33 illustrates two charts showing how the extraction efficiencies varied by solvent.

FIG. 34 is a chart quantifying the amount of KAR₁ concentrations in various sources of biochar.

FIG. 35 is a chart that shows seed germination rates of Arabidopsis seeds after 15 days in different media.

FIG. 36 shows two GC-MS spectra in the region of interest for identifying the presence of karrikins.

FIG. 37 compares the peaks of the KAR₁ reference and the Treated Biochar 1 at 46.68 min.

FIG. 38 illustrates the MS peaks at 46.78 min.

FIG. 39 is a mass spectrum reading of a KAR₁ reference material tested to confirm retention time.

FIG. 40 is a karrikin calibration curve.

FIG. 41 is a chart showing the variation in chemistry between bio-oil and residual extractive chemistry on char.

FIG. 42 is a mass spectrum reading of pine based bio-oil.

FIG. 43 is a mass spectrum reading of coconut based bio-oil.

FIG. 44 is a chart showing the residual peaks for coconut pyrolysis oil.

FIG. 45 is a chart showing the comparative chemistry of pine and coconut bio-oil.

FIG. 46 is another a chart showing the comparative chemistry of pine and coconut bio-oil.

FIG. 47 is a growth chart for corn root biomass.

FIG. 48 shows the test results of the use of the raw and treated biochar extracts on rice at Day 4

FIG. 49 shows the test results of the use of the raw and treated biochar extracts on corn at Day 3.

FIG. 50 depicts the germination rate of two types of rice seeds at Day 2.

FIG. 51 illustrates the same seed germination assay of FIG. 49 but measures the percentage with coleoptiles emerged at Day 3.

FIG. 52 depicts three spectra showing that KAR₁ is soluble and extractable with all three extract methods tested.

FIG. 53 is a chart showing the pixel court of germinated seed on Day 4 grown with HPLC fractioned ethanol extract of biochar 1.

FIG. 54 is a chart showing standard reference KAR₁ on the HPLC analysis at 325 nm.

FIG. 55 is a chart showing the HPLC analysis at 325 nm for the extract of biochar 1.

FIG. 56 is a chart showing HPLC analysis at 210 nm for the EtOH extraction of biochar 1.

FIG. 57 contains charts illustrating improved results obtained through the use of biochars.

FIG. 58 is an example of carbon dioxide production captured as a continuous gas bubble in BGB (left two tubes) and LTB (right two tubes) growth medium.

FIGS. 59 and 60 illustrate improved growth rates of colonies of Streptomyces lydicus using biochars.

FIG. 61 is a chart showing the Rhizobium RNA Concentrations at 24 and 48 hours of various biochars and a control.

FIG. 62 is a flow diagram of an example of a method that may be used for coating seeds with biochar.

FIG. 63 is a flow diagram of an example of a method that may be used for producing biochar solutions.

FIG. 64a-g show results from biochar extracts used in germination and growth tests with cucumbers, tall fescue, and corn seeds.

FIG. 65 is a chart showing the results of extract treated seeds at various application rates versus the untreated seeds.

FIG. 66 is a chart showing the results of an extract in a saturated cold germination test.

FIG. 67 is a chart showing the results of an extract in warm germination testing and saturated cold germination testing.

FIG. 68 is a chart showing the impact on sebacina growth over the glass bead control using vacuum treated biochars from different biomass feedstocks and various levels of karrikin.

### DESCRIPTION OF THE INVENTION

As illustrated in the attached figures, the present invention relates to a method for creating and/or capturing target compounds found in biochar that are created during biomass pyrolysis. The resulting target compounds in the biochar and its extracts can be used in industries, including but not limited to agriculture, animal health, human health, composting, and specialty chemicals.

For purposes of this application, “target compounds” include desirable residual organic or inorganic compounds including soluble signaling compounds, plant growth promoting regulator compounds (PGRs) and active biostimulant compounds. Soluble signaling compounds may include, for example, phenylpropanoid, phenylalanine, flavonoids, sterols, terpenes, terpenoids, tannins, coumarins, phenols, cyanohydrins, butenolides and/or karrikins, where the karrikin levels may exceed 10 ng/g. Plant growth regulating compounds may include salicylic acid, jasmonic acid, abscisic acid, cytokinin, gibberellic acid, and/or ethylene. Biostimulant compounds may include humic and fulvic acids as well as carbohydrate derivatives that support microbial communities.

For purposes of this application, the term “biochar” shall be given its broadest possible meaning and shall include any solid carbonaceous materials obtained from the pyrolysis, torrefaction, gasification or any other thermal and/or chemical conversion of a biomass. For purposes of this application, the solid carbonaceous material may include, but not be limited to, BMF biochar disclosed and taught by U.S. Pat. No. 8,317,891, which is incorporated into this application by reference.

Pyrolysis is generally defined as a thermochemical decomposition of organic material at elevated temperatures in the absence of, or with reduced levels of oxygen. When the biochar is referred to as “treated” or undergoes “treatment,” it shall mean raw, pyrolyzed biochar that has undergone additional physical, biological, and/or chemical processing.

As used herein, unless specified otherwise, the terms “carbonaceous”, “carbon based”, “carbon containing”, and similar such terms are to be given their broadest possible meaning, and would include materials containing carbon in various states, crystallinities, forms and compounds.

A biochar particle is a porous structure that has an outer surface and a pore structure formed within the biochar particle. As used herein, unless specified otherwise, the terms “porosity”, “porous”, “porous structure”, and “porous morphology” and similar such terms are to be given their broadest possible meaning, and would include materials having open pores, closed pores, and combinations of open and closed pores, and would also include macropores, mesopores, and micropores and combinations, variations and continuums of these morphologies. Unless specified otherwise, the term “pore volume” is the total volume occupied by the pores in a particle or collection of particles; the term “inter-particle void volume” is the volume that exists between a collection of particle; the term “solid volume or volume of solid means” is the volume occupied by the solid material and does not include any free volume that may be associated with the pore or inter-particle void volumes; and the term “bulk volume” is the apparent volume of the material including the particle volume, the inter-particle void volume, and the internal pore volume.

As used herein, unless stated otherwise, room temperature is 25° C. and standard temperature and pressure is 25° C. and 1 atmosphere. Unless stated otherwise, generally, the term “about” is meant to encompass a variance or range of +10%, the experimental or instrument error associated with obtaining the stated value, and preferably the larger of these.

Many different pyrolysis or carbonization processes can be, and are used, to create biochars. In general, these processes involve heating the starting material under positive pressure, reduced pressure, vacuum, inert atmosphere, or flowing inert atmosphere, through one or more heating cycles where the temperature of the material is generally brought above about 400° C., and can range from about 300° C. to about 900° C. Final material temperatures between about 200° C. and 300° C. can result in partial thermal degradation of a biomass feedstock and are considered torrefaction. Final material temperature below about 200° C. result in minimal structural changes to the biomass except loss of some volatile organic compounds.

The percentage of residual carbon yielded and several other initial properties are strong functions of the temperature and time history of the heating cycles of the biochar. In general, the faster the heating rate and the higher the final temperature, the lower the biochar yield. Conversely, in general, the slower the heating rate or the lower the final temperature the greater the biochar yield. The higher final temperatures also lead to greater modification of biochar properties by changing the inorganic mineral matter compositions, which in turn, modify the biochar properties. Ramp, or heating rates, hold times, cooling profiles, pressures, flow rates, and type of atmosphere can all be controlled, and typically are different from one biochar supplier to the next. These differences potentially lead to a biochar having different properties, further framing the substantial nature of one of the problems that the present inventions address and solve.

Generally, in carbonization most of the non-carbon elements, hydrogen and oxygen are first removed in gaseous form by the pyrolytic decomposition of the starting materials, e.g., the biomass. The free carbon atoms group or arrange into crystallographic formations known as elementary graphite crystallites. Typically, at this point, the mutual arrangement of the crystallite is irregular, so that free interstices exist between them. Thus, pyrolysis involves thermal decomposition of carbonaceous material, e.g., the biomass, eliminating non-carbon species, and producing a fixed carbon structure.

As noted above, raw or untreated biochar is generally produced by subjecting biomass to either a uniform or varying pyrolysis temperature (e.g., 300° C. to 550° C. to 750° C. or more) for a prescribed period of time in a reduced oxygen environment. This process may either occur quickly, with high reactor temperature and short residence times, slowly with lower reactor temperatures and longer residence times, or anywhere in between. To achieve better results, the biomass from which the biochar is obtained may be first stripped of debris, such as bark, leaves and small branches, although this is not necessary. In addition, the particle size of the biomass may be modified to alter pyrolysis behavior at a given condition. The biomass may further include feedstock to help adjust the pH and particle size distribution in the resulting raw biochar. In some applications, it is desirous to have biomass that is fresh, less than six months old, and with an ash content of less than 3%. Further, by using biochar derived from different biomass, e.g., pine, oak, hickory, birch and coconut shells from different regions, and understanding the starting properties of the raw biochar, the treatment and extraction methods can be tailored to ultimately yield predetermined, predictable residual chemicals.

The use of different biomass potentially leads to biochars having different properties, including, but not limited to different pore structures. As explained further below, the external & internal surfaces of the pores and the pore volumes themselves may hold residual chemistry. Thus, pyrolysis method and conditions, biochar treatment and/or biochar extraction can form, adjust, or remove residual compounds in the pores, residual compounds on the wall surfaces of the pores, or the biochar surface chemistry itself.

The presence of such residual compounds can result in a desirable biochar itself, for use in a variety of applications. Further, target compounds remaining on the biochar, or certain groups of the compounds, may be selectively extracted from the biochar. The extracted target compounds may be purified or concentrated into more useful products or mixtures for use in a variety of applications, such as seed treatment, foliar, or soil application.

### A. Target Compounds in Biochar and Biochar Extracts

A variety of target compounds have been identified in thermal decomposition products of biomass, including biochars and pyrolysis vapors, that can improve and support plant health, growth, and yield have been identified. Such target compounds include organic compounds, such as soluble signaling compounds, plant growth regulating compounds (PGRs), and biostimulating compounds.

### 1. Soluble Signaling Compounds

For the purposes of this application, the organic compounds that can be used to promote seed germination or plant development or microbial interactions may be referred to as “soluble signaling compounds.” As demonstrated and explained further below, the amount of signaling compounds in a biochar can be controlled with (i) the selection of biomass from which the biochar is created, (ii) the pyrolysis parameters and processes, and/or (iii) the types of post treatment processing used. Through these choices, the amount and distribution of soluble signaling compounds found in the biochar can be adjusted and optimized. Of particular interest is maximizing the amounts of soluble signaling compounds in the resulting biochar and/or extracting them from the biochar.

As background, two groups of soluble signaling compounds have been isolated from the smoke of burning plant material and have been directly shown to increase seed germination and early plant development: (i) Cyanohydrins, such as glyceronitrile, which has been linked to increased germination, and (ii) Butenolides. Butenolides are similar in functionality as strigolactones, which are a phytohormone that help to control plant development through shoot branching and cell elongation and act as a signaling compound in plant-microbial interactions. While the entire class of cyanohydrins, butenolides, and strigolactones are of interest, within the class of butenolides, karrikins are of particular interest. The karrikin family consists of KAR₁, KAR₂, KAR₃, and KAR₄. KAR₁ is 3-methyl-2H-furo[2,3-c]pyran-2-one, a two-ring structure comprised of a pyran ring and a lactone ring. Karrikins, which are easily dissolved in organic solvents, and to lesser degree in water, have been shown to be effective at concentrations as small as 10⁻¹⁰ M, similar to phytohormones.

Test have demonstrated that products generated by thermal decomposition of biomass may also contain other soluble signaling compounds such as phenylpropanoid, phenylalanine, flavonoids, sterols, terpenes, terpenoids, tannins, coumarins, benzaldehydes (e.g. methoxy-hydroxy benzaldehydes), and phenols, including lignin monomers and their derivatives; such as p-coumaryl alcohol, coniferyl alcohol, sinapyl alcohol and vanillin.

### 2. Plant Growth Regulating Compounds (PGRs)

Analysis of extracts from biochar also indicate persistence of known plant growth regulating compounds (PGRs) including, abscisic acid, jasmonic acid, and most significantly salicylic acid. See, for the example, the results of the analysis of one exemplary sample biochar in the table below:

Concentration in ng/mL

| | Sample Name | | | | | | | | | | | | | | | |
|---|---|---|---|---|---|---|---|---|---|---|---|---|---|---|---|---|
| | | | | | | | IAA- | IAA- | IAA- | | JA- | Methyl | | | | |
| | ABA | cZ | cZR | GA1 | GA4 | IAA | Ala | Asp | Trp | JA | ILE | IAA | OPDA | SA | tZ | tZR |
| Biochar 3 | 0.31 | ND | ND | ND | ND | ND | ND | ND | ND | 0.28 | ND | ND | ND | 73.02 | 0.02 | 0.03 |
| Extract | | | | | | | | | | | | | | | | |

Complex plant growth regulating compounds in biochar, such as abscisic acid and jasmonic acid likely result from incompletely charred material present at the center of larger biochar chips while salicylic acid, as a simple modification of phenol may be derived from several pathways during the thermal decomposition of lignin. The selection of biomass source and processing conditions will heavily influence the distribution of potential stimulating compounds in resultant chars.

### 3. Biostimulating Compounds

Biostimulants are substances that support a plant's natural nutrition processes thereby improving nutrient availability, uptake, or use efficiency, tolerance to abiotic stress, and consequent growth, development, quality, or yield. Some well-known biostimulating compounds are humic and fulvic acids. Humic acids in particular are known to improve micronutrient uptake.

Another group of biostimulant compounds are carbon sources that act as an energy source for beneficial microbes that support plant life. For example, these can include simple or complex carbohydrates and their derivatives such as levoglucosan and cellobiosan.

### B. Desired Biochar Properties

As discussed above, biochars derived from different biomass or produced with differing parameters, such as higher or lower pyrolysis temperature or variations in residence time, will have different physical and chemical properties and can behave quite differently in different applications. For example, some chars will have a high amount of total residual organic compounds (ROCs), while others will have relatively low levels. In addition, some biochars will have different types of residual organic compounds or different ratios of similar residual organic compounds. Different biochars may also differ considerably in both total mineral content and distribution of minerals. Additionally, in some biochars, these organic and mineral compounds, even if present in the same amounts, may be better suited for extraction than in other biochars. Depending on the application for the biochar product or the application for the biochar extract, the differences in the starting biochar properties will make certain biochars a better fit for use and for using certain extraction methods over others.

For purposes of this invention, the focus is on biochars that have soluble or otherwise labile carbons with bio-stimulating effects, which elicit plant growth responses at application rates that are one or more orders of magnitude lower than reported for typical biochars. As will be further explained below, through many years of research, it has been determined which biochar qualities and characteristics will elicit the best biostimulant effects, and the methods to achieve these biochar qualities and characteristics. These specific biochars are thus best suited for use themselves and for use in biochar extract production. As explained further below, it has been determined that biochars that will elicit the desired biostimulating effects, used alone or in biochar extract production, will have (1) desired pH levels, (2) desired acid levels, (3) no significant levels of deleterious compounds, (4) certain thermogravimetric analysis qualities (e.g., moisture, ash and residual organic compound quantities), (5) certain mineral and heavy metal content; (6) certain particle sizes and (7) a certain age and storage.

### 1. Biochar pH

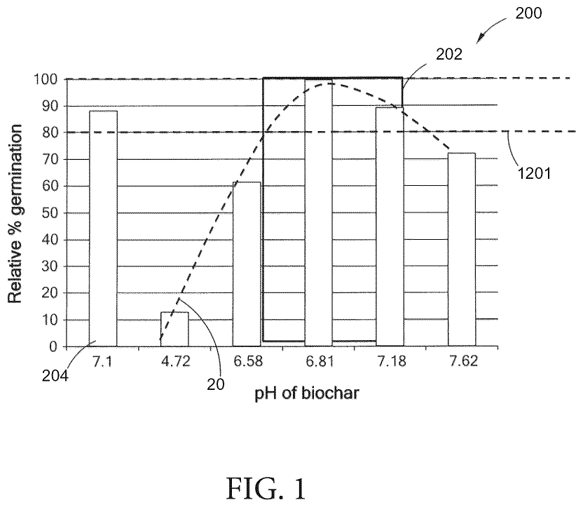

FIG. 1 illustrates a graph of the pH of various biochars that were made from different starting materials and pyrolysis process temperatures. Through testing, it was determined that biochars identified as effective at eliciting improved plant growth have pHs in the range of about 3.5 to 9, preferably 5 to 8.5, more preferably 6 to 8, and still more preferably 6.5 to 7.5, recognizing that other ranges and pHs are contemplated and may prove useful, under specific environmental or agricultural situations or for other applications. Alternatively, when using biochars to create biochar extracts that are effective, it is important that biochars are not strongly alkaline, thus it is preferred to have biochars with pHs below 8, preferably below 7, and more preferably below 6 and most preferably between 3.5 and 6.

Test demonstrate that the pH of biochars vary when made from different starting materials, including coconut shells, pistachio shells, corn, bamboo, mesquite, wood and coffee, wood (Australia), various soft woods, red fir, and various grasses. Biochar pH also varies when the same starting material is pyrolyzed at different process temperatures. While post treatment processes may be is used to alter the pH from the various higher pH levels (basic) and bring the pH into a more neutral range, it is desirable to create a biochar that does not require a post-treatment pH adjustment.

For example, a post treatment process can remove and/or neutralize inorganic compounds, such as the calcium hydroxide ((CaOH)₂), potassium oxide (K₂OK₂OK₂O), magnesium oxide (MgO), magnesium hydroxide (Mg(OH)₂), and many other alkaline mineral oxides/hydroxides that are formed during pyrolysis, and bound to the biochar pore surfaces. These inorganics, in particular calcium hydroxide, adversely affect the biochar's pH, making the pH in some instances as high as 8.5, 9.5, 10.5 and 11.2. These high pH ranges can be deleterious to crops, and may kill or adversely affect the plants, sometimes rendering an entire field a loss.

However, the calcium hydroxide, and other inorganics, cannot readily and quickly be removed by a single stage post treatment process such as simple washing of the biochar, even in an acid bath. Drying the biochar, such as by heating or centrifugal force, also will not substantially alter the composition of minerals contained within the biochar. It is for this reason that selecting the starting material and determining the desired pyrolysis temperature of the materials so the resulting biochar has a desirable pH is important.

Alternatively, biochars may exhibit extremely low pH on the order of 2.5-3.5. These materials contain significant quantities of residual pyrolysis oils, including low molecular weight acids. The highly acidic nature of these biochars can inhibit local plant development, alter nutrient availability and jeopardize soil micro-organisms. Again, single stage post treatment processes may not be as effective at increasing pH to a desired level. Selecting a starting material and determining the pyrolysis temperature of that material to achieve a resulting biochar with a desirable pH is more ideal.

There are a wide variety of tests, apparatus and equipment for making pH measurements that are known by those skilled in the art. For example, and preferably when addressing the pH of biochar, batches, particles and pore surfaces of those particles, two appropriate methods for measuring pH are the Test Method for the US Composting Council (“TMCC”) 4.11-A and the pH Test Method promulgated by the International Biochar Initiative. The test method for the TMCC comprises mixing biochar with distilled water in 1:5 [mass:volume] ratio, e.g., 50 grams of biochar is added to 250 ml of pH 7.0±0.02 water and is stirred for 10 minutes; the pH is then the measured pH of the slurry. The pH Test Method promulgated by the International Biochar Initiative comprises 5 grams of biochar is added to 100 ml of water pH=7.0±0.02 and the mixture is tumbled for 90 minutes; the pH of the slurry is measured at the end of the 90 minutes of tumbling. Prior to and before testing for pH, biochar is passed through a 2 mm sieve.

### 2. Biochar Acid Number

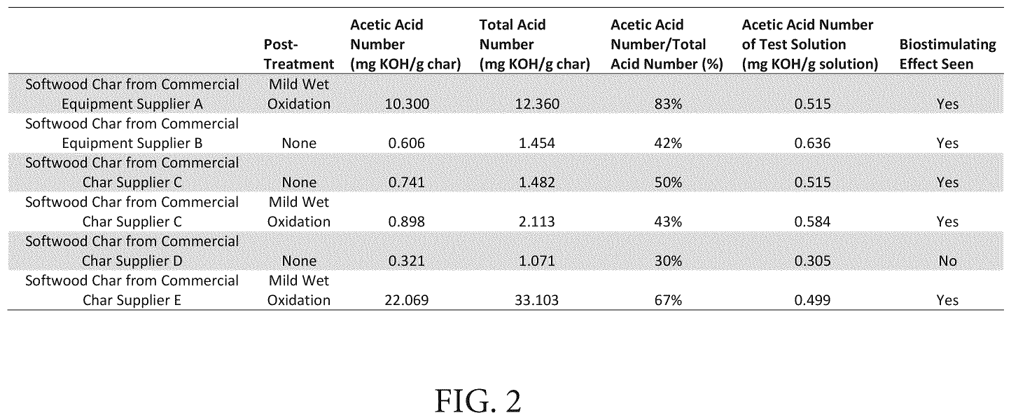

FIG. 2 illustrates a table showing the test results of various biochars for acid number and biostimulating effects. A positive biostimulating effect was determined by using an extract from said biochar and looking for an increase in germination rate at 2 days after plating or by an increase in total seedling surface area after 4 days of 16 hour light/8 hour dark growth in a 100% humidity environment. Use of the biochar extract eliminates potential effects from physical interactions with the biochar surface. The concentration of all test solutions used was adjusted such that the UV adsorption of the test solution was equivalent for each solution applied in biostimulating trials.

From these tests, it was determined that biochars that are likely to have a biostimulating effect preferably yield an organic solvent extract, obtained from Soxhlet extraction of the biochar (using the method outlined below), having a total acid number of 1.0 to 100 mg KOH/g biochar, and more preferably 10 to 50 mg KOH/g biochar. In addition, it is preferable that more than 40% of the Total Acid Number is attributed to carboxylic groups (Acetic Acid Number), more preferably at least 50% and most preferably greater than 60%.

The measurement of the “total acid number” is related to the measurement of pH. Measuring pH provides the acid strength of a solution based on dissociated hydrogen ions in an aqueous solution, while measuring total acid, measures by titration, the total acid content of solution rather than only the dissociated hydrogen ions. More specifically, through careful titration, acid groups of varied strength can be quantified. These are generally reported as carboxyl groups (—COOH) (or carboxylic like) and phenolic acids, that are in the solution, in some cases a lactone like functional group may also be observed between these peaks but is not always sufficiently strong to note. Acid numbers are determined by titration and expressed as mg KOH/g. A suitable method for this measurement is presented by the National Renewable Energy Laboratory “Acid Number Determination of Pyrolysis Bio-oils using Potentiometric Titration” method.

Using the National Renewable Energy Laboratory testing method to determine the acid number of biochars, first the biochar chemistry is extracted using ethanol in a Soxhlet extractor. Then 200 mg of this ethanol extract solution are mixed with 50 mL of isopropanol and titrated with 0.001 M tetrabutylammonium hydroxide (TBAOH) while stirring. If less than 5 mL of titrant are required, a more dilute solution of TBAOH may be used. Alternatively, the ethanol extraction solution may be concentrated through evaporation. As a general practice, it is important during titration to avoid significant vortex formation, as this can introduce CO₂ into solution, forming dilute carbonic acid and interfering with the results of the titration. Recommended best practice is the use of an automated titrator and inert gas bubble, but these are not required. Titration curves and end points can be determined by utilizing standardized control solutions of acetic acid, phenol and a combination thereof. Both the Acetic Acid Number (carboxyl groups) and Total Acid Number (carboxyl, lactone and phenolic groups) are determined. The acid numbers of the biochar are back calculated using the ratio of biochar extracted and the end volume of ethanol extract produced.

### 3. Deleterious Compounds in Biochar

Deleterious compounds can be found in biochars, which will counteract any beneficial compounds if present. Biochars that will elicit positive plant impacts will have no significant levels and preferably be essentially void of these known deleterious compounds. Deleterious compounds can come from the biomass feedstock, be formed through pyrolysis or combustion, or be a contaminant introduced at some point in the production or storage process. Of particular importance are heavy metals which can come from contaminated biomass and known phytotoxins that can form during combustion, such as polycyclic aromatic hydrocarbons (PAHs), and dioxins, including polychlorinated biphenyls (PCBs). Given that the compounds can come for biomass and/or formed through pyrolysis, it is desirable to select the biomass and determine the pyrolysis processing conditions that result in a biochar having no significant levels and preferably be essentially void of these known deleterious compounds.

a. Polycyclic Aromatic Hydrocarbons (PAHs)

There has been significant research that has shown pyrolysis at certain conditions can create polycyclic aromatic hydrocarbons (PAHs) that can reside in the pores of the resulting biochar or be adsorbed on to its surface. PAHs are known phytotoxins that can inhibit germination and hinder plant growth. PAH's are typically measured using EPA Methods 3540 & 8270/8270C-SIM. Although there are more than 70 PAHs tested for, often the focus is only on the sum of the 16 PAH priority compounds identified by US EPA (Acenaphthene, Acenaphthylene, Anthracene, Benz(a)anthracene, Benzo(a)pyrene, Benzo(b)fluoranthene, Benzo(k)fluoranthene, Benzo(ghi)perylene, Chrysene, Dibenz(a,h)anthracene, Fluoranthene, Fluorene, Indeno(1,2,3-cd)pyrene, Naphthalene, Phenanthrene, and Pyrene). IBI lists the range of maximum allowed thresholds for priority PAHs as 6-300 mg/kg (6-300 ppm) dry weight. In particular, for biochars and their extracts being used to produce beneficial responses in plants, it is preferable that the biochar's concentration of priority PAHs (defined as the sum of the 16 EPA listed and on a dry weight basis) is less than 20 ppm, and more preferably less than 10 ppm and most preferably less than 5 ppm.

b. Dioxins

Dioxins are released from combustion processes and thus can be found in raw biochar that was not pyrolyzed at controlled conditions. Dioxins include polychlorinated dibenzo-p-dioxins (PCDDs) (i.e., 75 congeners (10 are specifically toxic)); polychlorinated dibenzofurans (PCDFs) (i.e., 135 congeners (7 are specifically toxic)) and polychlorinated biphenyls (PCBs) (Considered dioxin-like compounds (DLCs)).

Since some dioxins may be carcinogenic even at low levels of exposure over extended periods of time, the FDA views dioxins as a contaminant and has no tolerances or administrative levels in place for dioxins in animal feed. Dioxins in animal feed can cause health problems in the animals themselves. Additionally, the dioxins may accumulate in the fat of food-producing animals and thus consumption of animal derived foods (e.g. meat, eggs, milk) could be a major route of human exposure to dioxins. Thus, if biochar or biochar extracts are used in animal applications, where the animals ingests the biochar or its extract, the ability to remove dioxins prior to its use is of particular significance.

As mentioned, a number of different dioxins exist, several of which are known to be toxic or undesirable for human consumption. It is also possible that any number of dioxins could be present in raw biochar depending on the biomass or where the biomass is grown. Seventeen tetra-octo dioxins and furan congeners are the basis for regulatory compliance. Other dioxins are much less toxic. Dioxins are generally regulated on toxic equivalents (TEQ) and are represented by the sum of values weighted by Toxic Equivalency Factor (TEF)

$$T EQ = \sum [ {C}_{j} ] \times T E {F}_{i}$$

2,3,7,8-TCDD has a TEF of 1 (most toxic). TEQ is measured as ng/kg WHO-PCDD/F-TEQ//kg NDs are also evaluated. Two testing methods are generally used to determine TEQ values: EPA Method 8290 (for research and understanding at low levels (ppt-ppq); and EPA Method 1613B (for regulatory compliance). Both are based on high resolution gas chromatography (HRGC)/high resolution mass spectrometry (HRMS).

The required EU Feed Value is equal to or less than 0.75 ng/kg WHO-PCDD/F-TEQ//kg. Desirable biochar, has been shown to have TEQ dioxins less than 0.5 ng/kg WHO-PCDD/F-TEQ//kg, well below the requirement for EU Feed limits of 0.75 ng/kg WHO-PCDD/F-TEQ//kg.

Post treatment of biochars can reduce the amount of detectable dioxins from raw biochar such that the dioxins are not detectible in treated biochar. A proven approach to remove these substances is to wash the exterior surfaces with and/or rapidly infuse a solvent into the pore volume of the material targeted to remove these substances. Following the infusion with either flushing, mechanical extraction, or other methods to remove the solvent, laden with the substances in question, from the pores and interparticle spaces to further reduce the levels of toxicity. For example, the following data, shows removal of dioxins using a vacuum infiltration treatment process, as described in U.S. Pat. Nos. 10,023,502, 10,106,471, 10,252,951 and 10,556,838, all of are incorporated by reference in their entirety into this application, with dioxin laden raw biochar samples:

| | Raw | Treated | Raw | Treated |
|---|---|---|---|---|
| | biochar A | biochar A | biochar B | biochar B |
| TEQ ng/kg | 0.7 | 0.4 | 9.6 | 0.4 |
| (method 8290A) | | | | |

Another approach for some toxic compounds is, rather than removing the compounds in question, to react them in place with other compounds to neutralize the toxicant. This approach can be used either with washing, or forced/assisted infusion, and in these cases a removal step is less necessary—although it can still be used to prepare the material for another, subsequent phase of treatment.

While post treatment remediation of these contaminants is possible, it is preferable to avoid these post-treatment methods for removing toxic substances as they may also remove or alter the desirable beneficial compounds. Thus, it is preferable to create biochars without these toxins through proper feedstock selection and pyrolysis conditions.

c. Polychlorinated Biphenyls (PCBs)

Finally, there has been research that has shown Polychlorinated Biphenyls (PCBs) can be produced during combustion reactions and can be adsorbed in the pores or on the surface of biochars. This is less common than the formation of PAHs, but still of concern because PCBs are known persistent organic pollutants (POPs) which can act as phytotoxins that can inhibit germination and hinder plant growth. PCBs are typically measured using EPA Methods 8082, 8275, or 1668A. There are 7 PCB priority compounds as identified by the EPA: Aroclors 1016, 1221, 1232, 1242, 1248, 1254, & 1260. IBI lists the range of maximum allowed thresholds for PCBs as 0.2-1 mg/kg (0.2-1 ppm) dry weight. Thus, in applications related herein to biochars and their extracts being used to produce beneficial responses in plants, it is preferable that the biochar's concentration of priority PCBs (defined as the sum of the 7 EPA listed and on a dry weight basis) is less than 1 ppm, and more preferably less than 0.1 ppm and most preferably less than 0.01 ppm.

### 4. Thermogravimeter Analysis Qualities

The percent water, total residual organic compounds, total light organic compounds (volatiles or VOC) and total heavy organic compounds contained in a biochar particle or particles can all impact plant growth and all may be measured by thermogravimetric analysis (“TGA”). As noted previously, biochars that are effective at eliciting improved plant growth have desirable organic compounds, which more generally may be referred to as a subset of “Residual Organic Compounds” (ROCs). For the purposes of this application, “Residual organic compounds” (ROCs) are defined as compounds that burn off during thermogravimetric analysis (TGA) between 150 degrees C. and 950 degrees C., and include, but are not limited to, phenols, polyaromatic hydrocarbons, monoaromatic hydrocarbons, acids, alcohols, esters, ethers, ketones, sugars, alkanes and alkenes. Of the ROCs, those that burn off using thermogravimetric analysis between 150 degrees C. and 550 degrees are considered light organic compounds (volatiles or VOCs), and those that burn off between 550 degrees C. and 950 degrees C. are heavy residual organic compounds.

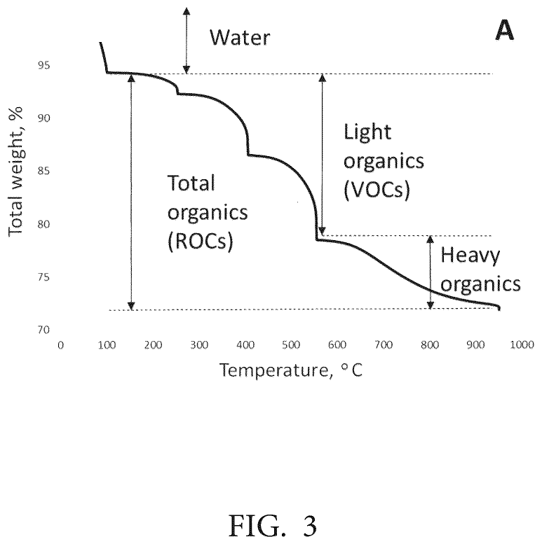

To determine percent water, total residual organic compounds, total light organic compounds (volatiles or VOC) and total heavy organic compounds contained in a biochar particle or particles, TGA is performed by a Hitachi STA 7200 analyzer or similar piece of equipment under nitrogen flow at the rate of 110 mL/min. The biochar samples are heated for predetermined periods of time, e.g., 20 minutes, at a variety of temperatures between 100° C. and 950° C. The sample weights are measured at the end of each dwell step and at the beginning and at the end of the experiment. Thermogravimetric analysis of a given sample indicating percentage water in a sample is determined by % mass loss measured between standard temperature and 150° C. Thermogravimetric analysis of a given sample indicating percentage of residual organic compounds is measured by percentage mass loss sustained between 150° C. and 950° C. Thermogravimetric analysis of a given sample indicating percentage of light organic compounds (volatiles) is measured by percentage mass loss sustained between 150° C. and 550° C. Thermogravimetric analysis of a given sample indicating percentage of heavy organic compounds is measured by percentage mass loss sustained between 550° C. and 950° C. FIG. 3 is an example of a Thermogravimetric Analysis (TGA) plot outlining the above explanation and the measure of water, light organics and heavy organics.

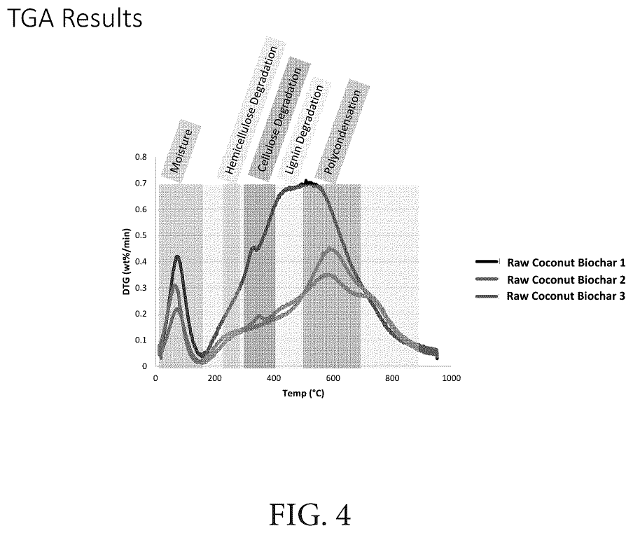

It is understood in the field of pyrolysis that various residual organic compounds found in biochars are derived from certain compounds in the original biomass. In addition, it is understood that due to the energy needed to convert the biomass compounds to these residual compounds, the pyrolysis method and conditions, including temperature and residence time, will also impact the amount and type of residual organic compounds left in the biochar. FIG. 4 is an example of a Thermogravimetric Analysis (TGA) plot which shows how the type and amount of residual organic compounds can vary for biochars from the same source, in this case coconut shells. reactions are estimated to occur primarily at 500-700° C. Some lignin decomposition reactions will occur at relatively low temperatures, but the main decomposition reactions will occur around 400° C. Secondary decomposition reactions of lignin intermediates will occur at temperatures above 600° C. In addition, competing cross-linking reactions occur, so the degradation process will include both polymerization and depolymerization reactions. To have both the quantity and quality of desirable organic compounds in biochar to elicit plant benefits and produce effective biochar extracts, there's a need for having consistent pyrolysis conditions and biomass uniformity.

Generalized methods for estimating extent of pyrolysis and ROCs (simplified as volatile matter within this method) by proximate analysis have been developed for carbon containing materials that can be applied to biochar, including ASTM method, D1762, D3172 through D3175 and D7582. Modifications of ASTM D7852 are described here that have been developed for use with micro-thermogravimetric analyzers and biochar to allow more detailed analysis of the 1^{st} derivative of the mass loss vs temperature curve. The method employed here utilizes a sample of 1-5 mg of ground biomass or biochar is loaded into a crucible and placed within the furnace of the TGA. This material should pass a 60 mesh screen, more preferably a 75 mesh screen and most preferably a 100 mesh screen. Inert gas is flowed over the sample at a rate of Y furnace volumes/min. 10° C./min to 950° C. Different heating rates between 2° C. and 20° C./min may be used but will alter the width of volatilization peaks, with lower heating rates producing narrower bands, and higher heating rates producing wider bands. Using this method, raw biomasses will typically have a volatile matter content above 70% on a moisture and ash free basis. Again, based on extensive biochar testing, biochars that elicit plant benefits generally have a volatile matter content on a moisture and ash free basis between 15% and 50%, and more preferably between 25% and 40% and a fixed carbon content between 50 and 85% and more preferably between 60 and 75%.

Using this method, raw biomasses will typically have a volatile matter content above 70% on a moisture and ash free basis. Again, based on extensive biochar testing, biochars that elicit plant benefits generally have a ROC content (referred to as volatile matter within the method) on a moisture and ash free basis between 15% and 50%, and more preferably between 25% and 40% and a fixed carbon content between 50 and 85% and more preferably between 60 and 75%.

Not only does TGA determine total residual organic compounds of a biochar, the specific TGA curve is indicative of the pyrolysis temperatures at which the biochar was created. The following table shows the typical peak position (center of peak) and allowable full width half maximum for each peak (peak width).

| | Peak Position (° C.) | Peak width (° C.) |
|---|---|---|
| Moisture | 50-100 | 20-50 |
| Volatiles | 150-275 | 20-50 |
| Hemicellulose | 300-330 | 20-30 |
| Cellulose | 330-350 | 10-20 |
| Lignin | 350-400 | 50-80 |
| highly volatile biochar | 450-550 | 50-100 |
| volatile biochar | 650-750 | 50-100 |

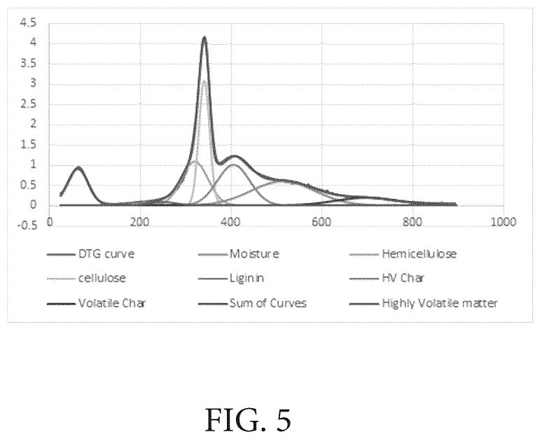

FIG. 5 illustrates the deconvolution of a TGA spectrum using the above assignments. Based on this deconvolution the volatile matter content is preferably between 20-40% of biochar, and more preferably between 25-35% of the moisture free weight of the biochar, of which existing volatile matter is composed of:
10-35% of volatile mater as cellulose/hemicellulose
10-35% of volatile matter as Lignin
10-35% of highly volatile biochar
<15% volatile biochar
Less than 5% low molecular weight volatile compounds

Or more preferably
15-30% cellulose/hemicellulose
15-30% Lignin
15-30% highly volatile biochar
<10% Volatile biochar
And less than 3% as low molecular weight volatile compounds.

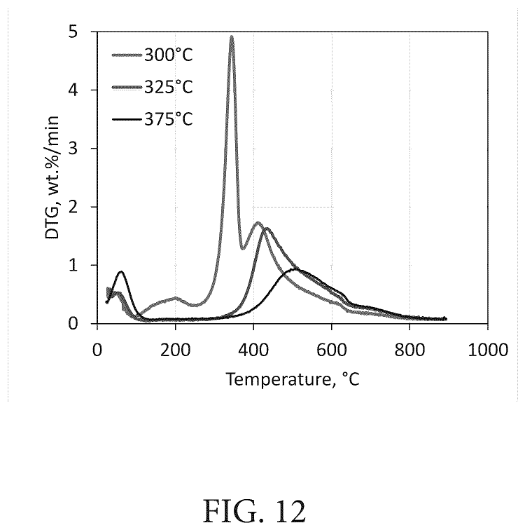

As shown above, the production of suitable agricultural biochar is dependent on chemistry formed when the biomass particle reaches a pyrolysis temperatures between 30° and 400° C. The exact conditions utilized to achieve this pyrolysis are widely varied and depend on a variety of process parameters including but not limited to: feedstock, feedstock moisture, feedstock particle size, equipment configuration, biomass contact time with heated surfaces, biomass residence time, gas environment, added gas flow rate, and gas residence time. For example, at low residence times, reactor temperatures significantly greater than the desired biomass pyrolysis temperature may be used. Due to heat transfer limitations, the bulk biomass particle may not reach temperatures in excess of the desired range. For this reason, discussion on suitable biochar is limited to the specific qualities of the material as shown by TGA rather than by process conditions. Some of these effects of the various process parameters are highlighted in FIGS. 12-15, as described further below.

### 5. Mineral and Heavy Metal Content

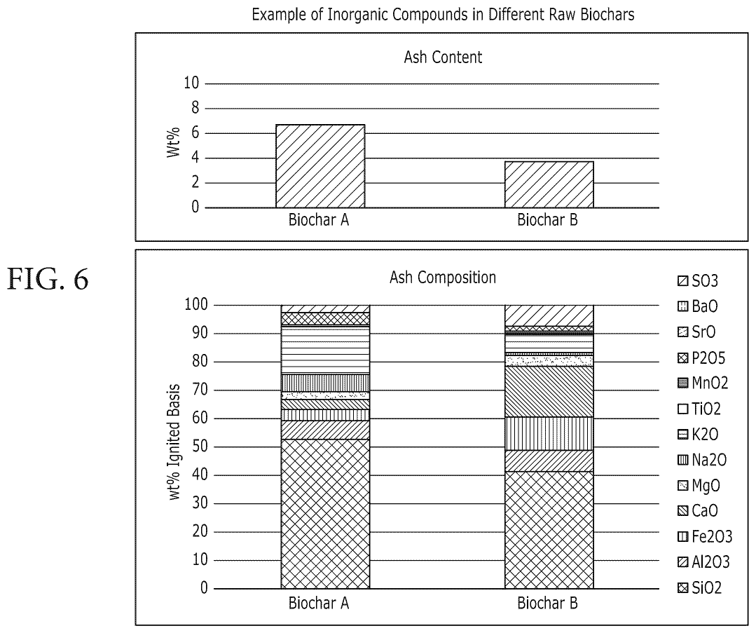

Feedstock and pyrolysis conditions will also determine the amounts of compounds other than ROCs in the biochar and how available they are for extraction. These other compounds include heavy metals, transition metals, and inorganic mineral compounds. When it comes to non-organic compounds, growing conditions will also impact the types and amounts in the biochar. For example, if a biomass feedstock is grown in soil with high levels of heavy metals the resulting biochar may have a higher concentration of those metals than the biochar created from the same biomass and pyrolysis conditions that was grown in non-contaminated soil. Another example would be chloride levels when a resultant biochar's feedstock was grown with high salinity irrigation or soil. For example, FIG. 6 shows compositional analysis using ASTM C311/XRF of the resulting ash following proximate analysis using ASTM E1534-93 (ashing temperature of 600° C.) from two different raw biochars, from different feedstocks. Ash composition results are in wt % after ignition. The total amount of inorganics (ash) in raw biochar A is more than 1.5 times the amount in biochar B. In addition, when looking at the composition of those inorganics there are significant differences between the two biochars, for example, there is a much higher percentage of potassium in Biochar A's ash versus that of Biochar B and there is a much higher percentage of iron and calcium in Biochar B's ash versus that of Biochar A. This data is shown as example only that the biochars themselves will have an impact on the amount and types of non-organic compounds available to be extracted, if desirable. These effects are important to consider in the selection of feedstock or biochar as these inorganic fractions can significantly affect the pyrolysis of biomass and the final pH of materials.

Some heavy metals are also micronutrients and are essential for normal growth but can be toxic if in high quantities including Cobalt, Copper, Manganese, Molybdenum, Nickel, and Zinc. Thus, heavy metals of most concern for biochars are those that are highly toxic and may also already be present in soils, particularly Arsenic, Cadmium, Chromium, Lead, and Mercury. These heavy metals are typically tested using EPA methods 3050B or 3051A for sample preparation and 6010B or 6020 for analysis. Except for mercury which is tested by EPA 7471 or similar methods. For reference, the table below provides heavy metals limits for RCRA hazardous waste, US EPA limits on soil application, the EU's limits for soil improver & plant biostimulants (PE-CONS 76/18 ANNEX I), and the range of maximum allowed thresholds for biochars as listed by the International Biochar Initiative (IBI). As evidenced, there is a wide range of guidelines used and one reason is because the effect of toxicity will depend on the concentration in the material, the amount of material being applied, and how bioavailable the toxin is. In applications related herein to biochars and their extracts being used to produce beneficial responses in plants, it is preferable that the biochar's concentration of heavy metals (defined as the sum of the twelve listed and on a dry weight basis) is less than 1000 ppm, and more preferably less than 750 ppm and most preferably less than 500 ppm. Additionally, the concentration of highly toxic heavy metals (defined as the sum of the five listed and on a dry weight basis) does not exceed 50 ppm, and more preferably does not exceed 25 ppm, and most preferably does not exceed 10 ppm. Additionally, each individual highly toxic heavy metal of the five listed should be below 25 ppm, and more preferably below 10 ppm, and most preferably below 5 ppm. Further specifics for desirable levels of each heavy metal can be found below.

TABLE 3

| | | US EPA | EU's | EU's | IBI's range of | |
|---|---|---|---|---|---|---|
| | RCRA 8 | limits | limits | limits | maximum allowed | Desirable |
| | Waste | on soil | for Soil | for plant | thresholds for | Biochar's most |
| | Limits | application | Improver | biosimulants | Biochars | preferable level |
| Heavy Metal | (mg/kg) | (mg/kg) | (mg/kg) | (mg/kg) | (mg/kg) | (mg/kg) |
| Highly Toxic | | | | | | |
| Arsenic | 5 | 75 | 10 | 40 | 13-100 | <5 |
| Cadmium | 1 | 85 | 1 | 1.5 | 1.4-39 | <1 |
| Chromium | 5 | 3000 | 100 | 2 | 93-1200 | <2 |
| Lead | 5 | 420 | 100 | 120 | 121-300 | <5 |
| Mercury | 0.2 | 840 | 1 | 1 | 1-17 | <0.2 |
| Others | | | | | | |
| Cobalt | — | — | — | — | 34-100 | <34 |
| Copper | — | 4300 | 100 | 600 | 143-6000 | <100 |
| Manganese | — | — | — | — | — | <100 |
| Molybdenum | — | 57 | 2 | — | 5-75 | <2 |
| Nickel | — | 75 | 50 | 50 | 47-420 | <47 |
| Selenium | 1 | 100 | 1.5 | — | 2-200 | <1 |
| Zinc | — | 7500 | 300 | 1500 | 416-7400 | <300 |

It should be noted that in some applications and uses a biochar with higher heavy metals might be desirable. For example, if the biochar or its extract is being used as a fertilizer to provide an essential heavy metal as a micronutrient to improve a lacking soil or support plants showing a deficiency, then significantly higher levels of that metal in the biochar would be desirable. For example zinc deficiency is the most common micronutrient deficiency in soils globally and zinc products are widely applied in agriculture as part of a fertilizer program for crops like corn and rice, particularly in low soil organic matter soil or acidic leached soils. Thus, a biochar or its extract with high zinc concentration could be applied as an alternative to traditional zinc products, such as zinc sulfate, to support optimal plant growth and yield.

### 6. Particle Size

In addition to feedstock selection and pyrolysis conditions, the biomass and biochar particle size can also impact the resulting extract. Generally speaking, smaller particles that have been pyrolyzed with larger particles will have been pyrolyzed to a further extent, and thus the residual compound types or quantities in biochar fines may be significantly different than those in the larger particles. Thus, physically removing fines or small particles may alter the bulk residual chemistry of a given biochar sample. Furthermore, segregating the biochar by particle size prior to extraction will in many cases result in different composition of the extracts vs. leaving the various particles mixed together. It should be noted that grinding biochar after pyrolysis to gain a desired particle size distribution yields a different result than sizing the particles before pyrolysis or before char extraction. This is because sizing before pyrolysis impacts the level of pyrolysis of the particles (typically less pyrolysis for the larger particles) and sizing after impacts the accessibility of various compounds by exposing new externally accessible surface area from which to extract materials. It is desirable in such cases to use biochar particles having particle sizes and distributions ranging from about 0.01 mm to about 10 mm. For example, particle sizes between 10 μm and 500 μm can be selected to improve extraction efficiency. By way of another example, particle sizes between 0.5 mm and 5 mm can be selected to improve separation after extraction. For a specific extraction, more consistent particle sizes in a smaller range may be beneficial to obtain more consistent extraction and separation properties, such that a 70% distribution around the mean particle size is 20% of the mean particle size. So, for example if average particle size is 100 μm, then 70% distribution around the mean would equate to plus or minus 20% of 100 μm, or in other words 70% of particles would be between 80 and 120 μm. By way of another example, if average particle size is 1 mm, then 70% of particles would be in the range of 0.8 mm and 1.2 mm.

### 7. Storage and Aging

Another variable of raw biochar that can impact what compounds are in the biochar will be the age and storage conditions of the biochar. Natural aging, a physiochemical process due to oxidation, can change a raw biochar's structure and surface chemistry which also impacts other biochar properties such as sorption or ion exchange capacity. Thus, the age of the raw biochar or storage conditions that would promote or inhibit oxidation, may impact an extraction method's efficacy in removing targeted compounds, or in some cases even the types and quantity of extractable compounds present. Untreated biochar, stored in an aerobic environment may exhibit significant changes over the first several weeks to several months of storage due to oxidation of the material surface, with the rate of oxidation several months of storage due to oxidation of the material surface, decreasing logarithmically over time. After oxidation, either by post treatment or aging, biochar stored under room conditions, without significant variations in moisture or persistent freeze/thaw cycles, shows excellent material stability with minimal changes in composition or structure over a period of years.

### C. Biochar Production

As discussed previously, there are a several different variables pertinent to the pyrolysis process that significantly impact the composition of raw biochar. These variables include, but are not limited to, temperature, residence time, reactor pressure and use the presence and composition, or absence, of a carrier gas.

### 1. Temperature

The effect of higher treatment temperature is clearly displayed though TGA of chars produced in a fixed batch kiln as shown in FIG. 12. These chars are produced by heating biomass to the specified higher heating temperature at approximately 5° C./min followed by a hold at temperature for 30 minutes before gradually cooling back to room temperature. All tests were conducted using 100 grams of biomass under a mild nitrogen purge. These tests allow sufficient time for large biomass chips to reasonably obtain the set pyrolysis temperature. With shorter residence time, heat transfer limitations through the biomass and biochar prevent sometimes significant portions of the biomass from achieving the set pyrolysis temperatures.

From FIG. 12, it is seen that as temperature increases to 300 C hemicellulose and cellulose fractions begin to decompose. When the temperature is increased to 325 to 350 nearly complete decomposition of these fractions is observed. At temperatures in excess of 350° C. predominately lignin decomposition occurs.

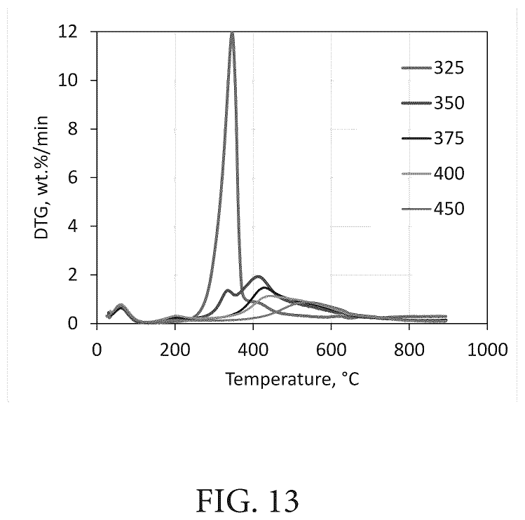

After complete degradation of the lignin, the formed amorphous carbon structure begins to further condense through cross linking and dehydration reactions. This results in increased TGA temperatures prior to observed decomposition and generally slower rates of weight loss. This effect can be seen in FIG. 13 which shows a temperature series produced using a continuous rotary kiln. The listed temperatures (300-450° C.) are the initial heating temperatures set for the kiln. Due to slow rotational rate and long residence time this results in near complete pyrolysis of the particles in the first zone.

### 2. Effect Residence Time

Residence time is closely related to reactor temperatures and biomass particle size. Biomass heating primarily results from heat transfer through the particle, however particle morphology, reactions occurring during the heating process and phase changes dramatically complicate calculation of heating rates. Because of this, a set residence time to reactor temperature is not established here beyond the understanding that lower reactor temperatures and larger biomass particles will require increased residence time to achieve similar degrees of pyrolysis as those processed at higher temperatures and from biomass of lower particle size. The exact chemistry of the resulting pyrolysis products will differ, even if degree of pyrolysis is matched due to wide variety of competing reactions that are variously favored at different biomass temperatures. As such different chemistries may be achieved by varying residence time.

### 3. Effect of Carrier Gas and Composition

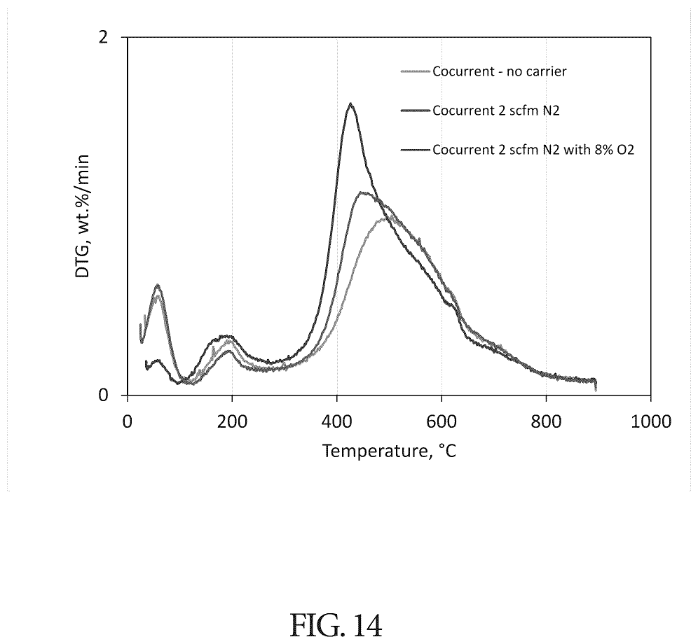

The use of carrier gas further complicates pyrolysis process. As the carrier/sweep gas is heated to the correct zone temperature, a reduction in available heat for pyrolysis occurs. As seen in FIG. 14, the addition of a non-preheated nitrogen sweep gas reduces the overall degree of pyrolysis at a given operating temperature. The inclusion of dilute oxygen in this stream resulted in sufficient oxidation to overcome most of this effect (8% oxygen by volume, equivalent to ˜6% stoichiometric combustion air). In some iterations of this process heat may be supplied entirely by external heating, however as demonstrated in FIG. 14, the controlled addition of oxygen may be utilized to partially or completely supply necessary heat to the system.

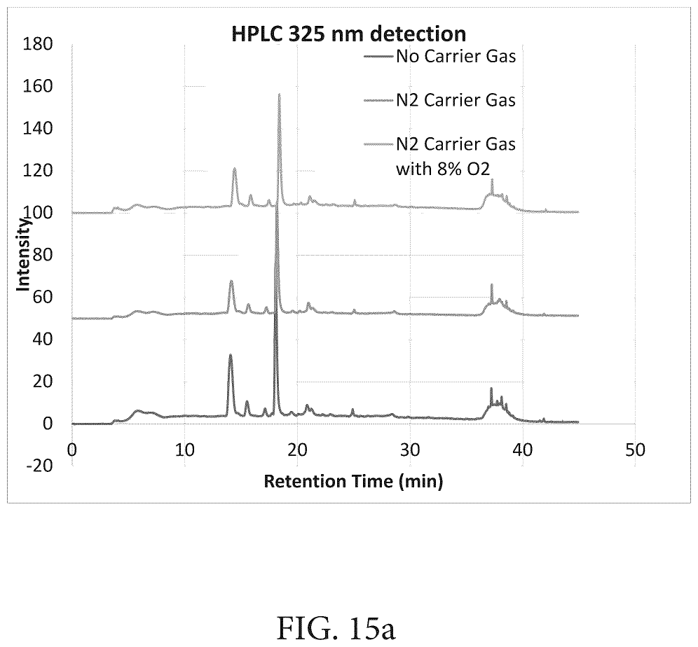

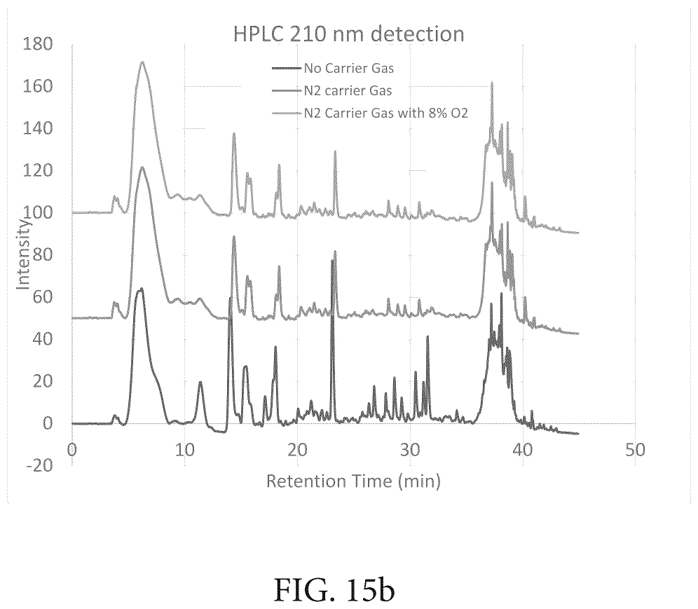

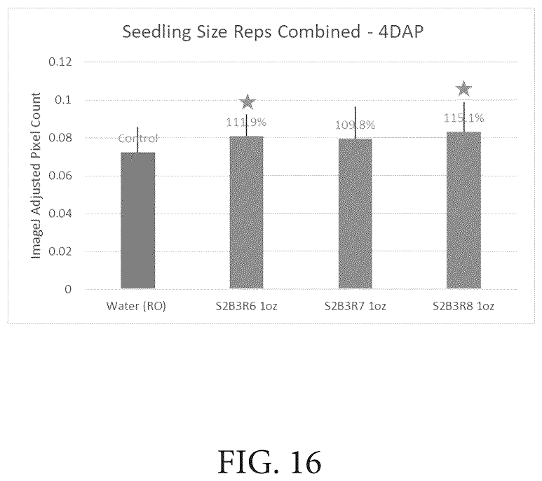

FIGS. 15A and B show a comparison of extracts from several chars produced at 400° C. in a rotary kiln furnace under different atmospheric conditions. Variation in residuals is not strongly affected by gas composition, allowing the use of an inert sweep to reduce vapor residence time and a small degree of oxygen to assist with maintaining pyrolysis temperature throughout the reactor without significantly altering the speciation or distribution of residual adsorbed chemistry. As illustrated in FIG. 16, when the extracts were tested as a seed treatment on hybrid corn at a rate of 1 oz per 100 lbs of seed extracts from each biochar, the use of the extracts showed increased seedling size by ˜10%-15% after 4 days for each treatment without significant differences between each.

### 4. Effect of System Pressure

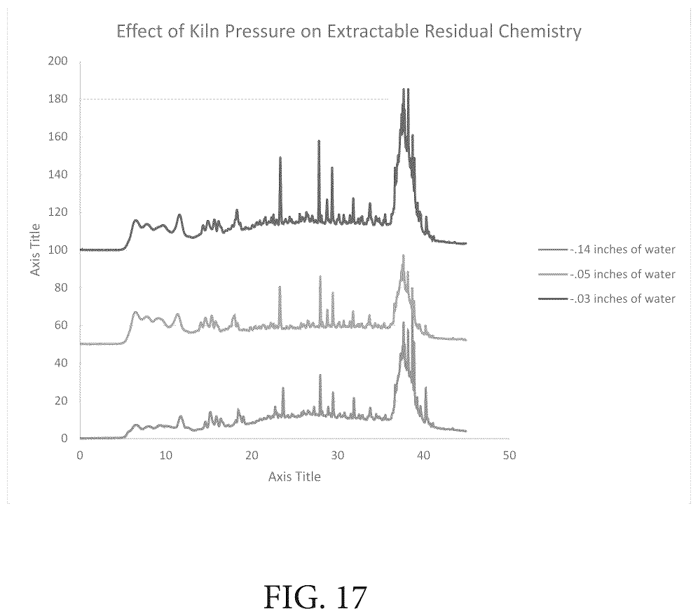

The effect of kiln pressure was examined using an increasing negative system pressure on a rotary kiln system set up in counter current flow. The vacuum pressure was adjusted between 0 and −0.15 inches of water with all other system parameters held constant. As shown in FIG. 17, the results indicate that as system pressure was reduced the content of residual chemistry (identified by the intensity of the chromatographic peaks) reduced. While it is typical to operate many types of pyrolizers under very slight vacuum to avoid emission of pyrolysis vapors from incomplete seals, for the production of agricultural chars it is preferable that the vacuum be held to not more than-0.15 inch of water, more preferably not more than-0.05 inch of water and most preferably a slightly positive pressure not to exceed 0.5 inches of water when system designs permit mild overpressures without evacuation of vapors.

### 5. Effect of Vapor-Char Interactions

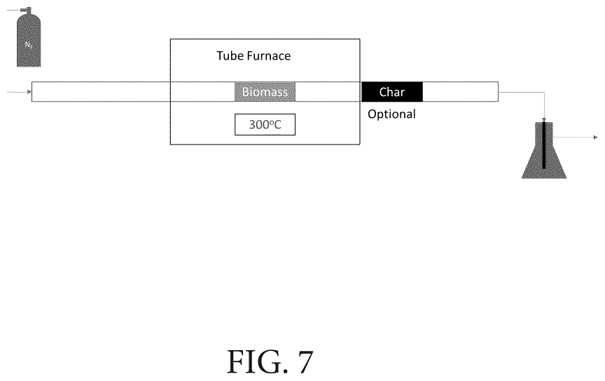

To illustrate the importance of vapor/biochar interactions within the above temperature ranges, a series of tests was performed in a fixed bed batch reactor, similar to the fixed bed batch reactor illustrated in FIG. 7. In this configuration biomass may be loaded into the heated section of the reactor, raised to pyrolysis temperature at ˜5° C./min under a constant N₂ gas sweep, held at the desired higher heating temperature and then cooled. In addition, in the vapor pathway, biochar, previously produced at a higher heating temperature may be added to simulate the adsorption of vapors onto biochar in a cooler section of a reactor. Finally, a mixture of biomass and biochar may be loaded into the heated zone of the reactor and pyrolyzed simultaneously. This illustrates the effect of pyrolysis of virgin biomass (either from the core of feed material, or in a secondary reactor) in the presence of a high temperature biochar. Vapors from each experiment are collected in a bubble trap containing a 1:1 by volume mixture of water and methanol.

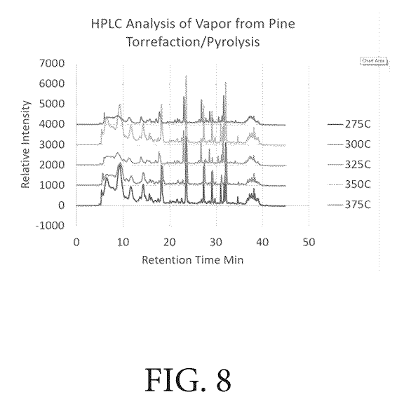

Soluble chemistry adsorbed on the biochar surface was extracted following a solvent extraction method, similar to that disclosed in U.S. Pat. Nos. 10,265,670, 10,065,163 and 11,097,421, all of which are incorporated by reference in this application in their entirety. These extracts and collected condensed vapors were analyzed after appropriate dilution using an HPLC equipped with a diode array detector operated under a water/acetonitrile gradient ranging from 10%-50% acetonitrile from 0-30 minutes and increasing to 100% acetonitrile at 31 minutes. FIG. 8 shows the effect of torrefaction/pyrolysis temperatures between 275 and 375° C. on the composition of collected vapors. While minor variations exist between peak ratios, the composition of the collected vapor is highly consistent between all samples, heavily favoring highly to moderately water soluble fractions eluted during the first 30 minutes of analysis with weak polar compounds eluting at later times. The compounds consist of a variety of phenolic derivatives, sugars, lower molecular weight acids and aldehydes and other volatile organics with mixed effects on plant germination and development.

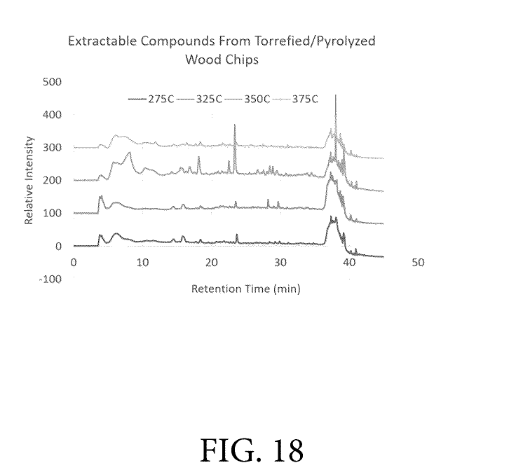

FIG. 18 shows the residual chemistry extractable from the biochar. The biochar extractives show fewer primary peaks during the first 30 minutes of analysis with a higher percentage of polar soluble compounds retained until 35 minutes or later compared to the collected vapor phase. The effect of temperature is also more pronounced with increasing water soluble fractions from 275-350° C. followed by a marked decrease in all signal intensity at 375° C.

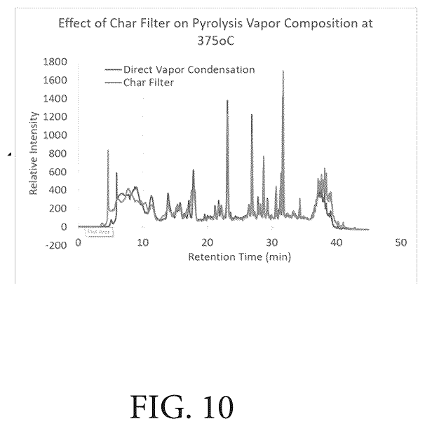

To further examine the division of products between the solid and vapor phase, biochar produced at 400° C. in a rotary kiln was positioned in the tube furnace out-side of the heating zone. Fresh biomass was pyrolyzed at 375° C. and the recovered vapors and extracts from biochar analyzed. A sample of the recovered biochar was subsequently placed back in the tube furnace and heated in one instance to 200° C. and a second sample to 250° C. In both instances the evolved vapors were again captured. As illustrated in FIG. 10, which illustrates the effect of biochar filter on pyrolysis vapors composition at 375° C., the effect of biochar filter is apparent even on the collected vapors. As can be seen, a marked increase in polar soluble compounds retained to 37-40 minutes is observed compared to the control as well as reductions in several water-soluble compounds with retention time below 20 minutes.

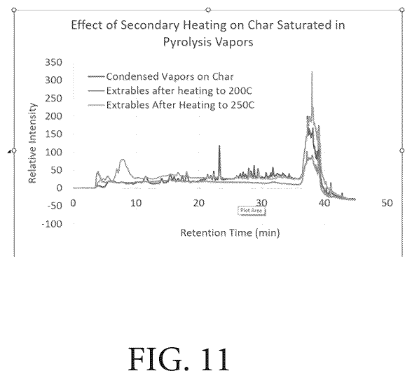

As illustrated in FIG. 11, which illustrates the effects of secondary heating on biochar saturated in pyrolysis vapors, in addition to the increased polar composition of the pyrolysis vapors, a substantial fraction of the vapors absorbed on the biochar filter were also polar soluble. These compounds remained markedly stable on the biochar even after being subjected to secondary heating at 200 and 250° C. At secondary heating temperatures of 200° C. water soluble residuals are largely driven off of the chars. More interestingly, at secondary treatment temperature of 250° C. absorbed polar fractions appear to continue thermal degradation with water soluble peaks again appearing at retention times less than 30 minutes. As the biochar used for absorption was produced near 400° C. this degradation is expected to be a result of reactions within the adsorbed pyrolysis vapors.

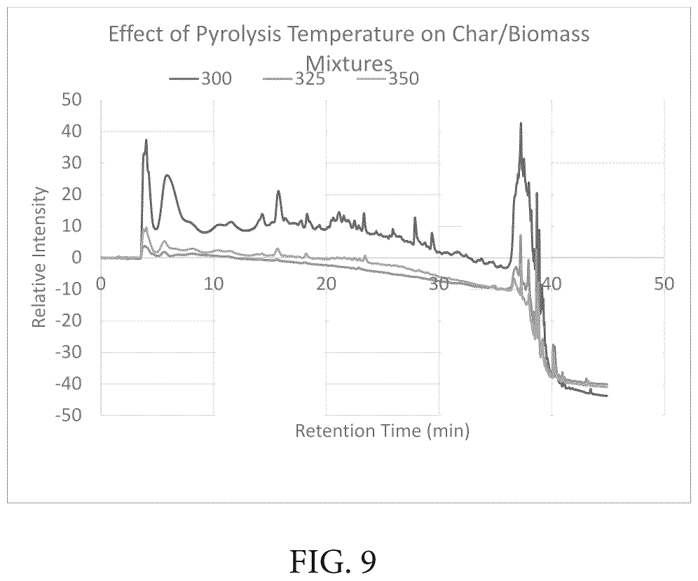

As a final analysis virgin biomass was mixed at a 1:1 volume ratio with biochar, previously produced at 400° C. and found to contain minimal native extractives. Mixtures were pyrolyzed at 300-350° C. Extracts were taken from chars as previously discussed and analyzed by HPLC. As shown in FIG. 9, which shows the effect of pyrolysis temperature on the biochar/biomass mixture, the results show reduced retention of water-soluble compounds compared to equivalent temperatures without the inclusion of chars. This suggests increased reaction of these fractions on the biochar surface. At 350° C. a reduction in polar soluble humic/fulvic like fractions is observed, with formation of distinct peaks at less than 30 minutes retention time. These peaks are consistent with those seen in FIG. 11 after reheating chars to 250° C.

The summary of this work highlights that a mixture of soluble pyrolysis compounds can be isolated from pyrolysis chars that is distinct from condensed pyrolysis vapors referred to variously as “bio-oil”, “pyrolysis-oil”, “wood vinegar”, and “pyroligneous acid”. The composition of this chemistry is altered by the presence of previously formed chars during the pyrolysis of virgin biomass and the presence of biochar within the exiting and cooling vapor stream. Highlighted is the use of a batch kiln to selectively obtain pyrolysis derived mixtures that favor polar soluble humic and fulvic like compounds with discrete water soluble compounds.

### D. Biochar Production Methods

The ultimate composition of matter discussed in section B above is obtained using thermally processed biomass that has experienced two, or preferably more, distinct higher heating temperatures. The first heat treatment temperature should result in a biomass surface temperature of at least 375° C. and preferably greater than 400° C. The temperature in the reactor may be, in this first heat treatment in a range, for example, between 40° and 600° C. Exposure to this temperature (i.e., hold time) should be for a period less than required to fully heating the biomass particle to 250° C. In other words, the center of the biomass particle should remain at a temperature at or below 250° C. but preferably below the subsequent higher heating temperatures.

A subsequent heating condition should ensure that additional uncharred biomass reaches a minimum thermal processing temperature of at least 300° C. at its core, but no more than 350° C. In this subsequent heating stage, the reactor temperature may be anywhere from 300 to 500° C. In addition, separation of the vapor and biochar streams should occur at reactor temperatures below 300° C. and preferably 150-300° C. and most preferably over 200-250° C. This combination effectively allows the formation of a discrete mix of water-soluble signaling compounds, rapidly available within the soil environment, as well as polar solvent soluble humic and fulvic like compounds expected to retain extended residency on biochar particles and within the soil profile due to reduced solubility in the aqueous phase. As explained further below, there are a range of production techniques that may be suited for pyrolysis of the biomass.

Additional heating zones between the first and subsequent discussed above may also be present and are intended to be included within the scope of this patent. For example, a pyrolysis system that first heats a biomass feed to a surface temperature of 425° C. in a 500° C. reactor, with a second stage occurring at 400° C. that raises the core temperature of biomass particles to 275° C., a 3rd stage at 350° C. that raises the biomass core temperature to 310° C. and a 4th stage at 250° C. prior the system discharge. In the given example stages 1 and 3 meet the discussed criteria of this disclosure, the additional stages are also considered as covered here.

In addition, two or more discreet pyrolysis reactors may be employed to achieve this effect. In this form, it is possible during production, to further tailor the resulting biochar and increase desirable compounds by the addition of raw biomass to the subsequent heating stage with the biochar, which raw biomass may, for example be wood. In this form, biomass may be fully converted to biochar at temperatures of 400° or greater without concern of excessive core temperature. Reactor temperatures of the subsequent stage should ensure that fresh biomass is heated such that the major fraction of new biomass is heated to 300-350° C., for example with a reactor temperature of 300-350° C. Further, during the pyrolysis, an inert sweep gas may be introduced to control vapor residence time and dilute oxygen may also be added to assist with maintaining pyrolysis temperatures. The biochar may also be oxidized after the biomass is pyrolyzed, for example, through exposure to an oxidizing gas, or in accordance with other methods disclosed above.

Regardless of other design and operation considerations, the operation of kilns and retorts may include use sweep gases such as nitrogen, carbon dioxide or combustion gases. Operation may also include the use of oxygen at up to 10% stoichiometric combustion rates to allow autothermal pyrolysis to occur. Whether by forced or natural convection, vapors must be removed from the kiln, operational pressure associated with operation should be between-1 and 1 inches of water, preferably between-0.5 and 0.5 inches of water and most preferably between-0.25 and 0.25 inches of water. These conditions allow adequate vapor-char interactor to occur for the deposition of desirable compounds. Vapor removal from the system may occur from any orientation in a static batch system or may occur either counter or co-current to biomass flow in a continuous system, preferably in a co-current flow pattern.

a. Fixed Bed Batch Reactor

Batch pyrolysis systems allow for extended residence times, sometimes on the order of days for pyrolysis to occur. This is useful for evenly processing large pieces of material without subjecting the outer edges of the material to excessively high temperatures. Continuous modes of operation are preferred however to limit the total processing foot-print required to achieve a given production rate. In a continuous system, optimization of throughput will generally result in reduced residence time, resulting in higher reactor set points, but biomass temperatures that are below reactor set points. FIG. 13 provides a series of tests performed in a rotary kiln and the initial reactor set point temperature. An initial examination of the TGA profile obtained from biochar produced at a 325° C. set point, shows a much lower degree of pyrolysis than 300° C. in the batch system. It is not until a set point of 350° C. that more extensive pyrolysis is observed. This trend continues with pyrolysis at 375° C. more akin to batch reactor pyrolysis at 325 and 400° C. better approximating the results of pyrolysis at 375 in the batch system.

Within the temperature ranges explored here it is apparent that for the particular continuous kiln design and operational parameters run here that the apparent higher heating temperature is approximately 25-50° C. lower than the set point.

In addition to the batch kiln operation discussed here, a range of production techniques are available that can achieve these results as discussed in the examples below.

b. Layer Method in Traditional Kiln

In this method a layer of biomass is initially combusted/pyrolyzed. Once the layer has sufficiently charred, fresh material is added. This process is repeated until the kiln reaches capacity. In this method, a biomass biochar mixture is maintained throughout the production process, resulting in various degrees of final pyrolysis as well as significant time for vapor biochar interactions to occur. This process is analogous to a “top load-updraft gasifier, though when used exclusively for biochar production operators will strive to reduce the stoichiometric quantity of air from approximately 30% typical for gasification to below 10%.

c. Rotary Hearth Furnace

Another method of production involves the use of a rotary hearth furnace. In this set up, biomass is feed through the top of the system, and retained on a perforated or mesh tray. A moving sweep arm moves the solid material around the reactor toward a gap, allowing the biomass/biochar to move to the next tray. Alteration in air supply, feed rate, or external heat source can be used to provide a temperature gradient across the trays. Through control of the feed rate and feed particle size, it is possible to obtain significant pyrolysis on the outer surface of the biomass particle while the interior remains unmodified or only moderately thermally modified. Such systems allow for gradients in pyrolysis not only to exist within the material bulk, but within the particle as well. In this system, pyrolysis of the center of the biomass feed particle occurs ideally just prior to exit of the final stage. In this way, vapors produced during the pyrolysis may react and adsorb on the solid pore walls of the biochar particle prior to entering the primary gas stream. At that point the vapor may also interact with biochar held on other trays before existing the system. Similar to a vertically aligned rotary hearth kiln, a horizontal rotary drum may be operated in a similar manner with either air inlet for autothermal operation or multiple independent heating zones providing the desired thermal gradient. In either case, particle size, temperature and rotational rate can be utilized to affect the final biochar properties.

d. Isolated Sequential Pyrolysis Stages

Yet another third method for producing biochars with varied temperature profiles is the use of isolated, sequential pyrolysis stages. In this set up, biomass is first pyrolyzed at elevated temperatures. After the initial pyrolysis the resulting biochar can be processed again at a lower temperature (if pyrolysis was not completed) or mixed in a desired ratio with fresh biomass and pyrolyzed again. In this way the desired biochar profile and desired volatilization temperature may be individually and more specifically controlled. Such a method, is operation agnostic and may utilize any number of batch or continuous pyrolysis systems known to the art.

### E. Biochar Treatment

Following pyrolysis, the final composition of a biochar may be modified by several methods. The residual compounds and biochar structure may be modified by a variety of oxidative methods known to the art, including gas phase oxidation such as air at temperatures greater than 100° C. or ozone, or wet acid oxidation methods, such soaking with hot nitric acid, sulfuric acid hydrogen peroxide or other oxidizing agents. Residual compounds may be further modified by the incorporation of a washing procedure to remove undesired compounds or an impregnation procedure to add additional compounds. Based on these methods, a post-pyrolysis biochar treatment process, (e.g. using vacuum, surfactant or ultrasonic treatment, or a combination thereof), may include up to three steps, which in certain applications, may be combined: (i) oxidation, (ii), washing and/or (iii) impregnation of the pores with an additive or reactant. When the desired additive is the same as that being inoculated into the pores, e.g., water, the step of washing the pores and inoculating the pores with an additive may be combined.

Oxidation is generally performed to alter the residual compounds and pore surface of a biochar. The primary goal being to increase hydrophilicity of the surface and increase the quantity of acidic functional groups such as carboxylic acid. Oxidation steps may also alter the distribution of soluble chemistry on biochar through chemical reaction, solvation, or volatilization. In one example, biochar, dried and held at 120° C. for 4 hours will lose moisture, but may also lose other light organic residuals such as acetic and formic acid. Mild oxidation of the char surface and adsorbed chemistry may also occur. In another iteration, treatment with ozone will preferentially degrade aromatic carbons, both adsorbed chemistry and on the biochar surface. Degree of modification will depend on the ozone concentration, treatment time and reaction temperature, but will result in increased hydrophilicity of the resulting char and increased water and polar solvent soluble compounds. Excessive treatment may result in complete ashing of sample. In another example biochar may be soaked in a boiling or refluxed nitric acid solution of 15M for a period of 10 minutes to 24 hours. The reacted char can then be rinsed to remove residual acid. In such a treatment, residual soluble chemistry will be essentially removed from the char, however the surface will be highly oxidized with a large increase in acidic surface functional groups.

While not exclusive, washing is generally done for one of three purposes: (i) to modify the surface of the pore structure of the biochar (i.e., to allow for increased retention of liquids); (ii) to modify the pH of the biochar; and/or (iii) to remove desirable or undesirable compounds or gases.

Treatment methods of this invention can be used to remove residual compounds, including but not limited to heavy metals, transition metals, inorganic mineral compounds, and residual organic compounds (ROCs), both volatile organic compounds (VOCs) and heavy ROCs. Some residual compounds may be deleterious in certain applications, including, but not limited to, polyaromatic hydrocarbons, polychlorinated biphenyls, dioxins, phenols, benzaldehydes, and furans. This treatment method may also extract compounds that are desirable for use in certain applications, for example in agriculture or animal applications. Some beneficial compounds that could be extracted include, but are not limited to, macronutrients, secondary nutrients, micronutrients, vitamins, organic compounds that microbes feed on, or signaling chemicals. Thus extraction, and in particular the treatment described previously, can be used to clean the biochar of certain undesirable compounds or to collect desirable compounds, or to do both.

In the simplest terms, the invention is a set of methods that extract or remove some amount of residual compounds from a biochar. Of particular interest is the removal of organic compounds from the biochar, but it is not the only one. Other potential compounds could include inorganic compounds such as ash or minerals. The extraction method can be selected to remove specific targeted compounds, specific groups of targeted compounds, or a broad range of compounds from the biochar. The purpose of the extraction or removal can be to improve the biochar, to collect some or all of the removed compounds, or a combination of both improving the biochar and collecting removed compounds. In some cases, an extraction may remove a broad range of compounds and then the extract material could be refined or distilled to collect the desired compound or group of compounds. This refined extract could then be used as its own product, disposed of, or be reincorporated into the biochar product. Alternatively, the resulting non-purified extract could also be used as its own product, disposed of, or be reincorporated into the biochar product.

The rationale for treating the biochar after pyrolysis is that given the large pore volume and large surface are of the biochars, it is most efficient to make significant changes in the physical and chemical properties of the biochar by treating both the internal and external surfaces and internal pore volume of the biochar. Testing has demonstrated that if the biochar is treated, at least partially, in a manner that causes the forced infusion and/or diffusion of liquids into and/or out of the biochar pores (through mechanical, physical, or chemical means), certain properties of the biochar can be altered or improved over and above simply contacting these liquids with the biochar. By knowing the properties of the raw biochar and the optimal desired properties of the treated biochar, the raw biochar can then be treated in a manner that results in the treated biochar having controlled optimized properties.

For purposes of this application, treating and/or washing the biochar in accordance with the present invention may involve more than a simple wash or soak, which generally only impacts the exterior surfaces and a small percentage of the interior surface area. “Washing” or “treating” may involve treatment of the biochar in a manner that causes the forced, accelerated or assisted infusion and/or diffusion of liquids and/or additivities into and/or out of the biochar pores (through mechanical, physical, or chemical means) such that certain properties of the biochar can be altered or improved over and above simply contacting these liquids with the biochar or so that treatment becomes more efficient or rapid from a time standpoint over simple contact or immersion.

In particular, effective treatment processes can remove desirable or undesirable substances from pore surfaces or volume, and impact anywhere from between 10% to 99% or more of pore surface area of a biochar particle. By modifying the usable pore surfaces through treatment and removing substances from the pore volume, the treatment itself can extract desirable compounds, or the resulting treated biochars can be more suitable for future extractions, or used in seed coating or slurries where those desirable compounds will be more available. Through the use of treated biochars and biochar extracts, agricultural applications can realize increased nutrient efficiency, reduced nutrient usage, increased yields, increased yields with lower water requirements and/or nutrient requirements, increases in beneficial microbial life, improved performance and/or shelf life for inoculated bacteria, and any combination and variation of these and other benefits.

Treatment further allows the biochar to be modified to possess certain known properties that enhance the use and availability of desired residual compounds of biochar. As explained further below, treatment can (i) repurpose problematic biochars, (ii) handle changing biochar material sources, e.g., seasonal and regional changes in the source of biomass, (iii) provide for custom features and functions of biochar for particular purposes; (iv) increase the retention properties of biochar, (v) provide for large volumes of biochar having desired and predictable properties, (vi) provide for biochar having custom properties, (vii) handle differences in biochar caused by variations in pyrolysis conditions or manufacturing of the “raw” biochar; and (viii) address the majority, if not all, of the problems that have, prior to the present invention, stifled the large scale adoption and use of biochars.

Treatment can modify and wash both the interior and exterior pore surfaces, remove beneficial or harmful chemicals, introduce substances to adjust the residual chemicals, and/or alter certain properties of the biochar and the pore surfaces and volumes. This is in stark contrast to simple washing which generally only impacts the exterior surfaces and a small percentage of the interior surface area. Treatment can further be used to chemically modify or coat substantially all of the biochar pore surfaces with a surface modifying agent or impregnate the pore volume with additives or treatment to provide a predetermined feature to the biochar, e.g., surface charge and charge density, surface species and distribution, magnetic modifications, and water absorptivity and water retention properties. Just as importantly, treatment can also be used to remove desirable substances from the biochar, such as PGRs, Karrikins, small-molecule biostimulants, humic/fulvic-like compounds, or undesirable substances, like dioxins or other toxins, either through physical removal or through chemical reactions.

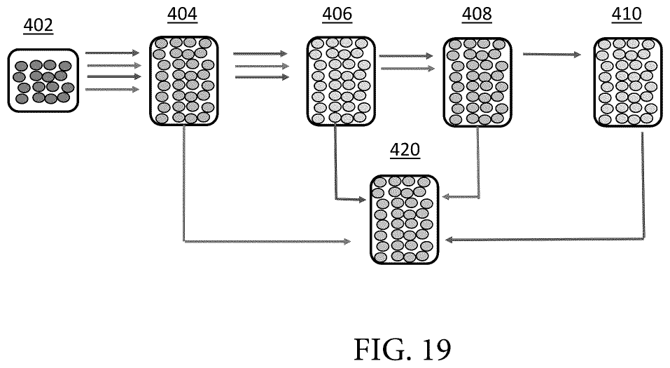

FIG. 19 is a schematic flow diagram of one example treatment process 400 for use in accordance with the present invention. As illustrated, the treatment process 400 starts with raw biochar 402 that may be subjected to one or more reactors or treatment processes prior to bagging 420 the treated biochar for resale (e.g. as seed coating), further processing (e.g extraction or slurry), or disposal. For example, 404 represents reactor 1, which may be used to treat the biochar. The treatment may be a simple water wash or may be an acid wash used for the purpose of altering the pH of the raw biochar particles 402. The treatment may also contain a surfactant or detergent to aid the penetration of the treatment solution into the pores of the biochar. The treatment may optionally be heated, cooled, or may be used at ambient temperature or any combination of the three. The treatment may also include an additive to react and thus adjust the residual chemistry in the biochar or adjust the biochar surface properties. For some applications, such as creating a biochar slurry, and depending upon the properties of the raw biochar, a water and/or acid/alkaline wash 404 (the latter for pH adjustment) may be the only necessary treatment prior to bagging the biochar 420. If, however, the moisture content of the biochar needs to be adjusted or further extraction of liquid from the biochar is desired, the treated biochar may then be put into a second reactor 406 for purposes of reducing the moisture content in the washed biochar. From there, the treated and moisture adjusted biochar may be bagged 420 for future treatment, use, sale, or disposal.

Again, depending upon the starting characteristics of the raw biochar and the intended final product and application, further processing may still be needed or desired. In this case, the treated moisture adjusted biochar may then be passed to a third reactor 408 for further treatment or extraction, which may include the addition of an additive or reactant. Thereafter, the biochar may be bagged 420, or may be yet further processed, for example, in a fourth reactor 410 to have further moisture removed from the biochar. Further moisture adjustment may be accomplished by placing the biochar in a fourth moisture adjustment reactor 410 or circulating the biochar back to a previous moisture adjustment reactor (e.g. reactor 406). Those skilled in the art will recognize that the ordering in which the raw biochar is processed and certain processes may be left out, depending on the properties of the starting raw biochar and the desired application for the biochar. For example, the treatment and additive or reactant processes may be performed without the moisture adjustment step, additive or reactant processes may also be performed with or without any treatment, pH adjustment or any moisture adjustment. All the processes may be completed alone or in the conjunction with one or more of the others.

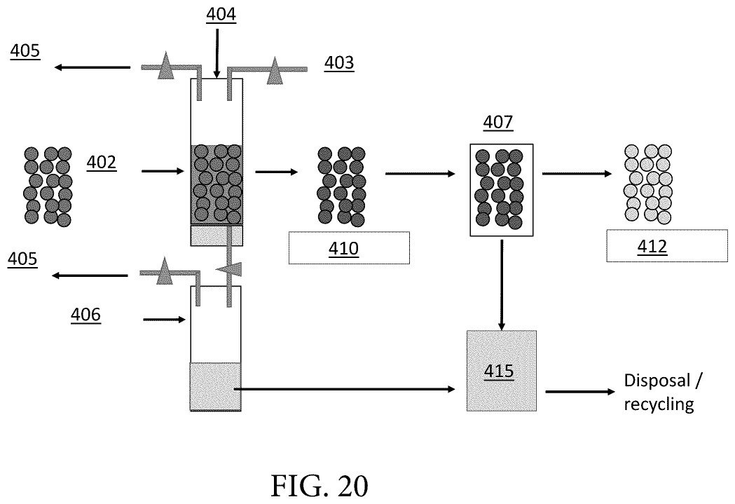

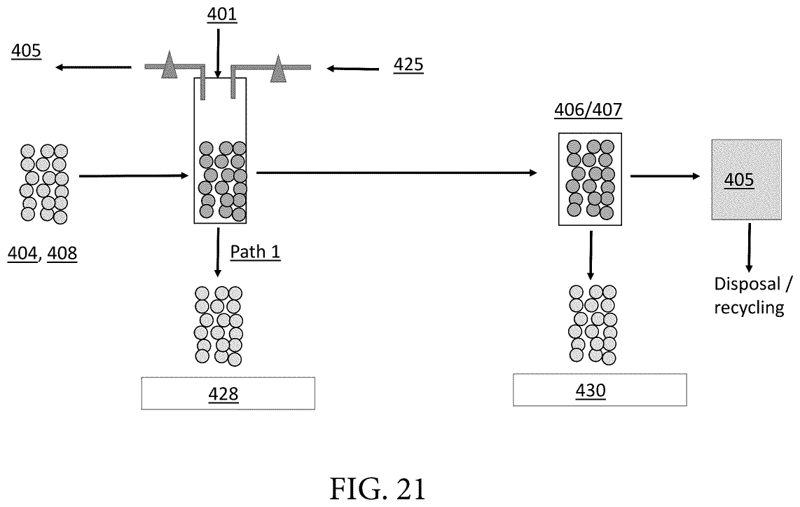

For example, FIG. 20 illustrates a schematic of one example of an implementation of biochar processing that includes washing the pores and both pH and moisture adjustment. FIG. 21 illustrates yet another example of an implementation of biochar processing that includes additive or reactant impregnation.

As illustrated in FIG. 20, raw biochar 402 is placed into a reactor or tank 404. A washing or treatment liquid 403 is then added to a tank and a partial vacuum, using a vacuum pump, 405 is pulled on the tank. The treating or washing liquid 403 may be used to clean or wash the pores of the biochar 402 or adjust the chemical or physical properties of the surface area or pore volume, such as pH level, usable pore volume, or VOC content, among other things. The vacuum can be applied after the treatment liquid 403 is added or while the treatment liquid 403 is added. Thereafter, the washed/adjusted biochar 410 may be moisture adjusted by vacuum exfiltration 406 to pull the extra liquid from the washed/moisture adjusted biochar 410 or may be placed in a centrifuge 407, heated or subjected to pressure gradient changes (e.g., blowing air) for moisture adjustment. The moisture adjusted biochar 412 may then be bagged or subject to further treatment. Any excess liquids 415 collected from the moisture adjustment step may be collected as an extract product, disposed of, or recycled, as desired. Optionally, biochar fines may be collected from the excess liquids 415 for further processing, for example, to create a slurry or seed coating treatment.

Optionally, rather than using a vacuum pump 405, a positive pressure pump may be used to apply positive pressure to the tank 404. In some situations, applying positive pressure to the tank may also function to force or accelerate the washing or treating liquid 403 into the pores of the biochar 402. Any change in pressure in the tank 404 or across the surface of the biochar could facilitate the exchange of gas and/or moisture into and out of the pores of the biochar with the washing or treating liquid 403 in the tank. Accordingly, changing the pressure in the tank and across the surface of the biochar, whether positive or negative, is within the scope of this invention.

As illustrated FIG. 21, the washed/adjusted biochar 410 or the washed/adjusted and moisture adjusted biochar 412 may be further treated by inoculating or impregnating the pores of the biochar with an additive or reactant 425. The biochar 410, 412 placed back in a reactor 401, an additive solution 425 is placed in the reactor 401 and a vacuum, using a vacuum pump, 405 is applied on the tank. Again, the vacuum can be applied after the additive solution 425 is added to the tank or while the additive solution 425 is being added to the tank. Thereafter, the washed, adjusted and impregnated/reacted biochar 428 can be bagged for future treatment, use, sale, or disposal. Alternatively, if further moisture adjustment is required, the biochar can be further moisture adjusted by vacuum filtration 406 to pull the extra liquid from the washed/moisture adjusted biochar 410 or may be placed in a centrifuge 407 for moisture adjustment. The resulting biochar 430 can then be bagged for future treatment, use, sale, or disposal. Any excess liquids 415 collected from the moisture adjustment step may be collected as an extract product, disposed of, or recycled, as desired. Optionally, biochar particulates or “fines” which easily are suspended in liquid may be collected from the excess liquids 415 for further processing, for example, to create a slurry, seed coating, or merely a biochar product of a consistently smaller particle size. As described above, both processes of the FIGS. 20 and 21 can be performed with a surfactant solution in place of, or in conjunction with, the vacuum 405.

While known processes exist for the above described processes, research associated with the present invention has shown improvement and the ability to better control the properties and characteristics of the biochar if the processes are performed through the infusion and diffusion of liquids into and out of the biochar pores. These diffusions and infusions of liquids can additionally adjust, make available, or collect the residual compounds of the biochar as well. One such treatment process that can be used is vacuum impregnation and vacuum and/or centrifuge extraction. Another such treatment process that can be used is the addition of a surfactant to infused liquid, which infused liquid may be optionally heated, cooled, or used at ambient temperature or any combination of the three.

Since research associated with the present invention has identified what physical and chemical properties have the highest impact on plant growth and/or soil health, the treatment process can be geared to treat different forms of raw biochar to achieve desired compounds that enhance these characteristics. For example, if the pH of the biochar needs to be adjusted to enhance the amount, availability or extractability of the desired residual compounds found in the biochar, the treatment may be the infusion of an acid or base solution into the pores of the biochar using vacuum, surfactant, or other treatment means. This pore infusion treatment may be conducted independently, or as part of a series of treatment steps which may alternatively include gas phase treatment of the biochar through, for example drying at temperatures in excess of 105° C., or contact with elevated concentrations of Ozone. Such gas phase reactions may selectively modify the chemical surface of the biochar, changing the adsorbed chemicals and modifying the pore wall chemistry and structure of the biochar. Treatment of pore infusion through, for example, the rapid, forced infusion of liquid into and out the pores of the biochar, has further been proven to sustain the adjusted pH levels of the treated biochar for much longer periods than biochar that is simply immersed in an acid solution for the same period of time. By way of another example, by adjusting the moisture content, excess liquid and other selected substances (e.g. Plant Growth Regulators (PGRs), phytohormones, Karrikins, small molecule biostimulant compounds, humic/fulvic-like compounds, chlorides, dioxins, ash, and other chemicals, to include those previously deposited by treatment to catalyze or otherwise react with substances on the interior or exterior surfaces of the biochar) can be extracted from the pores using vacuum and/or centrifuge extraction or by using various heating techniques. The above describes a few examples of treatment that result in treated biochar having desired properties for access & extraction and the desired residual chemistry identified to enhance soil health and plant life.

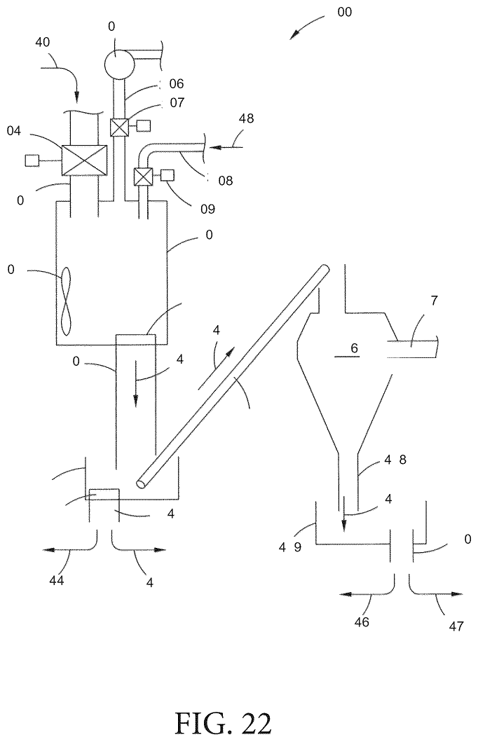

FIG. 22 illustrates one example of a system 500 that utilizes vacuum impregnation to treat raw biochar. Generally, raw biochar particles, and preferably a batch of biochar particles, are placed in a reactor, which is connected to a vacuum pump, and a source of treating liquid (i.e. water or acidic/basis solution). When the valve to the reactor is closed, the pressure in the reactor is reduced to values ranging from 750 Torr to 400 Torr to 10 Torr or less. The biochar is maintained under vacuum (“vacuum hold time”) for anywhere from seconds to 1 minute to 10 minutes, to 100 minutes, or possibly longer. By way of example, for about a 500 pound batch of untreated biochar, a vacuum hold time of from about 1 to about 5 minutes can be used if the reactor is of sufficient size and sufficient infiltrate is available to adjust the necessary properties. While under the vacuum the treating liquid may then be introduced into the vacuum chamber containing the biochar. Alternatively, the treating liquid may be introduced into the vacuum chamber before the biochar is placed under a vacuum. Optionally, treatment may also include subjecting the biochar to elevated temperatures from ambient to about 250° C. or reduced temperatures to about-25° C. or below, with the limiting factor being the temperature and time at which the infiltrate can remain flowable as a liquid or semi-liquid.

The infiltrate or treating liquid is drawn into the biochar pore, and preferably drawn into the macropores and mesopores. Depending upon the specific doses applied and pore structure of the biochar, the infiltrate can coat anywhere from 10% to 50% to 100% of the total macropore and mesopore surface area and can fill or coat anywhere from a portion to nearly all (10%-100%) of the total macropore and mesopore volume.

As described above, the treating liquid can be left in the biochar, with the batch being a treated biochar batch ready for further treatment, extraction, packaging, shipment and use in an agricultural or other application. The treating liquid may also be removed through drying, subsequent vacuum processing, centrifugal force (e.g., cyclone drying machines or centrifuges), with the batch being a treated biochar or liquid extraction batch ready for further treatment, extraction, packaging, shipment and use in an agricultural application. A second, third or more infiltration, removal, infiltration and removal, and combinations and variations of these may also be performed on the biochar with optional drying steps between infiltrations to remove residual liquid from and reintroduce gasses to the pore structure if needed. In any of these stages the liquid may contain organic or inorganic surfactants to assist with the penetration of the treating liquid or additives to adjust the residual chemistry in the biochar or extraction liquid.

As illustrated in FIG. 22, a system 500 for providing a biochar, preferably having predetermined and uniform properties. The system 500 has a vacuum infiltration tank 501. The vacuum infiltration tank 501 has an inlet line 503 that has a valve 504 that seals the inlet line 503. In operation, the starting biochar is added to vacuum infiltration tank 501 as shown by arrow 540. Once the tank is filled with the starting biochar, a vacuum is pulled on the tank, by a vacuum pump connected to vacuum line 506, which also has valve 507. The starting biochar is held in the vacuum for a vacuum hold time. Infiltrate, as shown by arrow 548 is added to the tank 501 by line 508 having valve 509. The infiltrate is mixed with the biochar in the tank 501 by agitator 502. The mixing process is done under vacuum for a period of time sufficient to have the infiltrate fill the desired amount of pore volume, e.g., up to 100% of the macropores and mesopores.

Alternatively, the infiltrate may be added to the vacuum infiltration tank 501 before vacuum is pulled on the tank. In this manner, infiltrate is added in the tank in an amount that can be impregnated into the biochar. As the vacuum is pulled, the biochar is circulated in the tank to cause the infiltrate to fill the pore volume. To one skilled in the art, it should be clear that the agitation of the biochar during this process can be performed through various means, such as a rotating tank, rotating agitator, pressure variation in the tank itself, or other means. Additionally, the biochar may be dried using conventional means before even the first treatment. This optional pre-drying can remove liquid from the pores and in some situations may increase the efficiency of impregnation due to pressure changes in the tank.

Pressure is then restored in the tank 501 and the infiltrated biochar is removed, as shown by arrow 541, from the tank 501 to bin 512, by way of a sealing gate 511 and removal line 510. The infiltrated biochar is collected in bin 512, where it can be further processed in several different ways. The infiltrated biochar can be shipped for use as a treated biochar as shown by arrow 543. The infiltrated biochar can be returned to the tank 501 (or a second infiltration tank). If returned to the tank 501 the biochar can be processed with a second infiltration step, a vacuum drying step, a washing step, an extraction step, or combinations and variations of these. The infiltrated biochar can be moved by conveyor 514, as shown by arrow 542, to a drying apparatus 516, e.g., a centrifugal dryer or heater, where water, infiltrate or other liquid is removed by way of line 517, and the dried biochar leaves the dryer through discharge line 518 as shown by arrow 545, and is collected in bin 519. The biochar is removed from the bin by discharge 520. The biochar may be shipped as a treated biochar for use in an agriculture application, as shown by arrow 547. The biochar may also be further processed, as shown by 546. Thus, the biochar could be returned to tank 501 (or a second vacuum infiltration tank) for a further infiltration step. The drying step may be repeated either by returning the dry biochar to the drying apparatus 516, or by running the biochar through a series of drying apparatus, until the predetermined dryness of the biochar is obtained, e.g., between 50% to less than 1% moisture.

The system 500 is illustrative of the system, equipment and processes that can be used for, and to carry out the present inventions. Various other implementations and types of equipment can be used. The vacuum infiltration tank can be a scalable off-axis rotating vessel, chamber or tank. It can have an internal agitator that also when reversed can move material out, empty it, (e.g., a vessel along the lines of a large cement truck, or ready mix truck, that can mix and move material out of the tank, without requiring the tank's orientation to be changed). Washing equipment may be added or utilized at various points in the process, or may be carried out in the vacuum tank, or drier, (e.g., wash fluid added to biochar as it is placed into the drier for removal). Other steps, such as bagging, weighing, the mixing of the biochar with other materials, e.g., fertilized, peat, soil, etc. can be carried out. In all areas of the system referring to vacuum infiltration, optionally positive pressure can be applied, if needed, to enhance the penetration of the infiltrate or to assist with re-infusion of gaseous vapors into the treated biochar. Additionally, where feasible, especially in positive pressure environments, the infiltrate may have soluble gasses added which then can assist with removal of liquid from the pores, or gaseous treatment of the pores upon equalization of pressure.

As noted above, the biochar may also be treated using a surfactant. The same or similar equipment used in the vacuum infiltration process can be used in the surfactant treatment process. Although it is not necessary to apply a vacuum in the surfactant treatment process, the vacuum infiltration tank or any other rotating vessel, chamber or tank can be used. In the surfactant treatment process, a surfactant, such as yucca extract, is added to the infiltrate, e.g., acid wash or water. The quantity of the surfactant added to the infiltrate may vary depending upon the surfactant used. For example, organic yucca extract can be added at a rate of between 0.1-20%, but more preferably 1-5% by volume of the infiltrate. The infiltrate with surfactant is then mixed with the biochar in a tumbler for several minutes, e.g., 3-5 minutes, without applied vacuum. Optionally, a vacuum or positive pressure may be applied with the surfactant to improve efficiency, but is not necessary. Additionally, infiltrate to which the surfactant or detergent is added may be heated or may be ambient temperature or less. Similarly, the mixture of the surfactant or detergent, as well as the biochar being treated may be heated, or may be ambient temperature, or less. After tumbling, excess free liquid can be removed in the same manner as described above in connection with the vacuum infiltration process. Drying, also as described above in connection with the vacuum infiltration process, is an optional additional step. Besides yucca extract, a number of other surfactants and polysorbates may be used for treatment, which include, but are not limited to, the following: nonionic types, such as, ethoxylated alcohols, phenols-lauryl alcohol ethoxylates, Fatty acid esters-sorbitan, tween 20, amines, amides-imidazoles; anionic types, such as sulfonates-arylalkyl sulfonates and sulfate-sodium dodecyl sulfate; cationic types, such as alkyl-amines or ammoniums-quaternary ammoniums; and amphoteric types, such as betaines-cocamidopropyl betaine.

Optionally, the biochar may also be treated by applying ultrasonics. In this treatment process, the biochar may be contacted with a treating liquid that is agitated by ultrasonic waves. By agitating the treating liquid, contaminants may be dislodged or removed from the biochar due to bulk motion of the fluid in and around the biocarbon, pressure changes, including cavitation in and around contaminants on the surface, as well as pressure changes in or near pore openings (cavitation bubbles) and internal pore cavitation.

In this manner, agitation will cause contaminants of many forms to be released from the internal and external structure of the biochar. The agitation also encourages the exchange of water, gas, and other liquids with the internal biochar structure. Contaminants are transported from the internal structure to the bulk liquid (treating fluid) resulting in biochar with improved physical and chemical properties. The effectiveness of ultrasonic cleaning is tunable as bubble size and number is a function of frequency and power delivered by the transducer to the treating fluid

In one example, applying ultrasonic treatment, raw wood based biochar between 10 microns to 10 mm with moisture content from 0% to 90% may be mixed with a dilute mixture of acetic acid and water (together the treating liquid) in a processing vessel that also translates the slurry (the biochar/treating liquid mixture). During translation, the slurry passes near an ultrasonic transducer to enhance the interaction between the fluid and biochar. The biochar may experience one or multiple washes of dilute acetic acid, water, or other treating fluids. The biochar may also make multiple passes by ultrasonic transducers to enhance physical and chemical properties of the biochar. For example, once a large volume of slurry is made, it can continuously pass an ultrasonic device and be degassed and wetted to its maximum, at a rapid processing rate. The slurry can also undergo a separation process in which the fluid and solid biochar are separated at 60% effectiveness or greater.

Through ultrasonic treatment, the pH of the biochar, or other physical and chemical properties may be adjusted and the mesopore and macropore surfaces of the biochar may be cleaned and enhanced. Further, ultrasonic treatment can be used in combination with bulk mixing with water, solvents, additives (fertilizers, etc.), and other liquid based chemicals to enhance the properties of the biochar. After treatment, the biochar may be subject to moisture adjustment, further treatment and/or inoculation using any of the methods set forth above.

### E. Biochar Extract Production

For the production of biochar extracts, it is desirable to select feedstock that has been pyrolyzed under conditions that optimize the target compounds or minimize the amount of undesired compounds required for removal. Further, as explained below, the extract process used can further be tailored to achieve desired resulting extracts.

### 1. Biochar Selection for Extraction

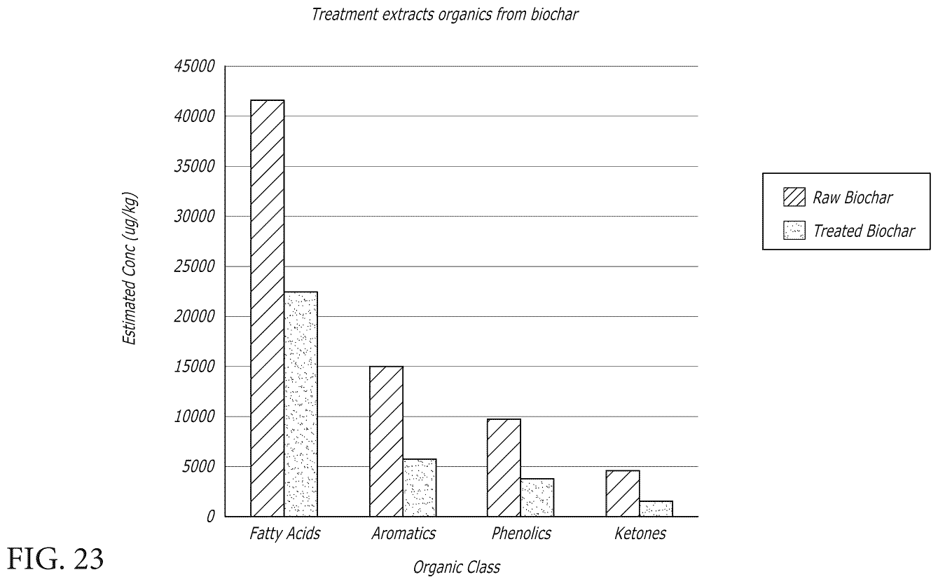

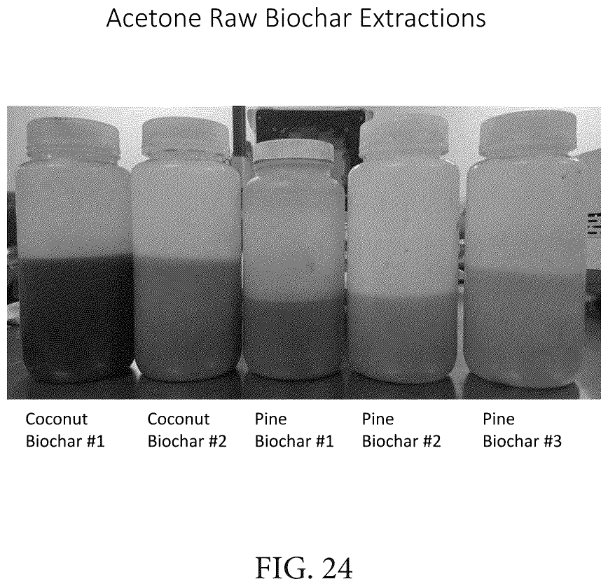

Feedstock selection, pyrolysis conditions, and post treatment each impact the type and quantity of compounds found in the biochar. This is demonstrated by FIG. 23 and FIG. 24. A sample of raw biochar and vacuum treated biochar from the same feedstock were tested using EPA method 8270 to understand what types of semi-volatile residual organic compounds were in the biochar and to what extent they were extracted through the treatment process disclosed previously. The biochar samples were ground prior to analysis and prepared using EPA method 3550. The identified compounds were then grouped into classes: fatty acids, aromatics, phenolics, and ketones. The results of this testing are depicted in FIG. 23. The treatment process successfully extracted a significant amount of the organics in all four classes from the biochar, as shown in the reduced organic levels in the treated biochar versus the raw biochar.

FIG. 24 shows the resulting concentrated extracts using acetone as the extraction liquid from raw biochars sourced from coconut and pine feedstocks. The color and opacity of the differing extracts demonstrates that, depending on biochar feedstock and pyrolysis method, different types and amounts of compounds will be extracted from the biochars using the same extraction method.

As discussed in detail above, feedstock and pyrolysis conditions also determine the amounts of compounds other than ROCs in the biochar and how available they are for extraction. Biomass and biochar particle size can also impact the resulting extract, as well as the age and storage conditions of the biochar.

### 2. Extraction Methods

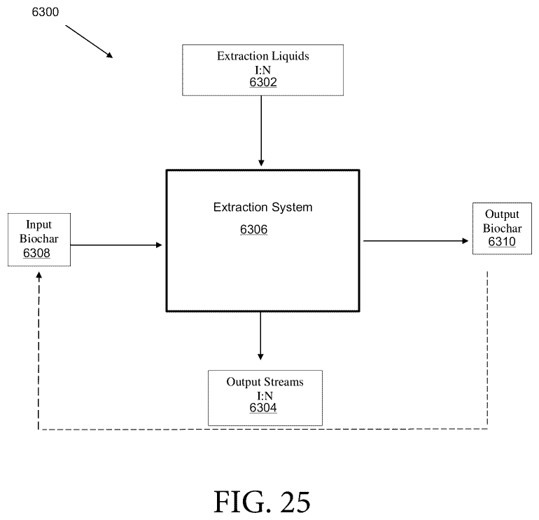

Biochar extraction may exist as part of the biochar wash procedure discussed previously or in combination with prior treatments. As illustrated by the flow chart 6300 shown in FIG. 25, of equal importance is that there can be from 1 to N extraction liquids 6302, and from 1 to N output streams 6304 resulting from the extraction or treatment process system 6306 which includes the input of biochar 6308. These output streams 6104 could be segregated by time, temperature, pressure, solubility, reaction, or even physical or hydrodynamic properties. The extraction system 6306 can be one tank or vessel or it could be a multi-vessel system. The various extraction liquids 6302 may also be introduced at the same time, through the same or multiple openings in varying locations in the treatment system, 6306, or may be introduced at different times in alignment with temperature or pressure changes, or even reactivity/reaction times occurring in the treatment system 6306. The same treatment system 6306 may be used for multiple treatments without removing the biochar 6308. It should also be noted that the output streams 6304 can contain any (or all) of solid, liquid, or gaseous products. As further shown in the FIG. 25, after a round of extraction, the remaining biochar 6310 can be removed and then sent to another stage directly or reintroduced into the same treatment system 6306. The remaining biochar 6310 can also be treated, and then sent to another stage of extraction or post processing.

In addition, the extraction can be done at any time after the biochar is created and can be one step of many in the production of a biochar or a biochar extract product. By way of example, this means an extraction step can be done before, after, or as the treatment method described previously or the biochar can be sized, agglomerated, or slurried before, during, or after an extraction step or the biochar can be inoculated with a microbe before, during, or after an extraction step.

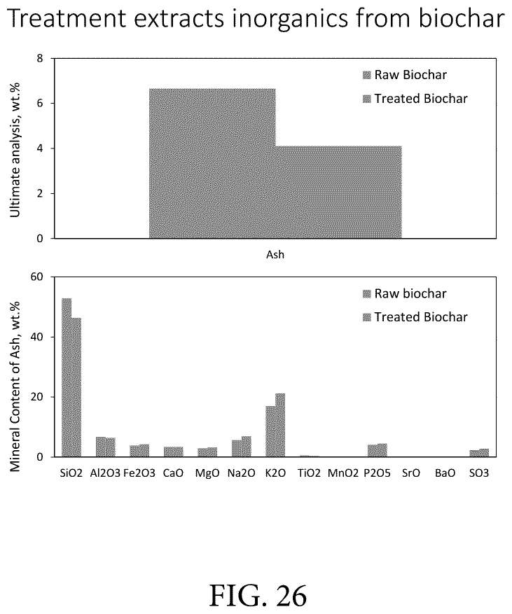

Various materials or media can be used to extract compounds from biochar. Water is the most convenient material to use for extraction but any material or technique that will remove targeted compounds from the biochar can be used. The material could remove the compound through physical or chemical means. For example, using a liquid material, such as water, that the residual compound dissolves in and then removing the liquid is one mechanism for extraction, but that same liquid material may also physically suspend particles and thus when the liquid is removed those solid particles are also removed. These suspended solid particles could either be the residual compound itself, like an ash, or they could be biochar fines that have the residual compounds in them. To restate from previous discussion, the time at which the material is sized can have a dramatic impact on the composition of the extract. The liquid with solid particles could then be filtered to purify these solid residual compounds from the liquid. If the fines contain the residual compound within them, instead of being the residual compounds themselves, then they could be further extracted using any of the methods described in this application. FIG. 26 shows the results of biochar material before and after a post treatment process and demonstrates inorganic removal through treatment where the extraction mechanism is generally physical.

Some other materials that work well to remove residual compounds by means of physical or chemical mechanisms from the biochar are steam, supercritical fluids, or solvents. Depending on the extent and targeted residual organic compounds a solvent extraction may perform better than water. Typical solvents that may be used for removal of residual organic compounds would be water, acidic solutions, alkaline solutions, ionic surfactants, non-ionic surfactants, acetone, acetonitrile, ethyl acetate, organic acids, ethanol, methanol or other polar solvents, hexane or other non-polar organic solvents, ethers, chloroform, furans, ketones, phenolics and dichloromethane.

As with liquid treatment of biochars, various conditions can be applied during the extraction to improve the extent or selectivity of the extraction. One variable that can be adjusted is pressure. The method of extraction can be done under vacuum, at elevated pressures, at atmospheric pressure, or under a pressure gradient, pulse, or variation. The pressure or change of pressure can allow the extraction media to diffuse further into the biochar pores, release gases from internal pores or fine particulates within pores, and thus increase the quantity of compounds captured by the extraction media. Another variable is temperature. The method of extraction can be done at standard temperature, elevated temperatures, or under a temperature gradient, or variation. Since solubility is dependent on temperature, adjusting the temperature can also be used to selectively extract compounds or to adjust the extent of extraction, either increasing or reducing the compounds removed in the extraction media. A third variable is time. The amount of time the extraction liquid is in contact with the biochar will impact the selectivity and extent of extraction of compounds. The time the extraction material has to contact all surfaces of the biochar impacts the amount of compounds that are extracted. Further, the time after the extraction liquid is in contact with the extracted compounds impacts the reaction rate or diffusion rate of the compounds into the liquid. The material used to perform the extraction may be in solid, liquid, gaseous, or supercritical form, with each form having advantages and disadvantages in performing the extraction. The material targeted for extraction from the biochar may also be in solid, liquid, gaseous, or in rare instances supercritical form. Mating the proper technique, with the proper extraction material, to gain a desired extract is a primary focus of this invention.

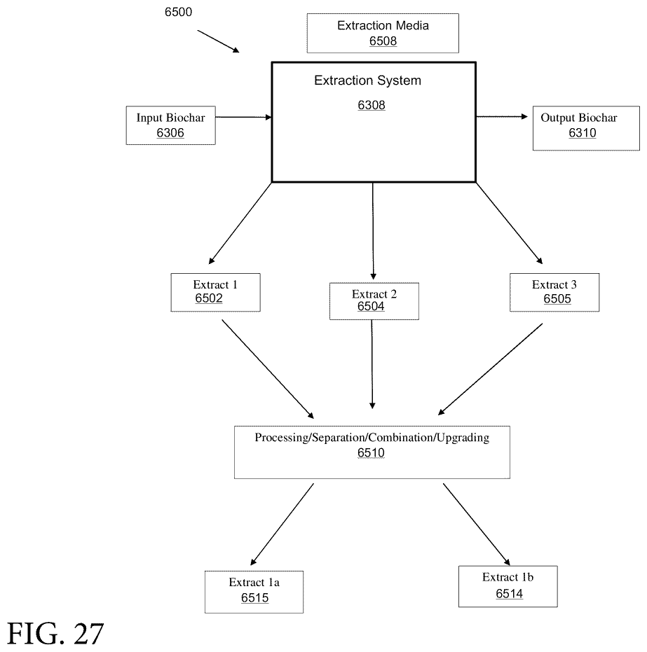

As illustrated by the flow chart 6500 shown in FIG. 27, multiple extracts 6502, 6504, 6506 may be generated from the same extraction media 6508, representing different compositions. For example, using water as the extraction medium and a treatment tank as the extraction system, the pressure in the treatment tank 6308 can be lowered to allow the extraction liquid 6508 to infiltrate a percentage of the pore volume of the input biochar 6306, contacting a larger amount of surface area than would be possible without the pressure change, then the pressure can be returned to atmospheric, followed by water laden with water soluble compounds taken from the output biochar 6310 being removed from the treatment tank 6308 as a first extract 6502. Then, the temperature in the treatment tank 6308 or the temperature of the extraction water can be raised to over 100° C., and a second extract 6504 comprising primarily steam, but also containing other gaseous compounds that volatilize or transition to vapor state at 100° C. or below may be removed as a separate extract. It should be noted that an extract does not need to be in liquid form. As shown in FIG. 27, the gaseous extract 6504 can be routed to further stages for processing, separation, combination, or upgrading at step 6510 independent of whether it remains a gas or is condensed into liquid form. At times, it may be advantageous to leave a particular extract in its native form rather than going through a phase change. At other times, a phase change may be desired. Furthermore, each of the extracts 6502, 6504, 6506 can be subjected to a further separation process at step 6510 after the actual extraction has taken place to create additional extracts 6512, 6514. Some ways to adjust the contents of an extract are variations feedstock, extractant, temperature, level, type, frequency, or direction of agitation, type of pressure variation (either static or dynamic), or other factors.

In some cases, the initial extraction media itself may need to be removed, for example if it, in itself, is phytotoxic, the desired compounds may need to be separated from that media and furthermore may need to be mixed, suspended, or dissolved in a different media. The separation process at step 6510 used to create extracts 6512, 6514 shown in FIG. 27 can involve selective degradation, such as by oxidation, ozonation, UV treatment, enzymatic treatment or chemical or physical separation, including by: filtration, hydrodynamic sorting, centrifugal sorting (centrifuging), chromatography, distillation, freezing, condensation, liquid-liquid extraction, solid-phase extraction, scrubbing, adsorption, flotation, decantation, flocculation, biodegradation, membrane processes, precipitation, melting, separation using electrical charge attraction, repulsion, or by charging the extracted liquids, solids, or gasses, directly, as well as other generally accepted methods for separating materials in mixtures, solutions, or aggregates.

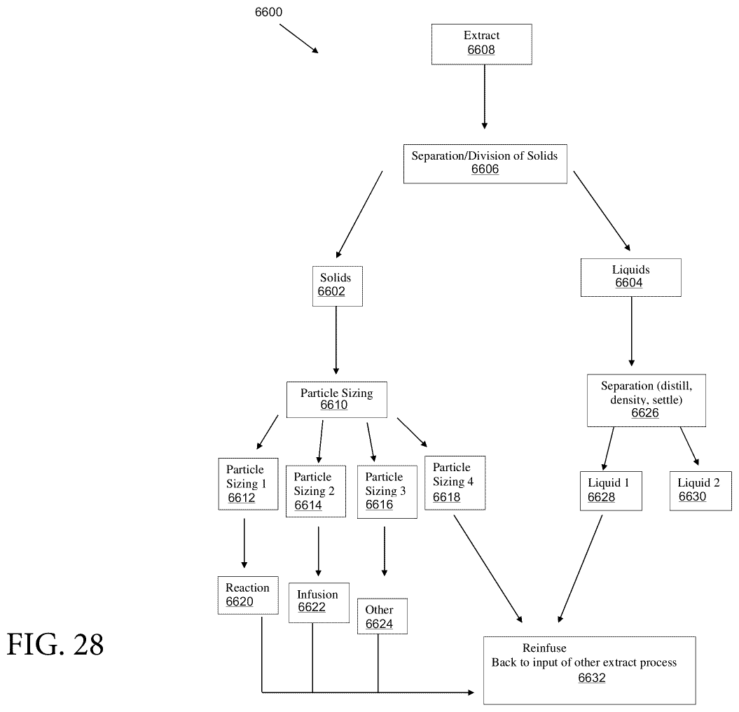

As shown in FIG. 28, solids 6602 and liquids 6604 may also be subjected to a process of separation/division at step 6606 from the input extract 6608. The solids 6602 can be treated in multiple ways, and routed to separate parts of the process, for example, sizing by particle size at step 6610, the resulting particles of like size segregated 6612, 6614, 6616, 6618, and then subjected to additional treatment, e.g. further reaction at step 6620, infusion at step 6622 with, for example, microbes, or other treatment at step 6624, such as suspension into a slurry or agglomeration into granules. Similarly, the liquids 6604 can also be separated using a process of distillation, solvent extraction, settling, density or viscosity separation, or other methods at step 6626. The separated liquids 6628, 6630 can then be moved to other parts of the process, used as an extract, disposed of, or recombined with one or more of the solids or other liquids produced in other parts of the process at step 6632. Infusion at step 6622 with microbes, that is, using microbes to change the state of the material into more advantageous forms, is also a valid and efficacious form of treatment. Microbes may be used to upgrade, solubilize, or modify organic or inorganic compounds found on the interior or exterior surfaces of the biochar. Microbes may also be used in some cases to modify the apparent or functional surface chemistry of the material by occupying exchange sites or by eroding or consuming residual surface compounds which impact the biochar's localized surface charge, availability of free electrons, pH, ion exchange capacity, or other common measurements of surface physical or chemical performance.

In addition to methods of separation for purification, the extracts can also be concentrated through evaporative, condensation, and/or crystallization methods. Some examples of industrial equipment for concentration process are flooded evaporators, rising/falling film evaporators, forced circulation evaporators, vacuum evaporators, multiple effect evaporators, and plate evaporators. In some cases, the extraction media could be fully evaporated off and the remaining material could be resuspended or dissolved in a different media, such as water. This additional concentration step is often needed to make a commercially viable product when the desirable compound is in a low concentration in the extract stream, for example less than 20 wt %, less than 10 wt %, less than 1 wt %, in the ppm range, or in the ppb range. One example of application for this additional concentration step is if the resulting extract product is for seed treatment. Seed treatments can be done upstream, i.e. during seed production, downstream, i.e. in seed batch treatments prior to planting, or during the planting, treatment can be applied to the seeds in furrow. By way of example, typical corn seed treatment rates for bio-stimulant or biocontrol products for upstream applications are about 1-2 fl oz per 100 lb seeds (<0.0005 mL/seed) and downstream applications are about 0.5-1 fl oz per 1000 ft-row or less (<0.05 mL/seed). Thus, removing the non-active liquid solvent from the stream is critical to getting a higher rate of application of the desirable material onto the seed at these very low application rates.

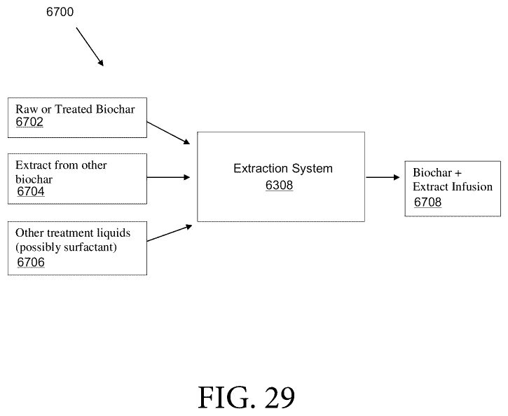

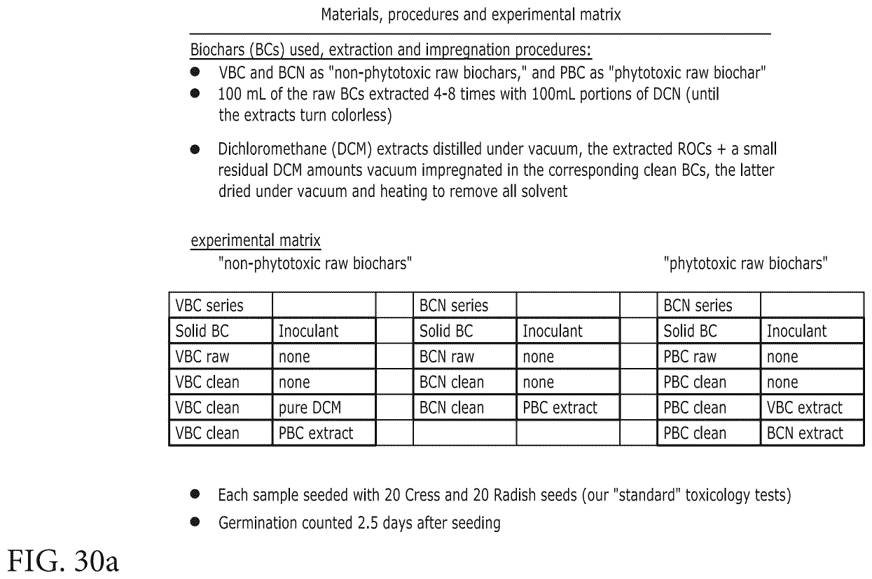

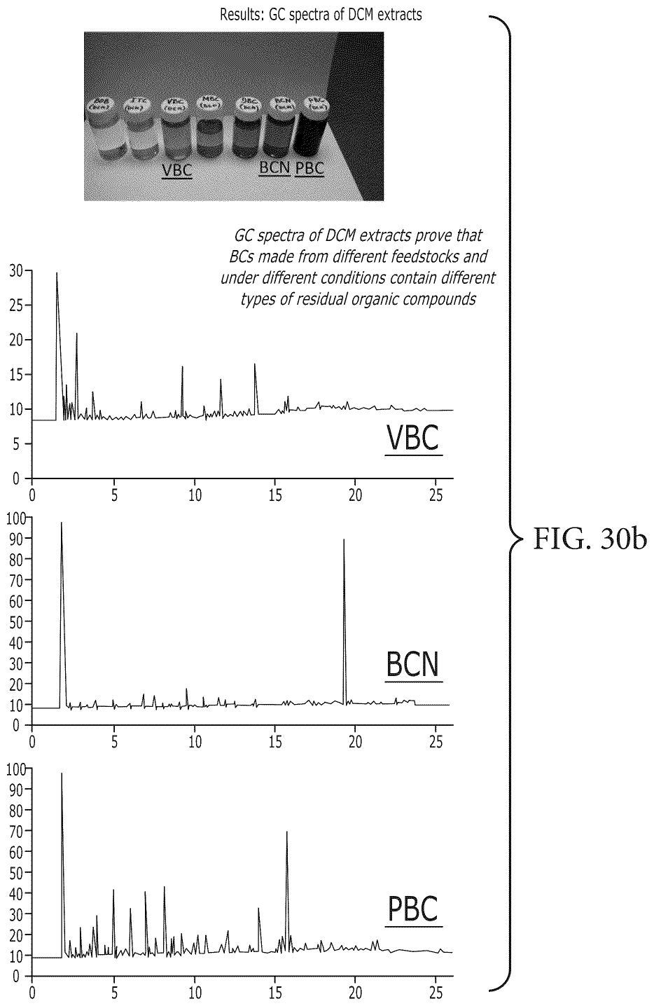

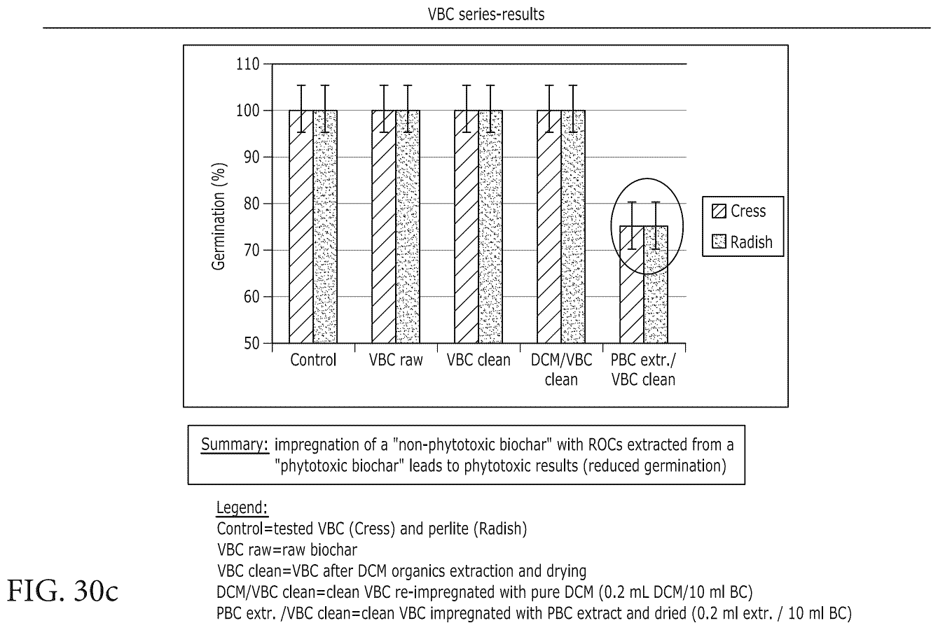

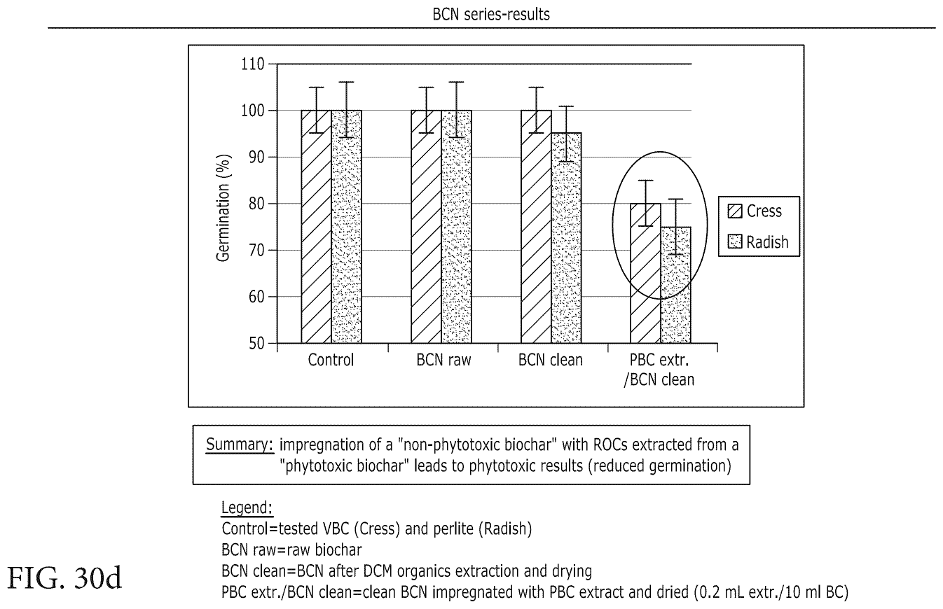

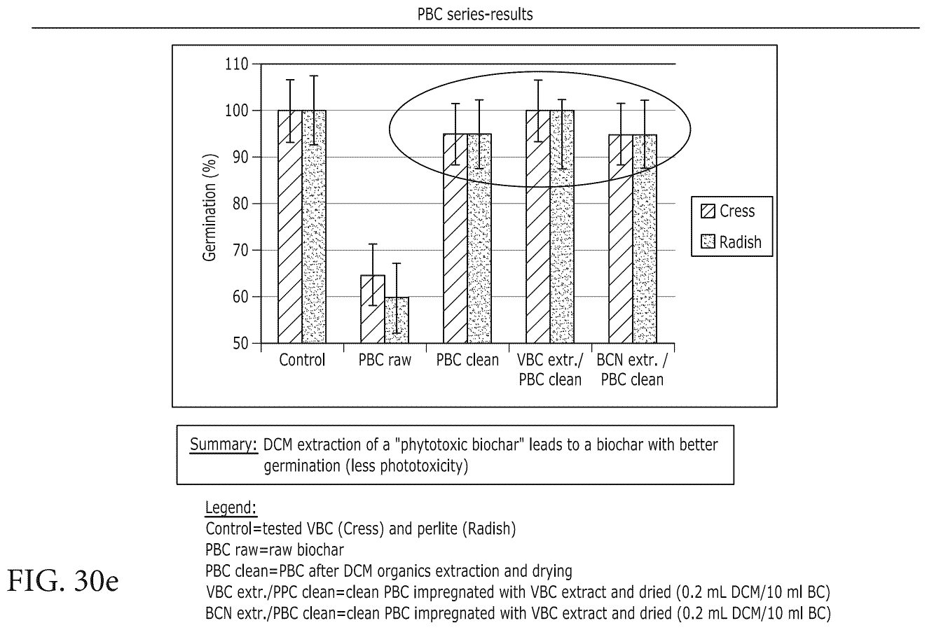

As shown in the flow chart 6700 of FIG. 29, raw or treated biochar 6702 can also be combined, reinfused, or treated in the treatment tank 6308 with extracts from other biochars 6704 or other liquids such as a surfactant 6706, thus in some cases imparting some of the properties of the other biochar to the inoculated material. As shown by example in FIGS. 30a-e, a phytotoxic biochar can become harmless and a harmless biochar can become phytotoxic when the residual organic compounds are extracted from each of the biochars and then reinfused into the other biochar. In other words, a biochar known to be phytotoxic can have the phytotoxic materials extracted. When this extract is reinfused into the pores of a second (previously non-phytotoxic) biochar, the second biochar can be proven to be phytotoxic, while the first biochar has been rendered non-phytotoxic. It should be noted that when the reinfusion takes place that it can occur with one or more extracts, either directly extracted, or treated/upgraded/amended with intermediate processing steps, in solid, liquid, gaseous, or supercritical forms. The reinfusion can be performed using any of the treatment processes described earlier in this application, to include simple soaking, but preferably a method such as vacuum, surfactant, ultrasound, or other that allows for greater, deeper, more rapid penetration of the extract into the pores of the newly targeted biochar. This example is an extreme one as one of the biochar extracts is clearly harmful, but demonstrates that the residual organic and inorganic compounds are different between biochars and can have varying impacts. Thus, using this method, compound, hybrid biochars can be created that share some of the properties of multiple raw biochars. Or, more importantly, previously unattainable forms of biochar can be developed by extracting materials from multiple other biochars, upgrading the extracts, and then reinfusing them at step 6708. After infusion, the upgraded biochar can be further treated, upgraded, modified, or processed in accordance with the methods outlined above, which address treating or processing raw or treated biochar.

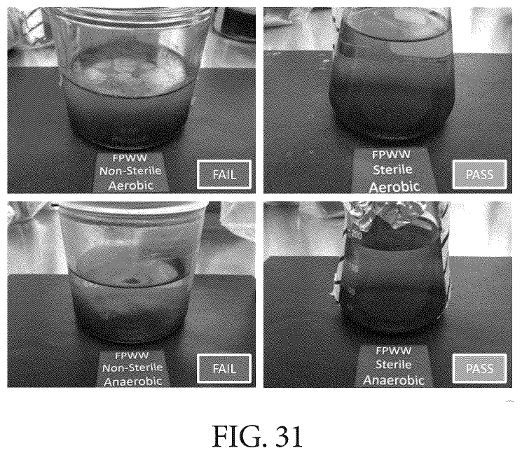

Some of the properties that cause a biochar extract to be a beneficial and a commercially viable product can also lead to product shelf-life concerns. For example, if the beneficial compounds in the extract are a nutrient for plants or microbes, and especially if the compounds are suspended in an aqueous solution, then the extract may foster microbial growth after production but prior to use. Thus, an additional sterilization step may be needed prior to, during, or post extraction and/or the final extract may need to be properly packaged and stored to ensure the extract product maintains a suitably long shelf-life. FIG. 31 shows the visual results of a lab test done to see the difference in microbial growth of a biochar extract during storage when sterilized at 121° C. and 21 psi for 45 minutes or not and when the extract was stored aerobically or anaerobically. The samples were stored for 12 days at 30° C. to induce quicker growth. The samples were then visually rated a pass or fail based on turbidity, surface growth, and discoloration. As seen in the figures, the sterilization step would be vital on this extract for a commercial product. The sterilization step may be in combination with other steps, for example during treatment, inoculation, purification, or concentration if the extract stream reaches sterilization conditions based on temperature and pressure. Sterilization could also be done using Ultra-violet light, radiation, or chemical methods.

To demonstrate other examples of extraction methods and their impact on resulting biochar extracts, two different lab methods were tested with different extraction media (solvents) to see impact on the biochar extracts created. The first method was a simple soak and filter method. The biochar was placed in a flask with a liquid solvent and allowed to stand for a set amount of time and then the material in the flask was filtered to remove the solid biochars leaving a liquid extract. The second method was using a Soxhlet extractor, which consists of a boiler and a reflux that recirculates distilled solvent through a solid material to continuously extract compounds from the solid material for collection. This method is particularly useful when desired compounds have limited solubility in the solvent.

With both methods, the extract could be considered final for testing or additional steps could be made to separate the solvent from the extracted compounds, typically through an evaporator, and then to dissolve or suspend the extracted compounds back into a set volume of a different solvent to create a final extract for testing. This final solution could be made with the same volume of solvent as the original solvent or a different amount of solvent to increase or decrease the resulting extract's concentrations.

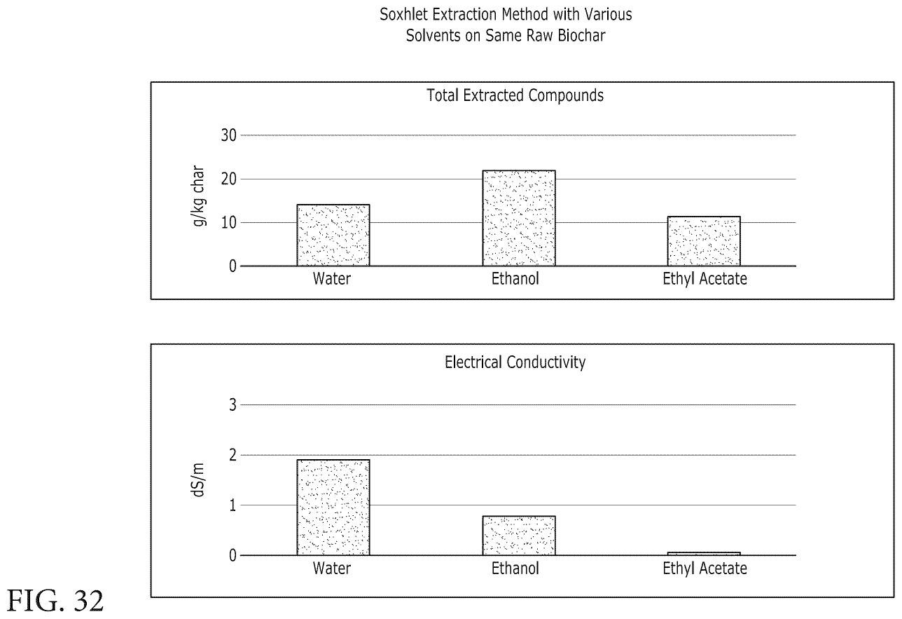

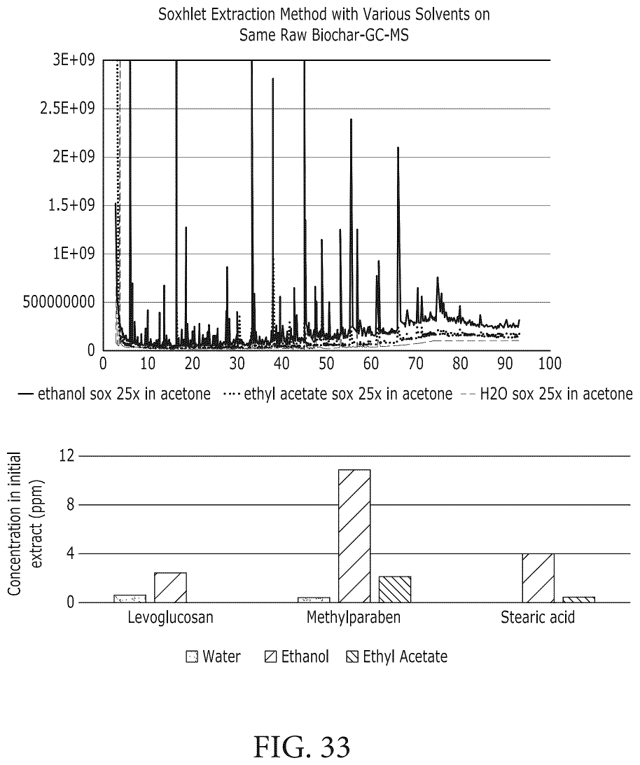

FIG. 32 and FIG. 33 show analysis results of Soxhlet extracts from the same biochar using three different solvents: water, ethanol, and ethyl acetate. The overall total amount of extracted compounds was highest with ethanol, followed by water and then ethyl acetate. Not surprisingly, the water, alcohol, and ethyl acetate solvent also had different extraction efficiencies and selectivity for different types of compounds. Based on the electrical conductivity of the three extracts, the water extracted the most minerals, ethanol extracted some, and ethyl acetate extracted almost none. GC-MS spectra of the three extracts show differing compounds and quantities for the three different solvents. As way of example, three representative compounds identified and quantified by the GC-MS are depicted in FIG. 33 to show how the extraction efficiencies varied by solvent. Levoglucosan, an anhydrosugars, had the highest concentration in the ethanol extract, followed by water, and was not identified in the ethyl acetate extract. Methylparaben, a phenolic, also had its highest concentration in the ethanol extract, but the ethyl acetate extract had the second highest concentration, and the water had the lowest concentration. The highest concentration of stearic acid, a fatty acid, was also seen in the ethanol extract, but a small amount was seen in the ethyl acetate extract, and it was not detected in the water extract.

Because different biochars have different types and amounts of residual compounds and because different extracting methods and media will have different extraction efficiencies for each residual compound, biochars and extraction systems can be designed for the desired compound or set of compounds. In many cases, additional extraction or purification steps may be warranted. For example, in some cases it could be desirable to extract as many compounds as possible from the biochar to leave a relatively clean biochar, devoid of most residual compounds, and perform an additional separation step to selectively choose a subset of compounds from the first extract. In other cases, it could be more desirable to use a more selective extraction method and solvent, so much of the residual compounds remain on the biochar. Or in other cases it may be desirable to use a more selective extraction method and solvent as a first extraction method, and then do a secondary extraction step on the remaining biochar either with a different selective extraction method and media or with a broad efficient extraction method and media.

### F. Presence of Target Compounds from Biochar

Various tests and research have proven that target compounds are not only created through pyrolysis but the concentration of these compounds can be controlled or altered by biochar production conditions, biochar treatment post treatment and through extraction.

### 1. Examples of Altering Content of Signaling Compounds

Plant hormones, including auxins, cytokinins, and gibberellic acid, plant growth regulators (PGRs), and soluble signaling compounds such as karrikins may be extracted from certain biochars, especially those subjected to particle temperatures below 500° C. and short residence times. The presence and concentration of these hormones, PGRs, or soluble signaling compounds in the extract can be determined using gas chromatography-mass spectrometry (GC-MS) or Liquid chromatography-mass spectrometry (LC-MS). Material feedstock selection and thermal processing will control the distribution of soluble signaling compounds available within a given biochar. As an example, Flematti et al., Identification of Alkyl Substituted 2H-Furo[2,3-c]pyran-2-ones as Germination Stimulants Present in Smoke, 2009, Journal of Agricultural and Food Chemistry, presented a scan of KAR₁ through GC-MS which can be used as a benchmark or control to determine the presence of the KAR₁ in the tested biochar extracts. As discussed previously, biochar extracts can be created by using a solvent, such as water, acetone, acetonitrile, dichloromethane, ethanol, ethyl acetate, or hydrochloric acid, to extract compounds from the biochar.

Given this research, it has been proven that the amount of soluble signaling compounds can be maximized by biomass selection and pyrolysis processes and parameters. Recent research has identified the presence of karrikins in biochar and has quantified karrikinolide in several systematically prepared biochars and associated this amount with species specific increases in seed germination and plant size resulting from the use of biochar in the growth media. See Kochanek et al., Karrikin Identified in Biochars Indicate Post-Fire Chemical Cues Can Influence Community Diversity and Plant Development, Aug. 18, 2016, PLOS Tenth Anniversary Journal (https://doi.org/10.1371/journal.pone.0161234). Until now, no data has been collected demonstrating levels over 1 ng/g of KAR₁ in biochar. It has been recently determined and discovered that through the selection of biomass, in combination with varying pyrolysis processes and parameters, higher levels of this soluble signaling compounds can be achieved in biochar than previously identified, which can be maintained in the biochar or extracted from the biochar for use in the promotion of seed germination and early plant development.

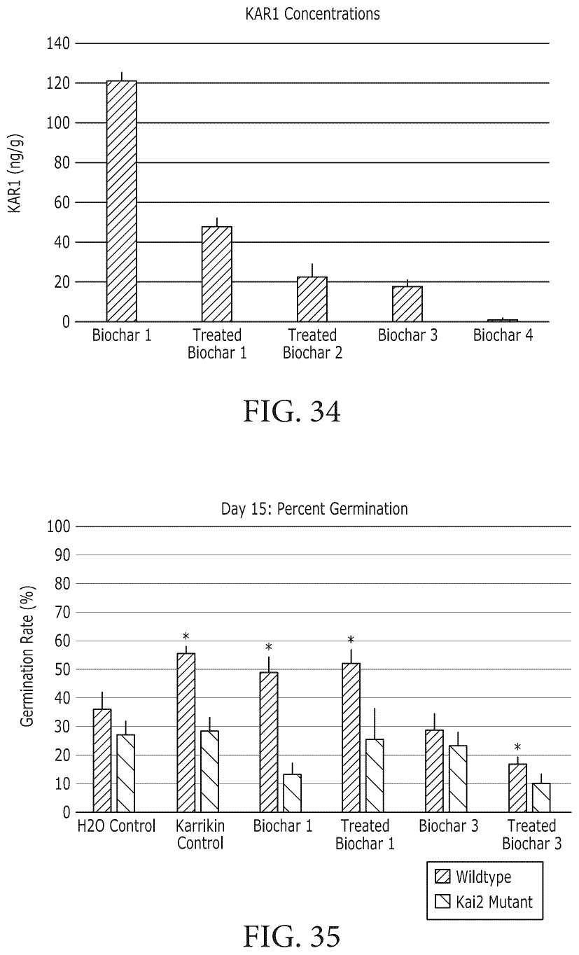

For example, FIG. 34 is a chart quantifying the amount of KAR₁ concentrations in various sources of biochar. Biochar 1, which is a raw biochar, has the highest concentrations of KAR₁ at 121 ng/g of biochar. Treated Biochar 1 is from the same exact biochar source as Biochar 1, but has undergone pressure/vacuum treatment, as set forth above, and showed the second highest level of KAR₁ at 47 ng/g of biochar. Thus, the pressure/vacuum treatment processing described above removed about 61% of KAR₁ from the biochar. However, the concentration levels of KAR₁ on both Biochar 1 and Treated Biochar 1 are orders of magnitude greater than that of published data on biochar KAR₁ levels. See Kochanek et al., Karrikin Identified in Biochars Indicate Post-Fire Chemical Cues Can Influence Community Diversity and Plant Development, Aug. 18, 2016, PLOS Tenth Anniversary Journal (https://doi.org/10.1371/journal.pone.0161234). Treated Biochar 2, at 22 ng/g of biochar, showed about half the amount of KAR₁ than Treated Biochar 1, even though they are from the same type of biomass and went through the same pressure/vacuum treatment processing. Thus, the difference most likely lies in the pyrolysis conditions. Biochar 3 and Biochar 4 are both raw biochars derived from the same type of biomass source, which is a different type of biomass than that of Biochars 1 and 2. Their levels of KAR₁ are significantly lower than that of raw Biochar 1, pointing to feedstock impact on karrikin levels. However, Biochar 3's KAR₁ level of 17 ng/g of biochar is still significantly more than that of the published data, whereas Biochar 4's KAR₁ level of 0.5 ng/g, falls in about the middle of published data, again pointing to the impact of pyrolysis conditions on resulting biochar karrikin levels. Accordingly, current tests show that not only do the pyrolysis methods, processes and parameters impact the concentration of karrikins in biochar, but also that the source material/biomass also plays a significant role in the availability of the karrikins to the biochar. Further, post treatment processes, such as subjecting the biochar to an excess of treating liquid under a vacuum can also remove or extract the karrikins, or other soluble signaling compounds from the biochar. Whereas an impregnation post treatment process, or a surface coating, such as with a surfactant, maintain the highest levels of karrikins in the biochar.

FIG. 35 is a chart that shows seed germination rates of Arabidopsis thaliana seeds after 15 days in different media. Two types of Arabidopsis seeds were used, a wild variety and a KAI2 mutant variety. Karrikin molecules are known to interact with KAI2 receptor proteins in the Karrikin pathway to impact germination and early stage plant growth. The KAI2 mutant seeds had T-DNA insertion mutations in the KAI2 gene to block the karrikin mediated signal transduction pathway. In other words, the KAI2 mutants' germination and early growth cannot be impacted by karrikins whereas the wild variety still has the signaling pathway available and thus growth and early germination can be impacted by karrikins. As expected, the synthetic karrikin positive control increased wildtype seed germination by 54% (p<0.01) over the water control but did not impact germination in the KAI2 mutant seeds. Biochar 1 and Treated Biochar 1 showed similar results to the karrikin control, increasing wildtype seed germination by 35% and 43% over water controls (p<0.05), but not increasing KAI2 mutant seed germination rate. There was no significant difference in seed germination rates between wildtype and kai2 seeds with Biochar 3 or Treated Biochar 3, which are derived from a different biomass type than Biochar 1 and Treated Biochar 1. In summary, proper concentrations of karrikins on Biochar 1 and Treated Biochar 1 increase seed germination rates in seeds where the karrikin-mediated signal transduction pathway is present.

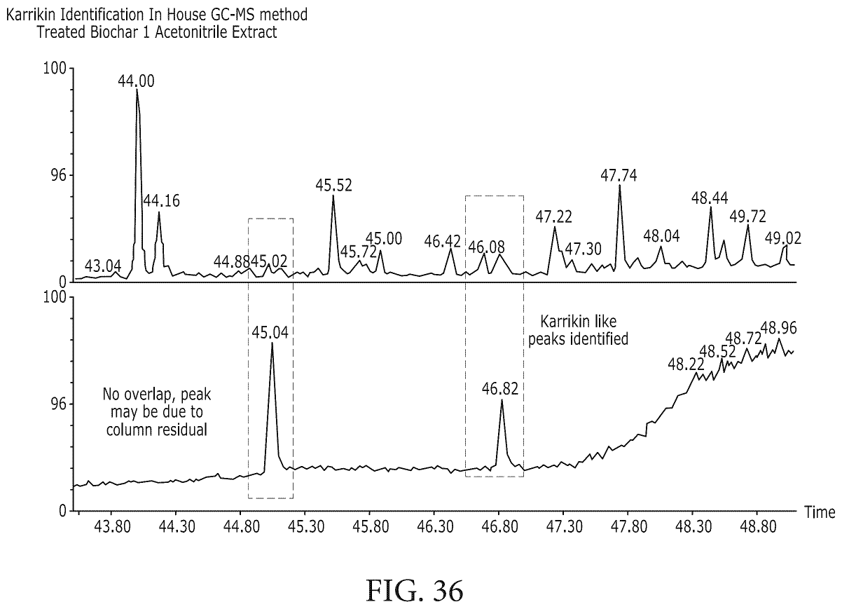

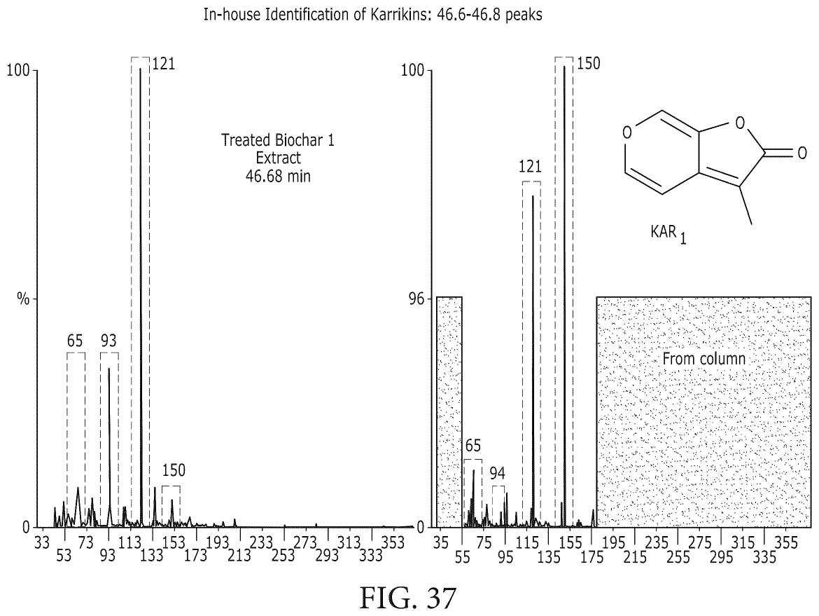

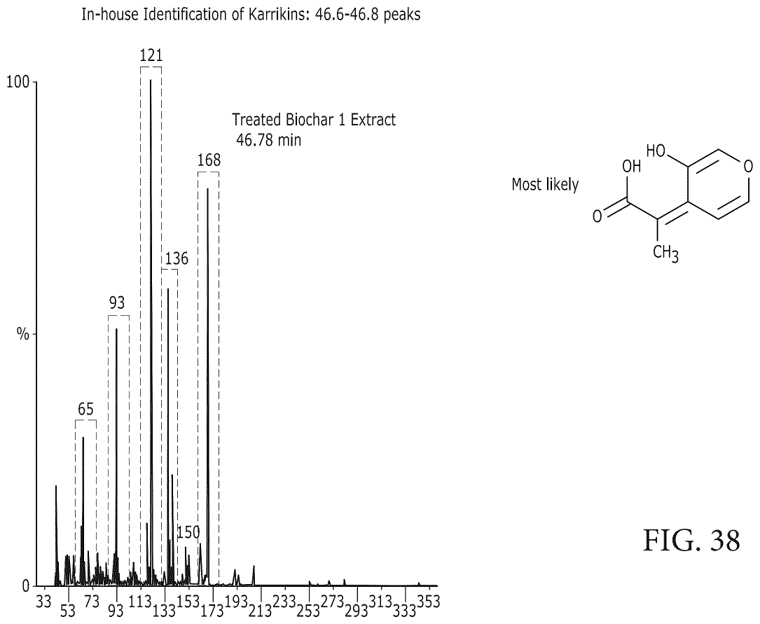

FIG. 36 shows two GC-MS spectra in the region of interest for identifying the presence of karrikins. The top spectrum is that obtained from an acetonitrile biochar extract of Treated Biochar 1, which, as previously discussed, was shown to have a large amount of KAR₁ but had been reduced by post-pyrolysis treatment processes. The bottom spectrum is a positive control reference of a 4 ppm solution of KAR₁ in water. In this figure, it is seen that karrikin-like peaks are identified in the extract of the treated biochar. FIG. 37 compares the peaks of the KAR₁ reference and the Treated Biochar 1 at 46.68 min and FIG. 38 illustrates the MS peaks at 46.78 min. Peaks in both FIG. 37 and FIG. 38 are consistent with karrikins or karrikin derivatives.

Additional testing has shown that it is possible to alter the amount of KAR₁ production via pyrolysis by varying feedstock, temperature and hold time at the higher heating rate. To demonstrate this, batch pyrolysis was performed on 2 gallons of biomass feedstock using a tube furnace reactor with a nitrogen sweep gas set to ensure a maximum gas residence time of <5 seconds within the heated region of the reactor. Oils were condensed using a helical coil condenser set to 10° C. Biochar was cooled in a water jacketed tube under nitrogen to avoid oxidation of surface compounds or modification by quench. Collected oils were mixed with methanol at a 50/50 volume ratio and stored at 4° C. until analysis to minimize reaction.

Residual chemistry was separated from the resulting biochar using a Soxhlet apparatus with acetone. Acetone was refluxed a minimum of 5 times over 2 hours to ensure near complete removal of soluble compounds. The refluxed acetone, containing the biochar extracts, is then concentrated by rotary evaporation to enhance detection of extracted compounds.

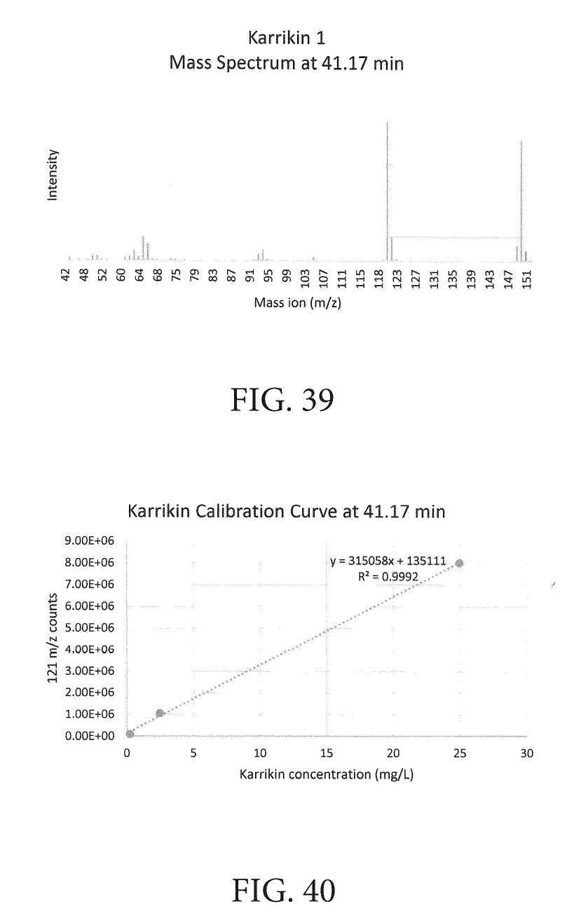

To determine the amount of karrikin in the extracted compounds, analysis by gas chromatography mass spectroscopy was performed on both a KAR₁ reference material and the concentrated extracts. FIG. 39 is a mass spectrum reading of a KAR₁ reference material tested to confirm retention time and signal. In particular, as seen in FIG. 40, KAR₁ reference material was tested using GC-MS, which confirmed a retention time of 41.17 minutes and mass ions (m/z: % of maximum ion. 121: 100%, 150: 86%, 65: 17%, 94: 8% using an in-house method. Using this data, a karrikin calibration curve was constructed from 0.25-25 ppm using m/121 peak intensity at 41.17 min., this karrikin calibration curve is illustrated in FIG. 40.

To show variations in the production of KAR₁ through varying feedstock, temperature, and hold time at the higher heating rate, multiple tests were performed using the same analytical method as above but at various conditions.

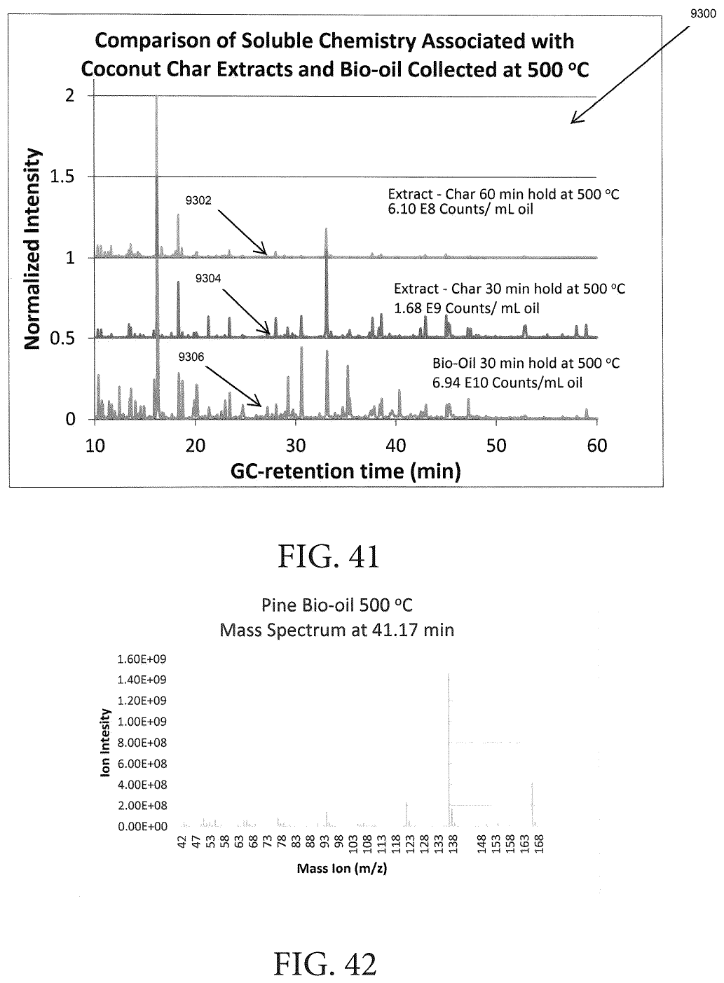

FIG. 41 depicts chart 9300 which shows the variation in chemistry between the bio-oil and residual extractive chemistry on biochar for runs conducted using coconut feedstock pyrolyzed at 500° C. The chart compares normalized peak intensity against GC-retention time (min). Reading 9302 is a GC-MS signal for biochar extract where the coconut shells were pyrolyzed at 500° C. for an hour hold time. Reading 9304 is a GC-MS signal for biochar extract where the coconut shells were pyrolyzed at 500° C. for a 30 minute hold time. Reading 9306 is a GC-MS signal for bio-oil where the coconut shells were pyrolyzed at 500° C. for a 30 minute hold time.

From this comparison, it can be seen that both the residual soluble chemistry associated with the biochar and the bio-oil represent rich sources of diverse organic compounds. The residuals on the biochar however, show reduced diversity after a 30 minute hold time at 500° C. compared to the bio-oil collected from the same run. Hold times of one hour, further reduced the diversity and concentration of soluble compounds on the biochar compared to the biochar collected after a 30 minute time frame. The variances observed here support that adjusting the time and temperature of pyrolysis will affect both the quantity and chemistry of biochar extracts. While much of the chemistry associated with the biochar extract was also found in the bio-oil, the bio-oil presents a substantially more complex matrix, requiring additional effort to refine.

As demonstrated above, and in connection with FIG. 41, KAR₁ was identified in bio-oil produced from the pyrolysis of coconut shells. In contrast, when the same pyrolysis and extraction methods set forth above were performed on pine, substantive Karrikin signals were not clearly detected in pyrolyzed pine samples. FIG. 42 is a mass spectrum reading of pine-based bio-oil produced at 500° C. with a 30 minute hold time. The mass spectrum shows the signal obtained at 41.17 minutes, previously identified as the retention time of KAR1. For the pine bio-oil sample the only compound clearly identified was 2-methoxy-4-propylphenol.

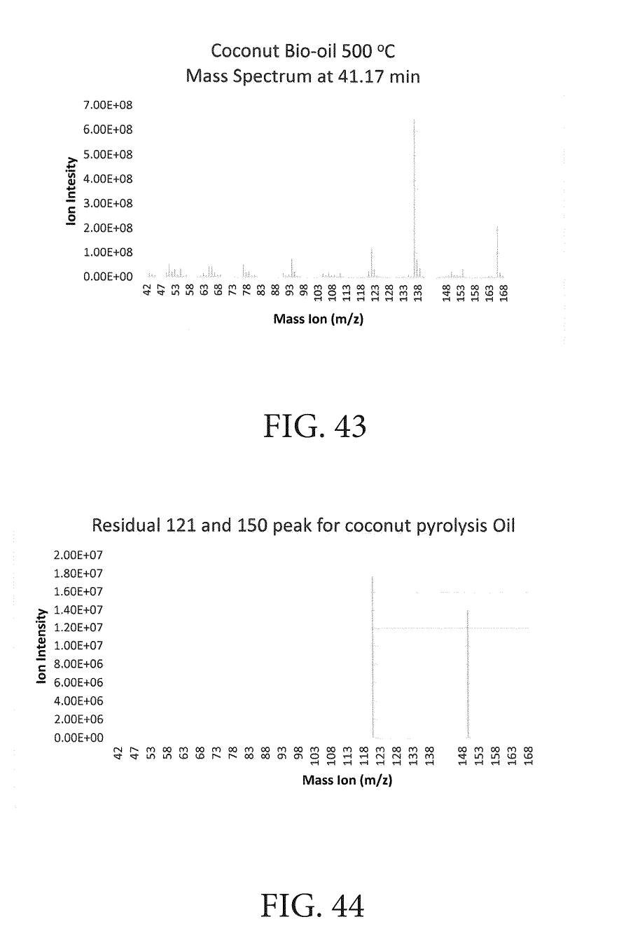

Similarly, FIG. 43 is a mass spectrum reading of coconut based bio-oil produced at 500° C. at a hold time of 30 minutes. The signal at 41.17 minutes is suspected to be composed primarily of 2-methoxy-4-propylphenol and 4-hydroxy-3methoxy benzyl. However neither compound suitably explains the residual intensity at 121 m/z and 150 m/z not accounted for by other compounds.

To account for these compounds, interference from 4 hydroxy-3methoxy benzyl alcohol was removed by normalization of the m/z 154 ion and phenol 2 methoxy-4-propylphenol by normalization and removal of the 137 mass ion, allowing the residual mass 121 and 150 ions to be determined. These mass ions, while the strongest signals for KAR₁, are only very minor components of the signal for the other suspect compounds. FIG. 44 is a chart showing the residual 121 and 150 peaks for coconut pyrolysis oil of analyzed in FIG. 43. Other mass ions have been masked to highlight the effect on ions 121 and 150. The residual mass 121/150 ratio was 1.27 while for a reference Karrikin 1 standard the ratio was 1.16. These values are in good agreement and are consistent with the identification of karrikin 1 at 41.17 minutes using the peak intensity observed at m/z=121. Thus, this reading strongly implies the presence of KAR₁ in bio-oil produced from the pyrolysis of coconut shells.

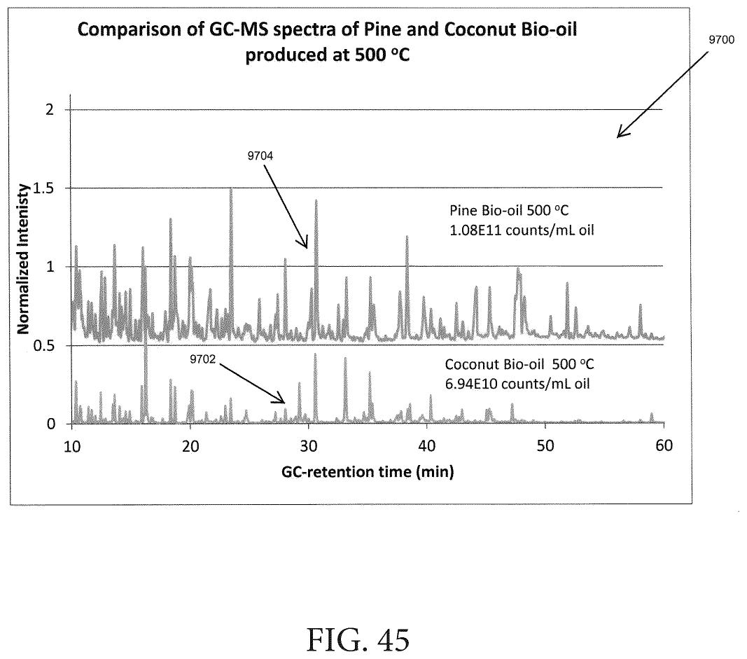

Further comparison testing was performed using pine and coconut as the biomass feedstock. Chart 9700 in FIG. 45 shows the comparative chemistry of pine and coconut bio-oil. The chart compares measured normalized intensity over GC-retention time (min) of bio-oils produced using pine and coconut shells at 500° C. for a hold time of 30 minutes. Reading 9702 is a GC-MS signal for bio-oil produced from coconut shells. Reading 9704 is a GC-MS signal for bio-oil produced from pine. Bio-oil collected from pine shows more complex spectra than the bio-oil obtained from coconut shells. Many of the primary peaks appear to originate with the cellulose fraction of the biochar and include increased production of compounds such as levoglucosan.

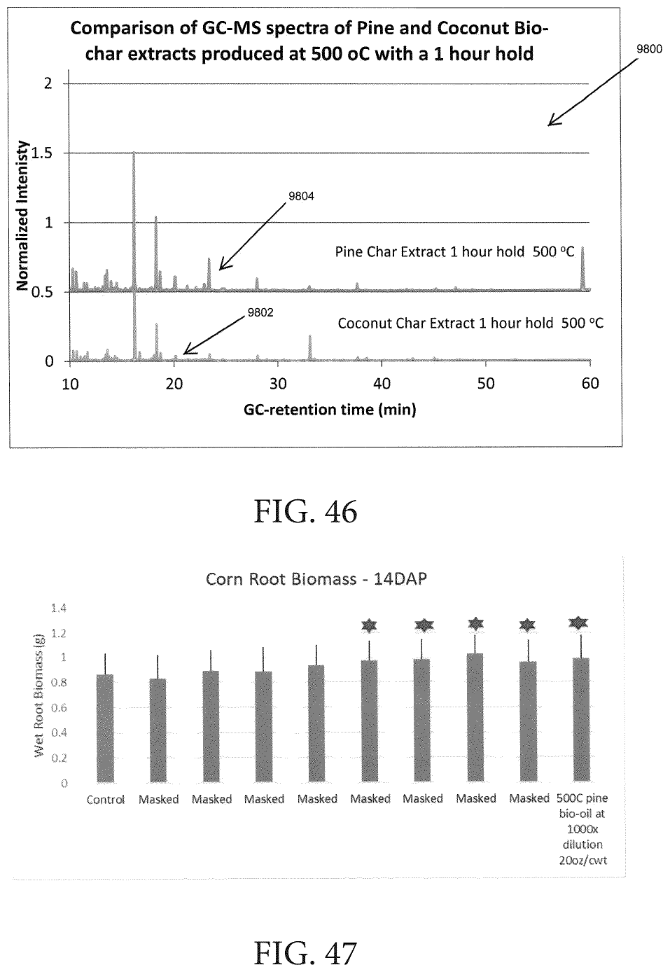

FIG. 46 is another a chart 9800 showing the comparative chemistry of pine and coconut bio-oil. Chart 9800 compares measured normalized intensity over GC-retention time (min) of bio-oils produced using pine and coconut shells at 500° C. for a hold time of one hour. Reading 9802 is a GC-MS signal for bio-oil produced from coconut shells. Reading 9804 is a GC-MS signal for bio-oil produced from pine. Variance between the biochar extracts obtained from material produced at 500° C. with a 1 hour hold time show substantially lower variability than observed for the bio-oil obtained after 30 minutes (shown in FIG. 45). Most peaks are observed in both samples, however distribution and concentration of compounds does vary.

In the substantial chemistry observed within both bio-oils, and extracts, potential exists for multiple additional beneficial or detrimental compounds. While karrikin was not clearly observed in the pine bio-oil, germination and early growth results obtained for a diluted pine bio-oil show statistically significant increases in root biomass 14 days after planting. FIG. 47 is a growth chart for corn root biomass illustrating such statistically significant increases in root biomass 14 days after planting.

Further tests were performed using the pyrolysis and extract methods first set forth above using coconut shell as feedstock and a 30-minute hold time at peak pyrolysis temperature, but each test was conducted with varied maximum temperatures. The table below shows the resulting calculated karrikin concentration on the coconut chars produced at the varying pyrolysis temperatures (all 30 minute hold time at the specified temperature except where noted).

| | | | | | | concentration |
|---|---|---|---|---|---|---|
| Reactor | Char | Weight in | Solvent | 121 signal at | concentration | on char |
| temp ° C. | yield | (g) | (mL) | 41.17 min | (mg/L) | (mg/kg) |
| 450 | 80% | 36.76 | 4.45 | 6.56E+06 | 20.4 | 2.47 |
| 500 | 59% | 45 | 7.29 | 3.31E+06 | 10.1 | 1.63 |
| 550 | 51% | 44.47 | 6.62 | 1.64E+06 | 4.8 | 0.71 |
| 600 | 32% | 45.42 | 6.52 | 1.73E+05 | 0.1 | 0.02 |
| 500 1 hr | 35% | 45 | 6.43 | 2.12E+05 | 0.2 | 0.03 |

The table below shows the resulting calculated karrikin concentration in the coconut pyrolysis oils produced at varying pyrolysis temperatures (all 30 minutes hold time at the specified temperature except where noted)

| | | | | Estimated | Estimated |
|---|---|---|---|---|---|
| | | | 121 | concen- | yield from |
| Reactor | | Dilution | signal at | tration | biomass |
| temp ° C. | Oil Yield | factor | 41.17 min | (mg/L) in oil | (mg/kg) |
| 450 | 12% | 2 | 9.81E+06 | 31 | 7 |
| 500 | 29% | 2 | 2.72E+07 | 86 | 49 |
| 550 | 33% | 2 | 3.09E+07 | 98 | 65 |
| 600 | 45% | 2 | 2.42E+07 | 76 | 69 |
| 500 1 hr | 45% | 2 | 2.26E+07 | 71 | 64 |

From the above pyrolysis tests and analysis, it is demonstrated that KAR₁ production can be varied via pyrolysis conditions, dependent on pyrolysis feedstock, temperature and hold time at the higher heating rate. Further, KAR₁ was identified in the pyrolysis oils produced from coconut shell, and was identified as a residual organic in biochars produced from coconut shells. KAR₁ 1 signals were detected in both the bio-oil and residual solids of coconut that was minimally processed (<500° C. for 30 minutes), the residual solid fraction showed browning, but minimal indication of charring, indicating the bulk biomass temperature had not reached the reactor temperature and had instead only reached torrefaction conditions. KAR₁ was lost on coconut chars that were held at higher pyrolysis temperatures for an extended period of time-indicating reaction or volatilization from the surface. Thus, KAR₁ signals decreased in biochar extracts as pyrolysis temperature increased. Lastly, KAR₁ recovery in the bio-oil, as a function of initial biomass, were not strongly impacted by pyrolysis temperatures above 500° C. This, in combination with the detection of potential KAR₁ signals in material processed at 450° C., indicates that KAR₁ is primarily formed formation at relatively low temperatures and volatilized as the biomass/biochar temperature increases.

In summary, as demonstrated above, KAR₁ can be produced through the pyrolysis of biomass at varying temperatures and hold times, by collecting the resulting bio-oil and biochar extracts, using the methods first described above. Further, as demonstrated above, testing shows that the amount of KAR₁ or signal solubilizing compounds produced can be anticipated and controlled to produce a desired result, by varying temperature and hold times of the biomass. Certain biomass will produce distinct distributions of soluble signaling compounds, such as KAR₁, and for each biomass, the production of these compounds, such as KAR₁, will further vary when pyrolysis is performed at different temperatures, at varying hold times.

While the above method illustrates how KAR₁ can be produced through the pyrolysis of biomass at varying temperatures and hold times, in this same manner, other inorganic compounds, organic compounds, or soluble signaling compounds, including but not limited to, butenolides, anhydrosugars, carboxylic acids, fatty acids, alkanes, ketones, aldehydes, aromatics, phenolics and complex macromolecular organics similar to humic and fulvic acids can also be produced. Even more specifically, methylparaben, vanillin, furfural, and levoglucosan have been consistently identified in extracts from all sources. Biomass can be selected from sources other than pine and coconut to yield varying results. Biomass selection may include, but is not be limited to, softwoods, hardwoods, straw, corn stover, bagasse, and nut shells. Temperatures can vary for each biomass and desired product of soluble signaling compounds from any temperature ranging from 400 to 600° C., with solid hold times ranging at any particular temperature for any time between 1 minute, 12 hours, 24 hours, 48 hours or 72 hours in industrial continuous and batch kiln designs, but may be up to an additional one, two or even three weeks in traditional earthen kiln designs. Reactions may be carried out with or without a sweep gas and/or vacuum to modify the vapor residence time. Sweep gas may include inert gases such as CO₂ and N₂ and may or may not include recycle of the gases from the pyrolysis system itself. Although these tests have been focused on desirable compounds in relationship to seed germination and early plant growth, the same methods for selecting feedstock and pyrolysis conditions to create specific inorganic or organic compounds can be used for desired compounds for other applications including but not limited to animal feed, pharmaceutical, or chemical feedstocks for other commercial goods. The beneficial compound may improve seed germination, increase plant growth, improve crop yield, promote microbial communities, improve animal health, or act as an active ingredient in pharmaceuticals. In addition, some desirable compounds may cause direct harm to plants, microbes, or animals, but may be desirable for application as insecticides, herbicides, anti-microbials, or anti-fungals. In addition, although the focus of this invention has been to collect the compounds through the biochar extraction method, the invention also covers collection of desirable compounds through resulting bio-oils, pyrolysis vapors, or non-condensable gases obtained through biomass pyrolysis.

### 3. Examples of Humic and Fulvic Acids in Biochar

As stated previously, some well-known biostimulating compounds are humic and fulvic acids. Humic acids in particular are known to improve micronutrient uptake. Aqueous suspensions of an organic solvent extract and alkaline water extract of a biochar were analyzed for fulvic and humic acid content, results of which are presented in the table below on a biochar extracted basis:

mg extractable/100 g char

| Extract analyzed | Fulvic | Humic |
|---|---|---|
| Alkaline Extract | 22.86 | 0.95 |
| Organic Solvent* | 2.62 | 1.67 |
| Organic Solvent + acid* | 3.57 | 0.24 |

*suspended in aqueous solution

An interesting observation is that when the organic solvent extraction was resuspended in an acid modified aqueous solution, the quantity of determined humic acids dropped considerably, in favor of fulvic acids, indicating that many of these compounds are weakly associated and may be measured as smaller, or larger, fractions depending on the pH of the analyzed solution and method used.

### 4. Examples of Effects of Post Treatment Processes on Biochar Extracts

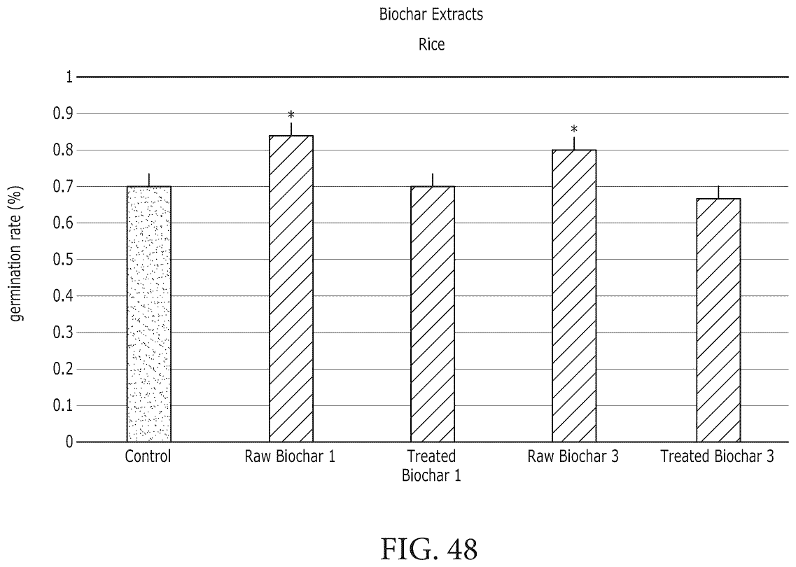

Extracts from raw and treated biochars were tested to determine the impact of the extract on seed germinations rates in rice and corn. FIG. 48 shows the test results of the use of the raw and treated biochar extracts on rice at Day 4. The extracts from Raw Biochar 1 and Raw Biochar 3 are both from different sources of biomass and both increase seed germination rates by 19 and 14 percent at Day 4, respectively, over the control.

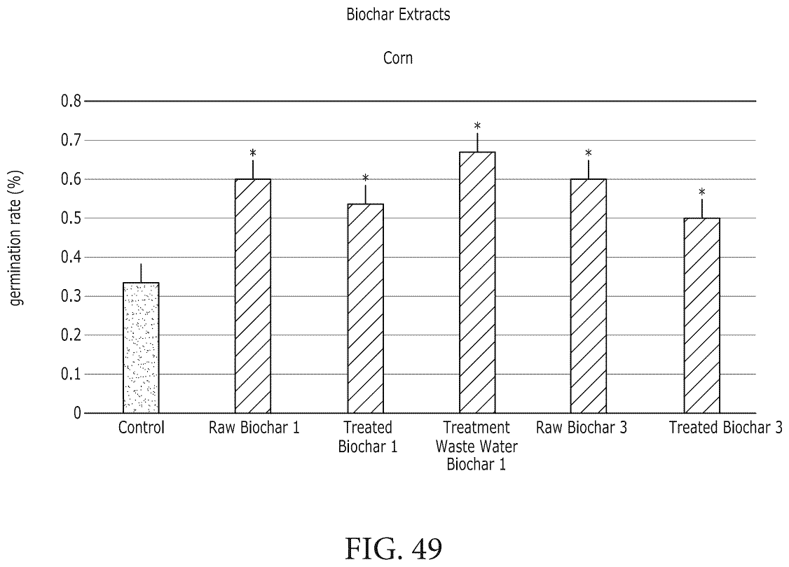

FIG. 49 shows the test results of the use of the raw and treated biochar extracts on corn at Day 3. FIG. 49 also show additional test results using the treating waste water extracted from the vacuum treatment process of Treated Biochar 1. As shown, extracts from the Raw Biochar 1 and Raw Biochar 3, which are both from different sources of biomass, along with the treating waste water from Treated Biochar 1, significantly increase corn seed germination by more than 50% over the control at Day 3. Treated Biochar 1 and Treated Biochar 3 also show a statistical increase in germination rate over the control but to a somewhat lesser extent than their raw counterparts. While FIG. 49 illustrates the test using the extracts on corn, it is worth noting that testing has also demonstrated that Treated Biochar 1 and Treated Biochar 3, prior to any solvent extraction, also increases rice seed germination rates by 14 and 33 percent over the control at Day 2.

The conclusions drawn for the tests shown and described in connection with FIGS. 48 and 49 are that extracts from Raw Biochars 1 and 3 increase rice and corn seed germination more than the extracts from the vacuum Treated Biochars 1 and 3. The wastewater from the Treated Biochar 1, which can be considered a type of extraction, also shows a high increase in corn seed germination at Day 3. This correlates well with results presented previously on KAR₁ levels and the corresponding Arabidopsis Wild and KAI2 Mutant tests.

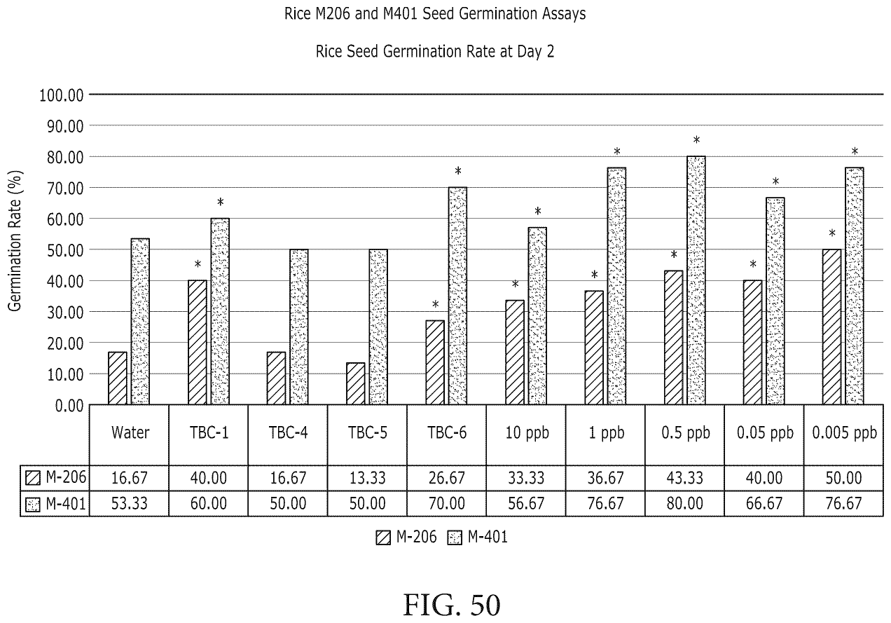

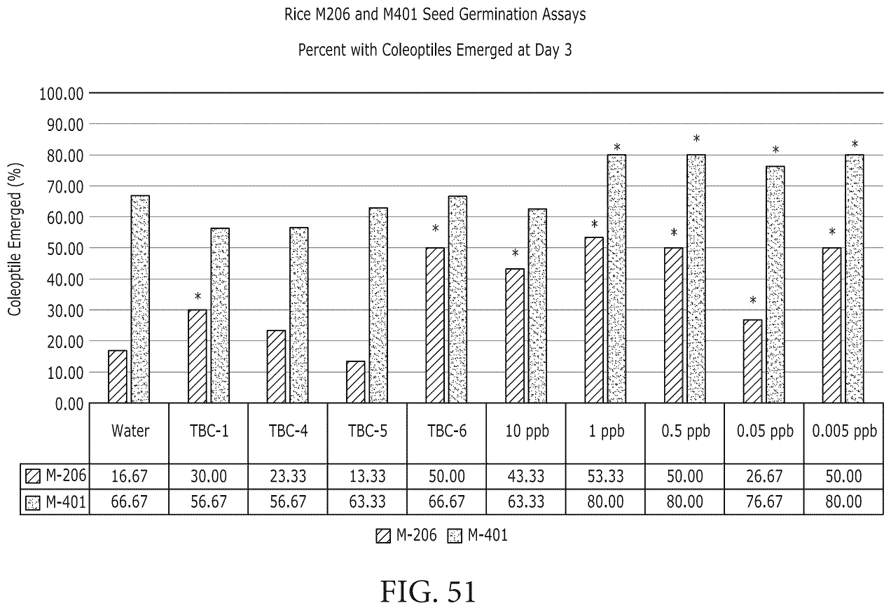

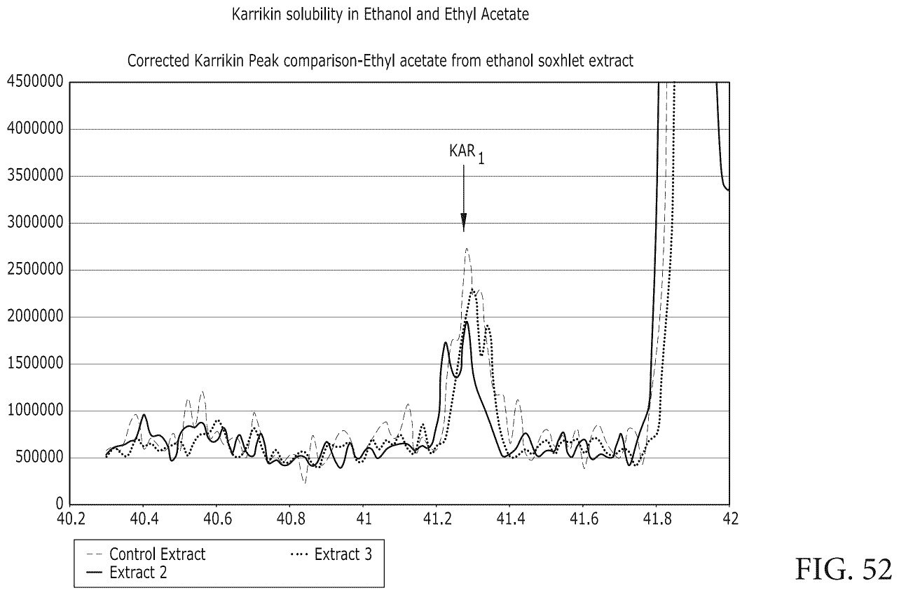

Post-treatment processes in general, as well as the type of post-treatment processes specifically described previously, in conjunction with the type of biochar, based on feedstock and pyrolysis conditions, may also impact the efficacy or the concentration of available karrikins, or other soluble signaling compounds that impact seed germination and early plant development. FIG. 50 depicts the germination rate of two types of rice seeds at Day 2. FIG. 51 illustrates the same seed germination assay of FIG. 50 but measures the percentage with coleoptiles emerged at Day 3.

The media used to germinate the seeds included a water control, treated biochar 1 (TBC-1), treated biochar 4 (TBC-4), treated biochar 5 (TBC-5) and treated biochar 6 (TBC-6), along with reference karrikin (KAR₁) controls at various ppb levels (10, 1, 0.5, 0.05 and 0.005) in water. TBC-1 and TBC-5 are derived from raw Biochar 1. TBC-4 and TBC-6 are derived from raw biochar 4, a different biomass feedstock than TBC-1. TBC-1, 4 and 5 were all vacuum treated, as described more fully above. TBC-6 is an agglomerate that includes raw Biochar 4 that has been treated with surfactant.

Both tests demonstrate that TBC-1 and TBC-6 significantly increase both types of rice seed germination and significantly increase the rate of coleoptile emergence in the M206 seeds. Accordingly, biochars derived from different biomass, if treated differently through post treatment processes, can change the amount of available signaling compounds, including karrikins. As demonstrated, TBC-1 can significantly increase germination rates of M-206, with most similar results to that of the karrikin solution at 0.05 ppb. TBC-6's germination results were most like that of the 10 ppb karrikin solution. When looking at M-206 on day 3 coleoptile emergence, TBC-1 was still closest to the 0.05 ppb and TBC-6 was closest to 0.5 ppb but still also similar to the 10 ppb. As shown in FIG. 32, the concentration of KAR₁ on TBC-1, is approximately 50 ppb, whereas the concentration of KAR₁ on raw Biochar 4 (which was included in TBC-6) is approximately 0.5 ppb. One potential cause for this unexpected difference in performance and karrikin level is that, not only does the post-treatment method impact the absolute amount of karrikins in the biochar, it may also impact the availability of said karrikins to impact seed germination and early growth. Comparing to reference karrikin samples, it appears the amount of KAR₁ available for the rice seed to impact germination and early growth may be similar between TBC-1 & TBC-6, despite TBC-1 having significantly higher levels of KAR₁. Accordingly, a surfactant treatment may help increase the availability of KAR₁ to the seed during treatment.

Another potential cause for the unexpected difference in performance and karrikin level in the test is that the signaling compounds, such as karrikins, are competing with germination-inhibiting compounds. These inhibiting compounds could be phytotoxic compounds or potentially even related butenolides such as 3,4,5-trimethylfuran-2 (5H)-one, which prior art has identified and isolated from plant-derived smoke and found to both reduce germination and reduce the beneficial effects of the signaling compound, 3-methyl-2H-furo[2,3-c]pyran-2-one (Light, et. al in “Butenolides from Plant-Derived Smoke: Natural Plant-Growth Regulators with Antagonistic Actions on Seed Germination” Journal of Natural Products, 2010) (https://pubs.acs.org/doi/abs/10.1021/np900630w). Since inhibitor compounds will also be impacted by how the biochar is made and post-processed, the levels of inhibitor compounds in the various biochars tested may also vary and thus cause some biochars with signaling compounds not to perform as expected.

A third potential cause is that signaling compounds and inhibitor compounds might have concentration or quantity thresholds. For example, at a certain level a signaling compound changes from a positive influence in germination and early growth to a negative influence. By way of a different example the threshold could be similar to an activation level, where no impact is seen until a certain level of compound is reached or where once a certain level is achieved no further impact is seen as the level of compound increases.

### 4. Examples of Chromatographic Isolation of Compounds in Extracts

To better understand extraction of signaling compounds and also the interactions between signaling compounds and inhibitor compounds in extracts further testing was completed. First to better understand how KAR₁ could be extracted and isolated from biochar, Biochar 1, previously shown to have high levels of KAR₁, was used to make three different extracts. The control extract was made using the Soxhlet extractor with Ethanol as the solvent and then concentrated 25× by rotary evaporation. The second extract was made from the control extract by removing the ethanol using a rotary evaporator and then resolubilizing the extracted compounds in ethyl acetate, at a 10× concentration level. It should be noted that when depicting results for this extract they were multiplied by 2.5 to normalize the concentration to that of solutions 1 and 3. The third extract was made from the control extract by removing the ethanol using a rotary evaporator and then resolubilizing in water and then as a final step liquid-liquid extraction was performed with ethyl acetate. The ethyl acetate solution was measured at a 25× concentration. These three extracts were run on CG-MS with mass specific selective ion analysis to identify KAR1. For GC-MS testing, the control extract was also rotary evaporated and resolubilized in acetone at a 25× concentration. The three spectra are depicted in FIG. 52 and show that KAR1 is soluble and extractable with all three extract methods tested. In addition, the KAR₁ levels continued to equate to 75-150 ng/g of biochar.

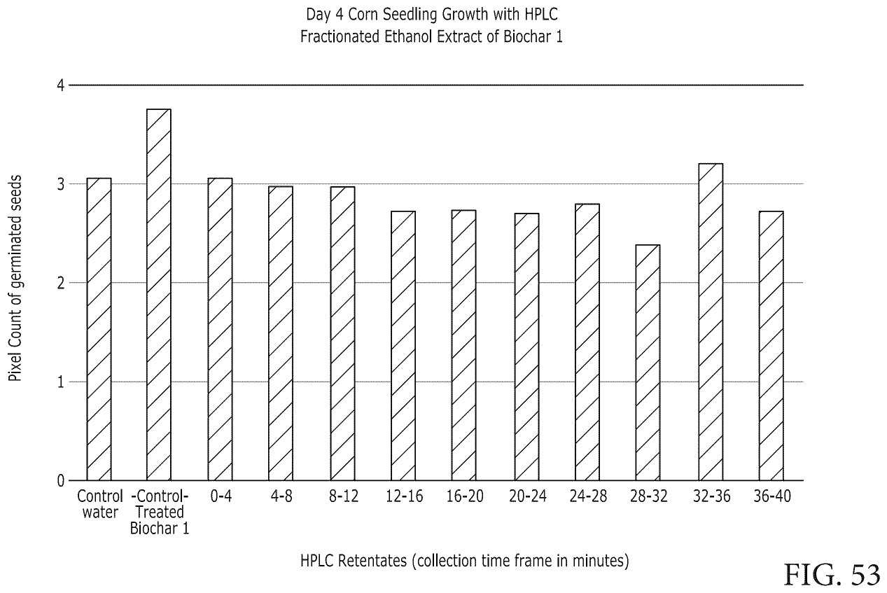

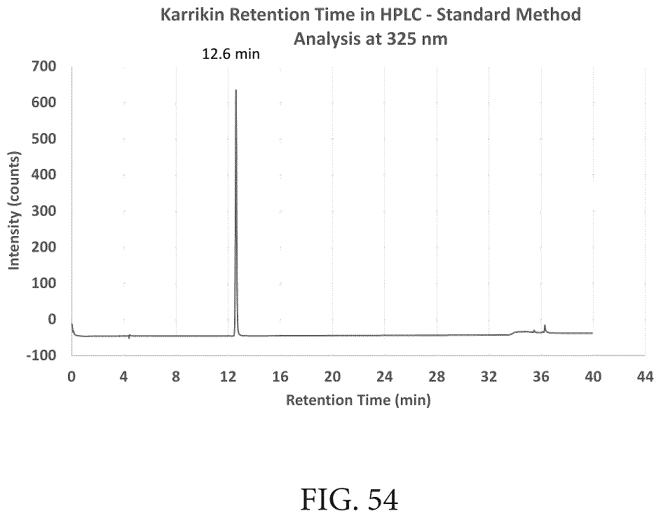

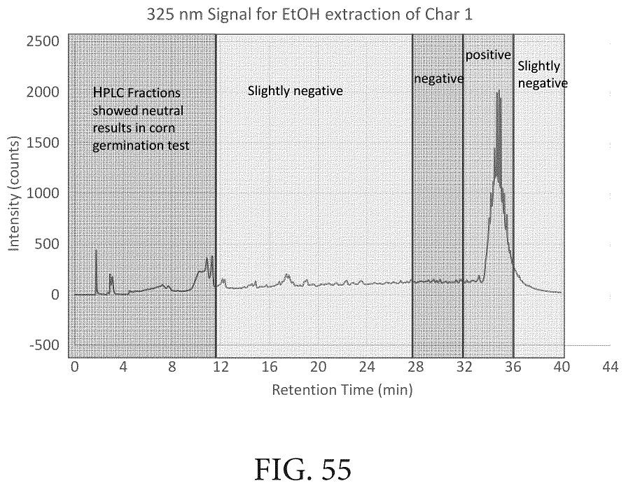

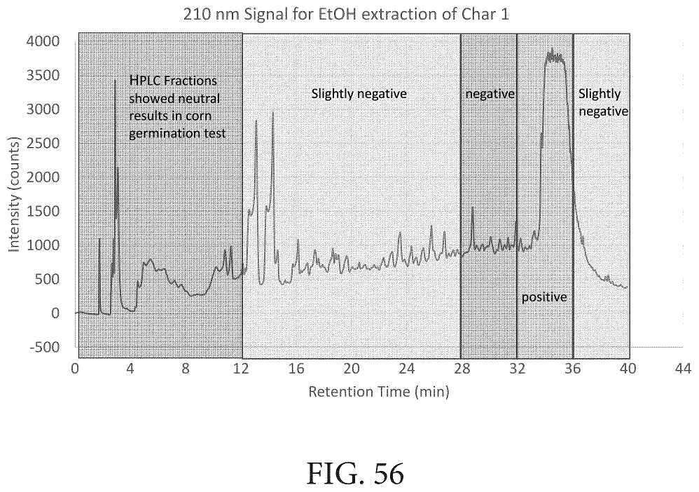

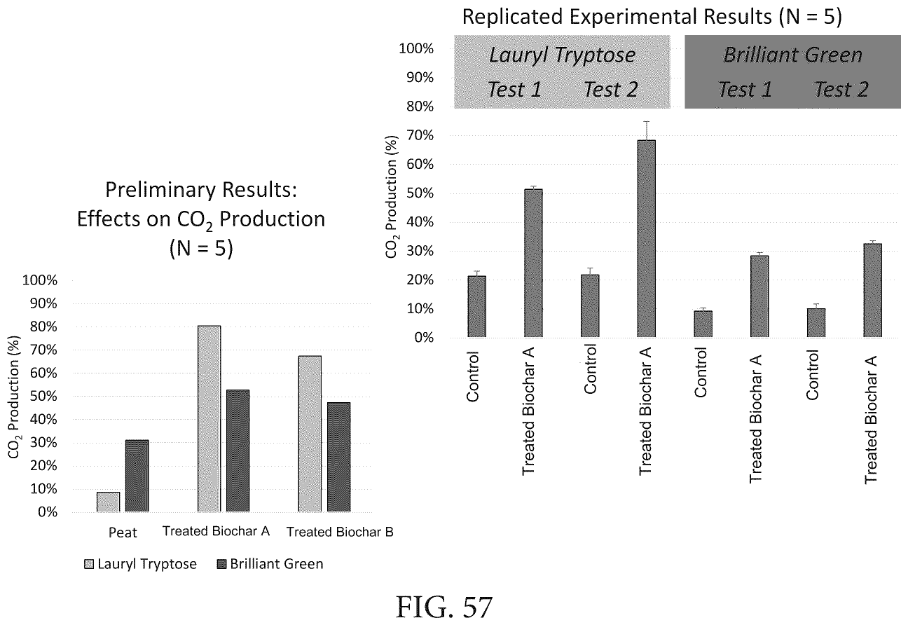

Next, the Soxhlet ethanol extract of Biochar 1 was separated into fractions of compounds using an HPLC. Extracts were evaporated and resuspended in 50% Acetonitrile and water at ˜15× concentration. 100 μL of this solution was injected into the C18 reverse phase column (250 mm, 4.6 mm ID with 5 μm diameter packing). Eluant was flowed at 0.8 mL/min with the composition increasing from 10% ACN in water to 50% over 30 minutes. Between 30 and 31 minutes the concentration of ACN was increased to 100%. Between 31 and 40 minutes pure ACN was used to flush the remaining compounds from the column. Fractions were created by collecting retentates for every 4 minutes between 0 and 40 minutes. These fractioned extracts were then diluted sufficiently to match isolated chemical concentration equivalent to a 100× dilution of the original extract and used in a corn germination test. Images were taken on day four and analyzed for extent of early development based on pixel counts of germinated seeds, as depicted in FIG. 53. Many of the fractionations were neutral or slightly negative. The biggest impacts were for the retentate of the HPLC from 28-32-minute retention time, which was a negative impact, and from 32-36-minute retention time which was a positive impact on the corn seed early development. Looking at a standard reference KAR₁ on the HPLC analysis at 325 nm, shown in FIG. 54, KAR₁ should be in the 12-16 retentate, but unexpectedly a slightly negative impact was seen. Looking at the HPLC analysis at 325 nm for the extract, shown in FIG. 55, there does appear to be a peak for KAR₁ with other small peaks in the retentate. However, if instead the HPLC analysis for the extract is looked at a 210 signal, as shown in FIG. 56, significantly more compound peaks are visible in that same retentate time period of 12-16, which likely indicates that there are both signaling compounds and inhibiting compounds impacting the corn germination results in this specific fraction.

In a separate analysis, an extract of a pine wood derived biochar sample was fractionated using a dry vacuum chromatography method with a water/methanol gradient. The effects of the fraction collected at 30%/70% water/methanol was compared to the fraction collected at 100% methanol and the whole extract on the development of Arabidopsis thaliana on agar plates containing a bromocresol purple dye. Following a two week stratification and incubation period, seedlings of consistent size were selected from each treatment and grown on fresh agar plates. Four days after transfer the 30%/70% water/methanol extract shows similar increases in root length and lateral root development as the whole extract compared to the control while the 100% methanol fraction shows no significant impact. The 30%/70% water/methanol fraction contains a complex mix of moderate molecular weight compounds, but generally smaller in size than the 100% extract.

Overall these tests show that biochars and their extracts can contain a complex mix of compounds, containing both growth-promoting compounds and growth-inhibiting compounds. Butenolides, and specifically karrikins, while important germination promotors, are not the only important organic compound that can be found in a biochar or its extract. Other potential biologically important compounds that have been identified in some biochars and their extracts include but are not limited to other butenolides, anhydrosugars, carboxylic acids, fatty acids, alkanes, ketones, aldehydes, phenylpropanoids, phenylalanines, flavonoids, sterols, terpenes, terpenoids, tannins, coumarins, and phenols. Even more specifically, methylparaben, furfural, levoglucosan and lignin monomers as well as their derivatives; such as, vanillin, p-coumaryl alcohol, coniferyl alcohol, sinapyl alcohol have been consistently identified in extracts. It should be remembered that the concentration or amount of these compounds in an extract and the application rate can impact the resulting biological effect. Thus, concentration level changes in an extract or application rate of an extract with a specific compound concentration may switch a compound between the categories of growth-promoting compound, growth-inhibiting compound, and neutral compound.

### G. Benefit of Target Compounds for Plant Growth Promoting Bacteria

In additional to the benefits shown above, target compounds or groups of target compounds can work to support plant health, growth, and yield, by impacting and supporting soil enhancing organisms, particularly beneficial or symbiotic microorganisms, such as plant growth promoting bacteria (PGPB) & fungi. These beneficial microorganisms can include, but are not limited to, plant growth promoting rhizobacteria, free-living and nodule-forming nitrogen-fixing bacteria, organic decomposers, nitrifying bacteria, phosphate solubilizing bacteria, biocontrol agents, bioremediation agents, archea, actinomycetes, thermophilic bacteria, purple sulfur bacteria, cyanobacteria, saprotrophic fungi, biocontrol fungi, ectomycorrhizae, endomycorrhizae, ericoid mycorrhizae, and arbuscular mycorrhizal fungi (AMF).

### 1. PGPB

PGPB may promote plant growth either by direct stimulation such as iron chelation, phosphate solubilization, nitrogen fixation and phytohormone production or by indirect stimulation, such as suppression of plant pathogens and induction of resistance in host plants against pathogens. In addition, some beneficial bacteria produce enzymes (including chitinases, cellulases, -1,3 glucanases, proteases, and lipases) that can lyse a portion of the cell walls of many pathogenic fungi. PGPB that synthesize one or more of these enzymes have been found to have biocontrol activity against a range of pathogenic fungi including Botrytis cinerea, Sclerotium rolfsii, Fusarium oxysporum, Phytophthora spp., Rhizoctonia solani, Pythium ultimum.

Additionally, bacteria communicate via the distribution of signaling molecules which trigger a variety of behaviors like swarming (rapid surface colonization), nodulation (nitrogen fixation), and virulence. For example, a signaling molecule that is involved in quorum sensing-multicellular-like cross-talk found in prokaryotes can be bound to the surface of biochars. Signaling molecules may be used to manipulate the behavior of the bacteria. An example of such a use would be molecules which inhibit cell-to-cell communication and could be useful in hindering plant pathogens. Creating biochars with signaling molecules could be used to engineer specific responses from various naturally occurring bacteria or could be applied with the bacteria that one is trying to establish in the ecosystem.

Mycorrhizal fungi, including but not limited to Endomycorrhizae and Ectomycorrhizae, are known to be an important component of soil life. The mutualistic association between the fungi and the plant can be particularly helpful in improving plant survivability in nutrient-poor soils, plant resistance to diseases, e.g. microbial soil-borne pathogens, and plant resistance to contaminated soils, e.g. soils with high metal concentrations. Since mycorrhizal root systems significantly increase the absorbing area of plant roots, introducing mycorrhizal fungi may also reduce water and fertilizer requirements for plants.

Typically mycorrhizae are introduced into soil as a liquid formulation or as a solid in powder or granular form and contain dormant mycorrhizal spores and/or colonized root fragments. Often the most economic and efficient method is to treat the seeds themselves, but dealing with traditional liquid and powder inoculums to coat the seed can be difficult. Another method is by placing the mycorrhizae inoculum in the soil near the seeding or established plant but is more costly and has delayed response as the plants initial roots form without a mycorrhizal system. This is because the dormant mycorrhizae are only activated when they come close enough to living roots which exude a signaling chemical. Thus, applying inoculant with or near fertilizers with readily available phosphorus levels can impede the desired mycorrhizal fungi growth. A third option is to dip plant roots into an inoculant solution prior to replanting, but this is costly as it is both labor and time intensive and only applicable to transplanting.

If the colonization of mycorrhizae can be quickened and the density of the mycorrhizae's hyphal network can be increased then the beneficial results of mycorrhizal root systems, e.g. increased growth, increased survivability, reduced water, and reduced fertilizer needs, can be realized sooner. Prior art shows that compost, compost teas, humates, and fish fertilizers can improve microbial activities and in more recent studies have shown physically combining arbuscular mycorrhizal fungi (AMF) inoculant with raw biochar has resulted in additional plant yield compared to each alone. See Hammer, et. al. Biochar Increases Arbuscular Mycorrhizal Plant Growth Enhancement and Ameliorates Salinity Stress, Applied Soil Ecology Vol 96, November 2015 (pg. 114-121).

Similarly, it should be noted that signaling molecules specific to mycorrhizal fungi can also expedite the colonization of the mycorrhizal fungi to plants, as it can bring mycorrhizae out of dormancy quicker and thus establish the mycorrhizal root system quicker.

### 2. Evidence of Microbial Biochar Interactions

Biotechnology, specifically the use of biological organisms, usually microorganisms, to address chemical, industrial, medica, or agricultural problems is a growing field with new applications being discovered daily. To date, much research has focused on identifying, developing, producing and deploying microbes for various uses. However, despite significant work on the microbes themselves, relatively little work has been performed on how to encourage the successful establishment of these microbes in their targeted environment.

Biochars have a proclivity to interact positively with many microbes relevant to plant health, animal health, and human public health applications. In fact, there has been a level of initial research focused on inoculating biochar with microbes and/or using biochar in conjunction with microbes or materials with microbes, e.g. compost. See U.S. Pat. No. 8,317,891.

Research has shown a substantial increase in PGPB growth and distribution resulting from being infused in biochar. For example, data resulting from research conducted to compare the effects upon CO2 production (an indicator of bacterial growth) using peat and biochars show the beneficial effects of using various biochars in promoting PGPB growth. As illustrated in the left-hand chart in FIG. 57, peat results in CO2 production of between approximately 10% and 30% (depending upon the grown medium), whereas biochars result in CO2 production of approximately 48% and 80%. Replicated experimental results using different biochars confirm CO2 production of approximately 30% to 70% (depending on the grown medium), as compared to approximately 10% to 20% for the peat control.

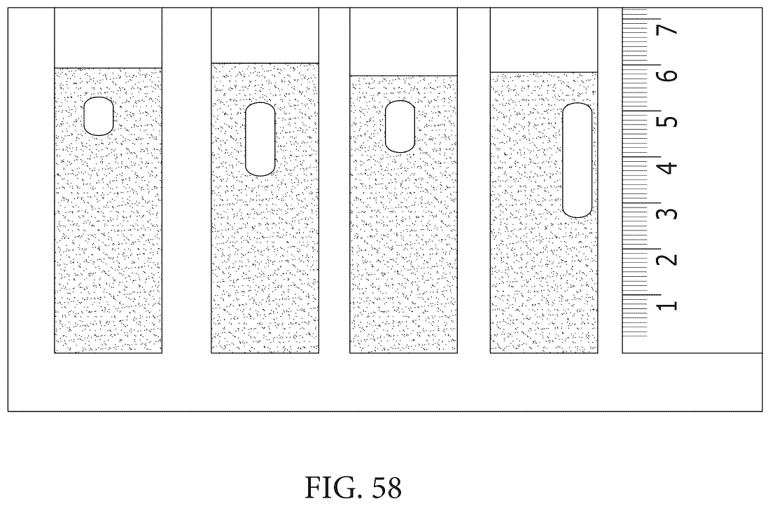

The method developed for determining this CO2 production as an indicator of bacterial growth consists of the following. The substrate, here biochar or peat, is sterilized by heating at 110 C for 15 hours. A bacterial stock solution is then created, here Tryptic Soy Broth was solidified with agar at 1.5% w/v in petri plates to isolate the gram negative non-pathogenic organism Escherichia coli ATCC 51813 (15 h growth at 37° C.). Then an isolated colony is captured with an inoculating loop and suspend in 10 ml sterile buffer (phosphate buffer saline or equivalent) to create the bacterial stock solution. Lactose containing assays are then used, here, test tubes that contain 13 ml of either Lauryl Tryptose Broth (LTB) or Brilliant Green Broth (BGB) that also contain a Durham tube. A negative control is generated by adding 10 μL of sterile buffer to triplicate sets of LTB and BGB tubes. A positive control is generated by adding 10 μL of bacterial stock solution to triplicate sets of LTB and BGB tubes. A negative substrate is generated by adding 1.25 ml (˜1% v/v) of sterile substrate to triplicate sets of LTB and BGB tubes. A positive substrate is generated by adding 1.25 ml (˜1% v/v) of sterile substrate and 10 μL of bacterial stock solution to triplicate sets of LTB and BGB tubes. The tubes of the four treatments are then incubated statically in a test tube rack at 37° C. for at least 15 h. The tubes are then carefully observed and any gas bubbles captured by the Durham tube within respective LTB or BGB tubes are closely measured with a ruler. Small bubbles <0.2 mm should not be considered. A continuous bubble as shown in individual tubes in FIG. 58 are what are observed and quantified. FIG. 58 is an example of carbon dioxide production captured as a continuous gas bubble in BGB (left two tubes) and LTB (right two tubes) growth medium. The percent carbon dioxide production is then calculated by dividing the recorded bubble length by the total Durham tube length and multiplying by 100.

Further tests were conducted using the Streptomyces lidicus WYEC 108 bacterium found in one of the commercially available products sold under the Actinovate brand. Actinovate products are biofungicides that protect against many common foliar and soil-borne diseases found in outdoor crops, greenhouses and nurseries. The formulations are water-soluble.

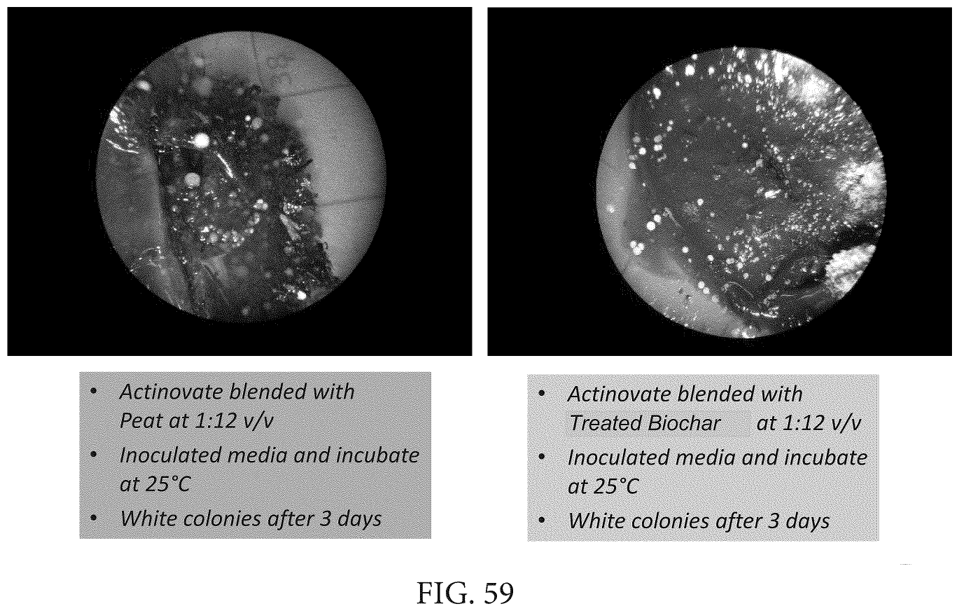

FIG. 59 illustrates the effects upon the growth of Streptomyces lidicus using conventional peat versus biochars. In the test illustrated by the photograph on the left of FIG. 59, an Actinovate powder was blended with peat, placed in an inoculated media and incubated at 25° C. The photograph shows the distribution and density of white colonies after 3 days. In the test illustrated by the photograph on the right of FIG. 59, an Actinovate powder was blended with the treated biochar, placed in an inoculated media and incubated at 25° C. The photograph also shows the distribution and density of white colonies after 3 days, the distribution and density of which are significantly greater than those achieved with peat.

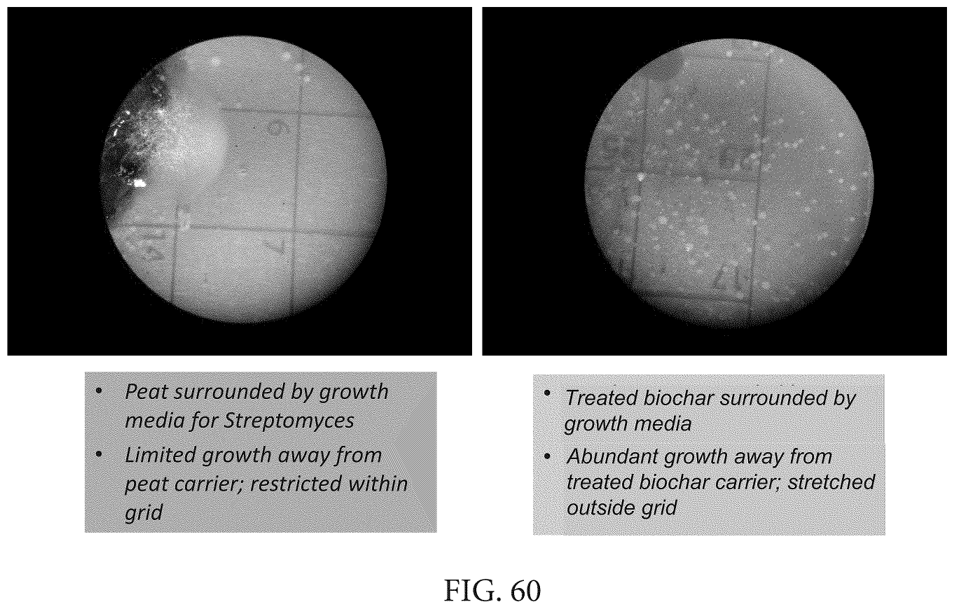

FIG. 60 further illustrates the improved growth of the Actinovate bacterium using biochar versus peat. The left photograph shows only limited and restricted growth away from the peat carrier. The right photograph shows abundant growth of the bacterium spread much farther out from the biochar carrier.

To date biochar's positive impact on soil microbes have been focused on its many physical properties that make it interesting as a microbial habitat. The most obvious of these is its porosity (most biochars have a surface area of over 100 m2/g and total porosity of 0.10 cm3/cm3 or above). Furthermore, many biochars have significant water holding and nutrient retention characteristics that may be beneficial to microbes. However, biochars may also contain compounds that can promote beneficial microorganism growth and/or compounds that are deleterious to the microorganisms.

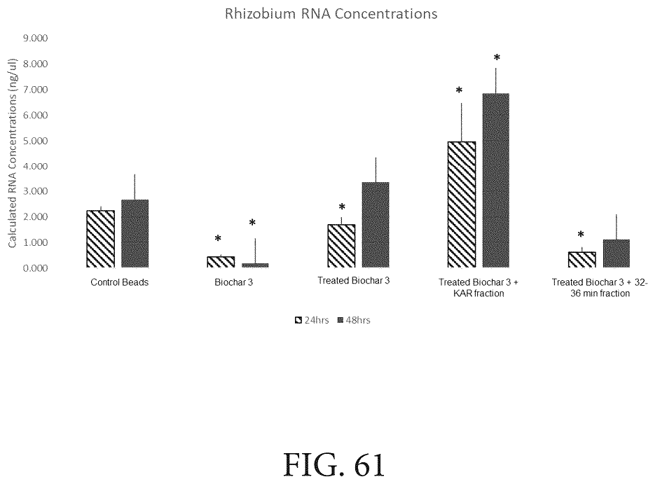

To demonstrate compounds found in biochars can impact beneficial microorganism growth and can be extracted, testing was done with rhizobium. Biochar 3 showed deleterious impacts, reducing microbial growth compared to porous glass control beads with similar porosity and surface area. However, these deleterious impacts were eliminated following solvent extraction of the biochar. In other words, biochar 3, post extraction, showed similar retention to the control beads. Next, a beneficial extract fraction removed from biochar 1 was added to the solvent-extracted (“cleaned”) biochar 3. With the addition of the beneficial compounds in the biochar 1 extract, the cleaned biochar 3 now showed significant increases in rhizobium populations. Finally, as a check a separate deleterious fraction from biochar 1 was added to a cleaned biochar 3 and it showed significant reductions in rhizobium populations at 24 hours, and numerical decreases at 48 hours after inoculation, FIG. 61 which is a chart showing the Rhizobium RNA Concentrations at 24 and 48 hours of the various biochars and the control. These results demonstrate that residual, extractable compounds found on biochars can impact microbial populations. This also demonstrates the potential to take advantage of the variability in soluble compounds on differing biochars by adjusting feedstock, pyrolysis method/conditions, and extraction methods to create specific compounds and/or extracts with potentially highly differentiated impacts on microbial populations.

Further, the same organic solvent derived extract of biochar 3 was found to promote the development of a consortium of microbial species when mixed at an ˜200:3:3 ratio of water, extract, and inoculum, as shown by the below table:

| Sample | CFU/ml |
|---|---|
| H₂O | 0 |
| Inoculum | 4.50E+05 |
| Inoculum + Biochar 3 | 3.25E+06 |
| Extract | |

### H. Biochar Extract Composition

Based upon extensive research and the production of various biochars, it has been determined that extracts suitable for use at rates of 0.1 to 5 oz per 100 lbs of common monocots should exhibit a pH between 3 and 5 and more preferably between 3 and 4. The acetic acid number should be 0.1 and 2 and preferably between 0.5 and 2 mg KOH/mL. The total acid number should be between 0.2 and 5 and preferably between 0.75 and 5 mg KOH/mL solution. The table below shows the various ranges for different biochars from different suppliers and whether a biostimulating effect was seen. From these results, the above references ranges for the acetic acid number and total acid number were derived.

| | | | | Acetic | Acetic | |
|---|---|---|---|---|---|---|
| | | | | Acid | Acid | |
| | | Acetic | Total | Number/ | Number | |
| | | Acid | Acid | Total | of test | |
| | | Number | Number | Acid | Solution | |
| | Post- | (mg KOH/ | (mg KOH/ | Number | (mg KOH/g | Biostimulating |
| Biochar | Treatment | g char) | g char) | (%) | solution) | Effect Seen |
| Softwood Char from | Mild Wet | 10.300 | 12.360 | 83% | 0.515 | Yes |
| Commercial Equipment | Oxidation | | | | | |
| Supplier A | | | | | | |
| Softwood Char from | None | 0.606 | 1.454 | 42% | 0.636 | Yes |
| Commercial Equipment | | | | | | |
| Supplier B | | | | | | |
| Softwood Char from | None | 0.741 | 1.482 | 50% | 0.515 | Yes |
| Commercial Char | | | | | | |
| Supplier C | | | | | | |
| Softwood Char from | Mild Wet | 0.898 | 2.113 | 43% | 0.584 | Yes |
| Commercial Char | Oxidation | | | | | |
| Supplier C | | | | | | |
| Softwood Char from | None | 0.321 | 1.071 | 30% | 0.305 | No |
| Commercial Char | | | | | | |
| Supplier D | | | | | | |
| Softwood Char from | Mild Wet | 22.069 | 33.103 | 67% | 0.499 | Yes |
| Commercial Char | Oxidation | | | | | |
| Supplier E | | | | | | |

When used at rates below 10 fl oz per cwt seeds or 32 fl oz per acre, the humic acid concentration should be greater than 0.1 g/L and preferably between 0.1 and 10 g/L and more preferably 0.2 and 5 g/L as determined by the CDFA method. When used at rates below 10 fl oz per cwt seeds or 32 fl oz per acre, fulvic acid concentrations, as determined by the LAMAR method, should be greater than 0.1 g/L and preferably between 0.1 and 10 g/L and more preferably between 0.2 and 2 g/L.

Extract solutions may be soluble in water modified carrier solution, or may be suspended as a microemulsion, either natively or through use of additives such as surfactants. Preferably these microemulsions are of less than 1 μm in diameter and more preferably less than 0.5 μm in diameter. Microemulsions should be stable between 4 C and 40 C and prevent flocculation or reaction of suspended chemistry.

Extract solutions may contain additional extractable components in addition to humic and fulvic acids. The total extractable content determined by loss on weight by drying at 105° C. Total extractable content may be between 0.1 and 20 g/L and preferably between 0.5 and 10 g/L.

Analysis of extract solutions may, alternatively, be performed by visible light spectroscopy. To perform an analysis, solutions should be dissolved in an equal volume of a polar organic solvent, such as acetone, acetonitrile, methanol, ethanol or isopropyl alcohol. The visible light absorbance at 450 nm should be been 0.02 and 4 units/cm and preferably between 0.16 and 1.6 units/cm, where absorption exceeds instrument dilution may be used to determine adsorption values of the solution.

Biochar extracts may include additional plant stimulating compounds from the categories butenolides, (example Karrikin) anhydrosugars, (example levoglucosan) carboxylic acids (example, vanillic acid), fatty acids (example palmitic and linoleic acid), alkanes, phenols (including methoxy-phenols and ethoxy-phenols), ketones, aldehydes (example, vanillin), phenylpropanoids (example cinnamic acid and aldehyde, coniferyl acid and aldehyde), phenylalanine, coumarins, flavonoids, sterols, terpenes, terpenoids, and tannins. These compounds should be between 1-1000 ppm in solutions and preferably between 10 and 500 ppm in solution.

In cases where a biochar extract concentrate is used in preparation of a final treatment formulation, those skilled in the art will recognize that all proportional increases and decreases in the biochar extract concentrations are covered by, and included in the scope of the invention. For example: A biochar extract concentrate designed to be diluted 1 part to 50 in water and applied at 1 oz per 100 lbs of seed may contain one or more of the following conforming compositions:

| | | |
|---|---|---|
| Humic Acid | 5-500 | g/L |
| Fulvic Acid | 5-500 | g/L |
| Beneficial Compounds | .0005-5 | g/L |
| Karrikin | 50-1000 | ppb |
| Total Biochar Extracts | 5-1000 | g/L |

Higher or lower biochar extract concentrations may produce different dilution ratios and/or application rates, however, the final treatment formulation will generally remain proportionally the same. As such, increasing or decreasing extract concentrations will cause any departure in the scope of the invention, as the proportional formulation of the biochar concentrates will remain the same-only the dilution ratios and application rates will vary.

It is desirable to have Karrikin levels in biochar extract greater than 1 ppt, more preferably greater than 0.005 ppb, even more preferably greater than 0.05 ppb, or even more preferably greater than 0.5 ppb. In fact, having concentrations greater than 1 ppb or even greater than 1 ppm could also be desirable. This is because in application the extract can be diluted to get to the right application rate to see the desired effect.

### I. Applications

The raw biochars, treated biochars and biochar extracts produced in accordance with the present invention, such that their composition provides increased target compounds and/or little or no undesired compounds can be used in various applications. The below includes, but is not limited to, various applications for use of the raw biochars, treated biochars and biochar extracts such as coating seeds, creating biochar solutions, creating biochar slurry and/or creating biochar aggregates, all of which are described in the following U.S. Pat. No. 11,130,715 (Biochar Coated Seeds), U.S. Pat. No. 10,550,044 (Biochar Coated Seeds), U.S. Pat. No. 10,472,298 (Biochar Coated Seeds), U.S. Pat. No. 11,180,428 (Biochar Coated Seeds), U.S. Pat. No. 11,180,428 (Biochar Suspended Solution), U.S. Pat. No. 10,472,298 (Biochar Suspended Solution), U.S. Pat. No. 10,059,634 (Biochar Suspended Solution), U.S. Pat. No. 10,065,163 (Biochar Extracts) and U.S. Pat. No. 10,265,670 (Biochar Extracts), all of which are incorporated in this application by reference, but also summarized below. Raw biochars, treated biochars and extracts may include use as a seed treatment, foliar application, or soil application for plants that may include row crops, specialty crops, fiber crops, cover crops, oil crops, turf grasses, potted plants, flowering plants, cannabis, annuals, perennials, evergreens and seedlings.

### A. Biochar Coated Seeds

Application of treated biochar and even the raw biochar greatly assists with the reduction of water and/or nutrient application, and the ability of biochar to carry nutrients, microbes, both, or a combination of these and other beneficial substances. It has been discovered that these same benefits can be imparted to plant growth by coating the seeds themselves with biochar prior to planting as well as providing a more efficient way of delivering the biochar to the area of the germinating seed. Coating the seeds prior to planting can dramatically reduce the need for high frequency saturation watering in the period immediately following installation. Coating particles with biochar can provide a more efficient biochar delivery system.

One example method to coat the seeds with biochar may be accomplished generally by (i) creating a slurry of biochar and starch binder, (ii) immersing the seeds in the slurry, and (iii) then drying the seeds. Optionally, a biochar extract can be used to coat the seeds in the same manner as described.

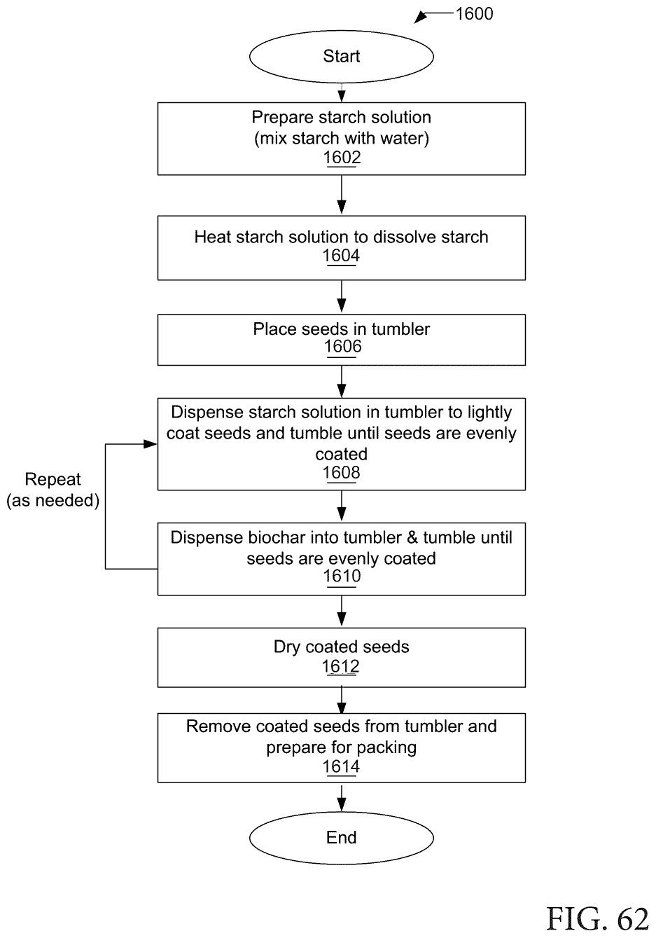

FIG. 62 is a flow diagram 1600 of an example of a method that may be used for coating seeds with biochar. The steps comprise: (i) preparing a starch solution (or binding solution) by mixing a starch (or a binder) with water to create a solution, step 1602; (ii) heating the starch solution to dissolve the starch, step 1604; (iii) placing seeds in a rotary tumbler, step 1606; (iv) dispensing the starch solution into the tumbler to coat seeds in a manner that lightly introduces the solution to the tumbler, step 1608; (v) tumbling the seeds until the seeds are evenly coated with the starch solution, step 1610; (vi) dispensing biochar in the tumbler to coat the seeds with biochar, step 1612; and (vi) drying the coated seeds while tumbling, step 1614.

At step 1602, the starch solution is prepared by mixing a starch or other binder with water. If the hydrophobicity of the biochar has been reduced during treatment, water alone can also be used as a binder. Corn starch is a simple example of a type of starch that may be used, although one skilled in the art will realize that there are many binders that can be used, such as starches, sugars, gum arabic, cellulose, clay, or polymers such as vinyl polymers, or a combination of these. The binder solution may be prepared by mixing enough corn starch with deionized H₂O to create a solution. For example, the starch may be approximately 2% by weight, but may range from 0.5% to 10% of starch by weight. Other starches, such as corn starch may be used as a binder, or other binders such as gelatins, cellulose, sugars, or combinations thereof may be used.

At step 1604, the starch solution is then heated to dissolve the starch. At step 1606, the seeds are then placed in a tumbler, such as a rotary tumbler and the tumbler is prepared for introduction of the starch (or other binder) solution. The seeds are then lightly sprayed with starch solution and tumbled with the starch solution until they are evenly coated with the starch/binder solution. Then, at step 1610, the biochar may be added to the tumbler. Prior to adding to the tumbler, the biochar may be prepared by reducing it to a power or pulverized to an average particle size of <1 mm. The method of sizing the biochar may be grinding, pulverizing, crushing, fracturing using ultrasonic, chemical, thermal, or pressure mechanisms, sieving, hydrodynamically sorting, attritting, or any combination of these.

Prior to adding the biochar, if necessary, the powered biochar may be dried at a temperature of at or about 120 degrees C. Additionally, beneficial macro- and micro-nutrients such as nitrogen, phosphorous, potassium, calcium, magnesium, sulfur, boron, zinc, iron, manganese, molybdenum, copper and chloride or starter fertilizers using ammonium nitrate, ammonium sulfate, monoammonium phosphate, or ammonium polyphosphate with added micronutrients can be added to the mixture at this time. Optionally, the biochar may have been already infused with these nutrients, beneficial microbes, or even the binder solution itself during the treatment process outlined earlier. In some applications, the biochar may have already been infused with a substance that will react with the binder added in this step to provide a more functional two stage biodegradable adhesive such as those outlined in U.S. Pat. No. 8,895,052 or others which perform in similar manner. These types of adhesives function in a similar manner to common epoxies, but demonstrate biodegradable characteristics that may make them more suitable for agricultural applications.

The mixture may also be heated or cooled during this stage to enhance or improve either the performance of the binder or maintain the inoculant (if used) at a proper temperature to assure efficacy. When adding to the tumbler, the powered biochar is sprinkled or otherwise dispensed into the tumbler until the seeds are coated, step 1612.

If a thicker coating of biochar is desired, then steps 1608 and 1610 may be repeated. Each of the layers of biochar may optionally be infused with the same, different, or zero nutrients, microbes, or other beneficial substances, causing the layers the be the same or causing them to be different or varied. If nutrients are added, they may also be layered during this process such that nutrients most beneficial to early germination and seedling growth are incorporated onto the biochar coated seeds. For example, these steps may be repeated, as necessary, to assure consistent coating to an average thickness of 0.01 to 100 times the diameter of the seed. Once the desired coating thickness is achieved, the coated seeds may then be dried and prepared for packing.

Optionally, a fertilizer, nutrient or microbial carrier (other than biochar) may be added to coat the seeds in any of the layers, including but not limited to: ammonium nitrate, ammonium sulfate, monoammonium phosphate, ammonium polyphosphate, Cal-Mag fertilizers or micronutrient fertilizers. Other additives, such as fungicides, insecticides, nematicides, plant hormones, beneficial microbial spores, or secondary signal activators, may also be added to the coating in a similar manner as a fertilizer.

The above is only one example of how seeds may be coated with biochar prior to use as a soil amendment. Other mechanisms and processes that may be used to coat seeds. Further, coating may be used on any type of plant seed, including, but not limited to, the following: grass, corn, wheat, soybeans, sugar beet, ornamental plant, vegetable, such as tomato, cucumber, squash, or lettuce, or any other plant commonly grown from seeds.

When the coated seeds are grass seeds, the coated seeds may then be applied using normal seeding techniques at the rate of between 500-1000 lbs. per acre for lawns or ornamental applications, ranges of between 15 and 4000 lbs. per acre may also be used without departing from the scope of the invention. For pasture grass applications, the application rate is typically lower, generally between 15-100 lbs. per acre.

The utility of coating the seeds with the biochar is that the biochar creates a protective “oasis” of water and nutrient retention around the seed to provide a more constant supply of available water and nutrients to the seedling during germination and initial growth. Coating seeds also allows for much easier application of biochar to the turf environment. It should be noted that coated seeds can also be used in “overseeding” applications for existing turf-namely applications where seeds are added to either increase the density of existing turf, or to establish an annual turf (e.g. rye) during a season where the perennial turf is dormant. Additionally, the seeds may be coated with treated biochar pre-infused with either nutrients, or microbial agents, such as mycorrhizal fungi, biocontrol bacteria or fungus, plant growth promoting rhizobacteria, mineral solubilizing microorganisms, or other microbes which demonstrate efficacy in turf grass environments.

The biochar increases the water and nutrient holding capacity of the immediate surroundings of the seed. Biochar applied in the manner described above results in more vigorous root development and increased establishment time leading to healthier plants with increased disease resistance compared to plants from seeds absent the biochar coating. Coating seeds in this manner can also be a greatly improved mechanism for delivery of both biochar as well as any nutrient or microbe infused into the biochar into the soil as the delivery can be accomplished simultaneously with the delivery of the seed into the soil.

Furthermore, the present invention may be used to coat other particles, besides seeds, with biochar. A solid or semi-solid particle, such as a small stone, polymer bead, biodegradable plastic pellet, fragment of a mineral such as perlite, or other particle that displays generally uniform distribution in particle size when seen in aggregation may be coated in the same manner as the seeds (described above) to assist with the distribution of biochar, or treated biochar, in a more efficient manner. This method may be used to produce biochar pellets in a manner that does not rely on heat or pressure treatment. Thus, coating particles, as set forth above, can avoid many issues associated with maintaining efficacy of microbes or less stable nutrients or microbial energy sources when making pellets from biochar or treated biochar without a core particle.

Additionally, the particle coated may also be an ingestible particle, such as animal feed pellets, medicines, vitamins or other nutrients or feed particles. Coating such ingestible particles with biochar or treated biochar may assist in the addition of biochar or treated biochar into the animal food chain and assist in the use of the biochar or treated biochar in animal health applications. When coating an ingestible particle, additives may also be included with or infused into pores of the coated biochar, through mixing, treatment, or both. By way of example only, particles for use in the present invention may be any type of particles that can be safely ingested or safely used in connection with agricultural applications. Optimally, such particles will range in size from 50 to 0.001 millimeters in diameter.

### B. Biochar Solution

It has been discovered that these same benefits can be imparted to agricultural growth through the production and application of biochar suspended solutions as described below. The creation of biochar suspended solutions prevents the potential for wind to blow biochar dust or fines, thus reducing biochar losses and allowing more uniform application and distribution. Furthermore, the biochar suspended solution, being wet, allows for greater penetration through the soil and allows for more accessibility for the roots of plants to garner the biochar's advantageous physical/chemical properties.

Further, biochar may be more effectively applied if the biochar is in suspension in solution. The biochar, prior to being put in suspension in solution, may be raw or treated, as described above. If the biochar is treated, not only can the pH be adjusted as needed, as discussed above, but also fertilizers, microbes, and host of other additives may be infused in the biochar prior to suspension in solution (as further described below). However, regardless of whether the biochar is raw or treated, the present application for the suspension of biochar in solution can be utilized for both.

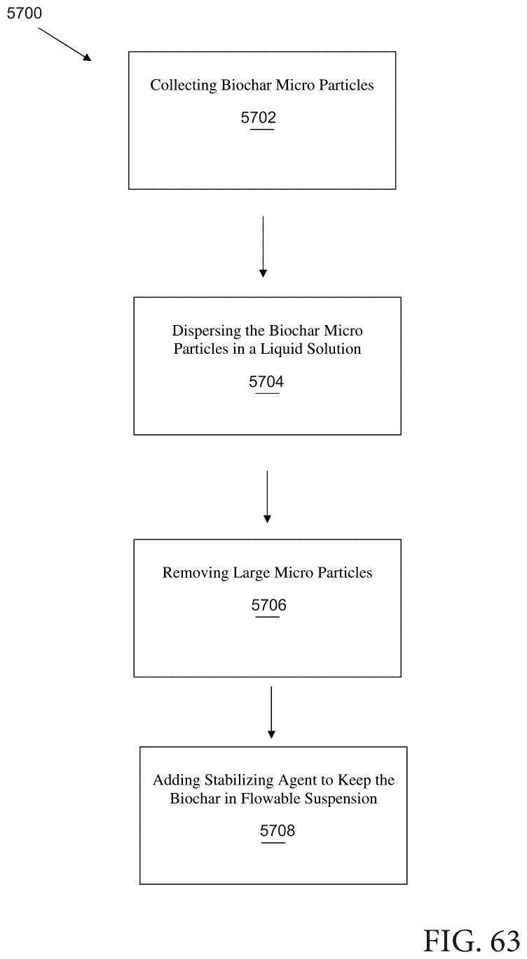

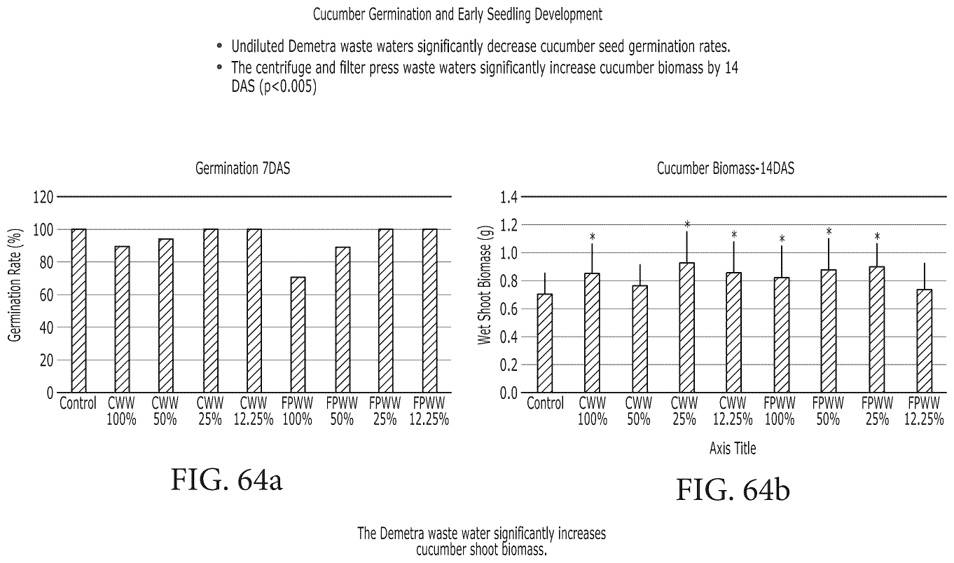

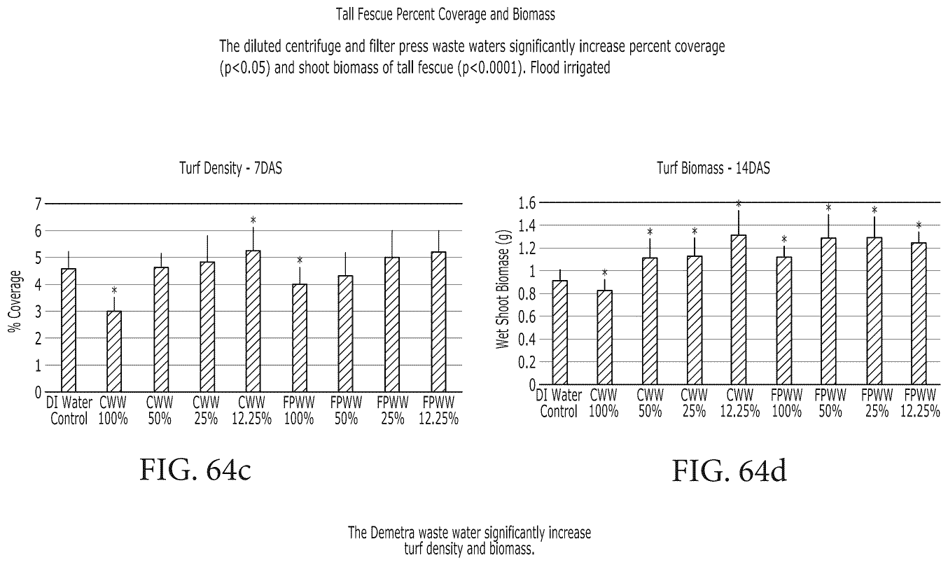

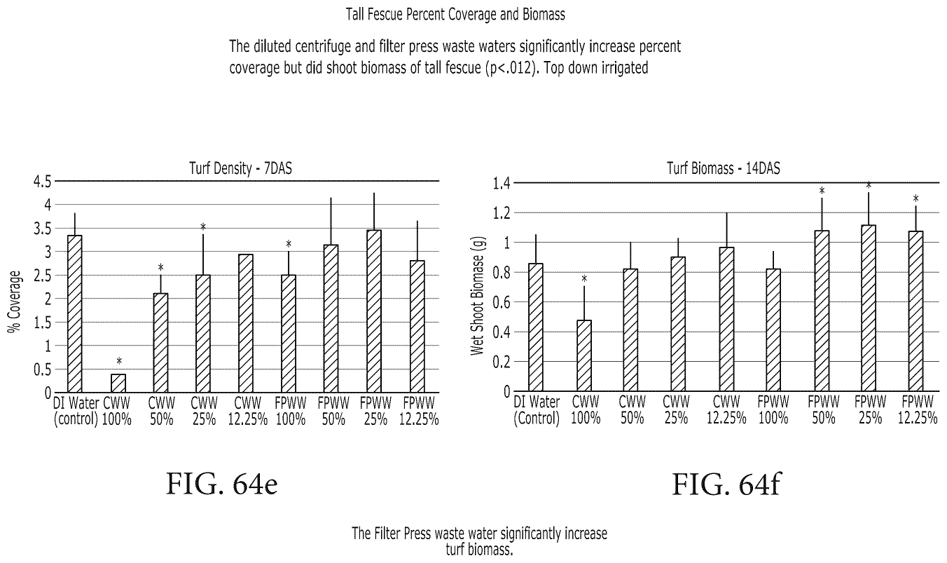

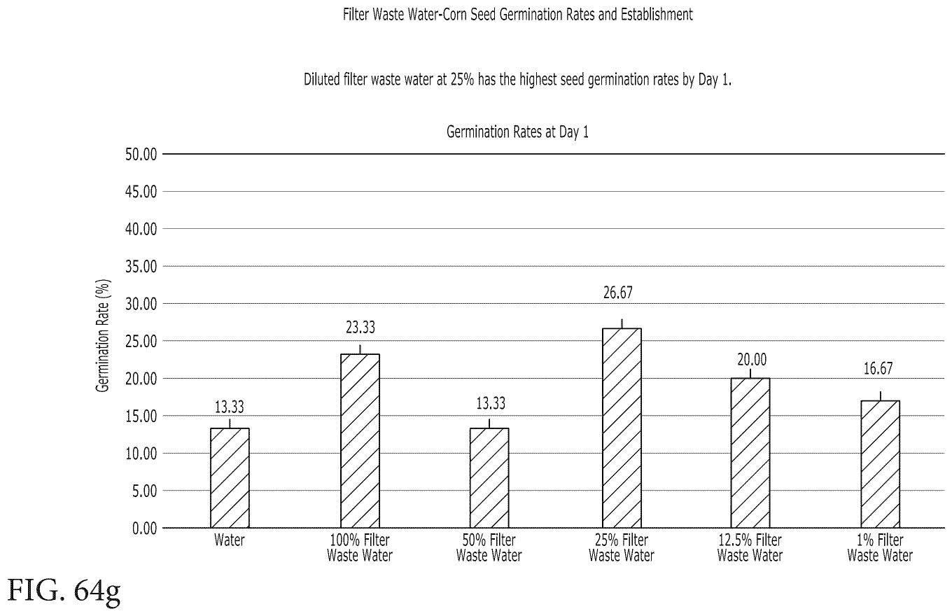

FIG. 63 is a flow diagram of an example of a method that may be used for producing biochar solutions. A “biochar solution” or “biochar suspended solution” shall mean biochar that has been added or suspended in a liquid, alone or in combination with other additives. In general, the method of producing liquid products containing biochar may be accomplished by sufficiently de-sizing the biochar to pass through nozzles and/or mesh screens, dispersing the biochar in solution, such as water, and adding xanthan gum and/or other additives to keep the biochar in suspension, in solution.

At step 5702, biochar particles, either treated or raw, are collected for use in solution. The biochar particles may be collected in any number of ways, including but not limited to: (i) flow from a centrifuge effluent, (ii) from biochar granular product, or (ii) a combination of both a centrifuge effluent and granulated product. In all cases, the collected biochar may be passed to a media mill, air impingement, burr grinder, or other grinding, milling, or particle sizing equipment for production of smaller particles. The media mill or other similar equipment (e.g., attritor mill) allows for the de-sizing of the biochar product through dry and/or wet grinding. Micro particles may also be collected directly by traditional desizing equipment, including but not limited to hammer mills and grinders. Those skilled in the art will recognize that other desizing equipment, such as impellers, ultrasonic mechanisms, vibrators, shakers, or other devices besides hammer mills and grinders may be used to produce and collect biochar micro particles. Flocculants such as polyacrylamide can also be used at levels of 1000 ppm or less to collect the micro particles and to create a biochar micro particle cake. The residual amount of flocculant left in the micro particle cake will vary depending on the amount of flocculant that leaves with the liquid. Those skilled in the art will recognize that other flocculants, besides polyacrylamide may be used to clump the biochar particles together and other agents besides flocculants may be used to separate the solid micro particles from liquid for storing, transporting, or other purposes. Differences or variation in liquid or gas flow speed, rate, or pressure may also be used to sort particles based on their hydrodynamic or aerodynamic properties.

At step 5704, the biochar micro particles may then be dispersed in a liquid solution to create a biocarbon solution having a biochar solid content of approximately 1-75%, most desirable ranges between 15-70%. The liquid solution may include, but not be limited to, water, deionized water, liquid fertilizer and/or any combination thereof. Other liquid and/or solid additives may also be included in solution. Once mixed in solution, the resulting biochar solution may then be passed through nozzles and mesh screens to remove any large biochar particles from the solution, at step 5706. Those skilled in the art will also recognize that the step of filtering out the larger particles may alternatively occur prior to or during the collection process (at step 5702).

To best hold the biochar in suspension, biochar micro particle sizes of about 0.5 mm or less may be desired or may depend on the method of application. For example, if applying biochar suspended solution with irrigation equipment, less than 0.05 mm, 0.025 mm, 0.01 mm, or even less may be desired, whereas less than 1 mm, 0.5 mm, 0.2 mm, or even less than 0.1 mm may be desired if applying biochar suspended solution with varying types of fertilizer equipment.

It should be noted that the pH of the biochar solution can affect how much biochar particles will stay in solution and the viscosity of said solution. Thus, it may be beneficial to add an acid or base before, during, or after these steps.

At step 5708, a stabilizing agent may then be added to keep the biochar in flowable suspension and prevent it from settling. The stabilizing agent can include xanthan gum at about 0.1% to 0.7% by weight to the solution or it can vary depending on the solids already in solution, the percentage of solids in solution and/or the particle size of the biochar used to create the solution.

Alternative natural or synthetic agents with pseudoplastic rheology capable of suspending biocarbon particles in solution may also be added at this step such as alkali swellable acrylic thickeners, inorganic substances, surfactants or other water born thickeners. Isothiazolin type preservatives could also be added to prevent biological degradation of the xanthan gum. For example, 50 ppm of active Kathon™ LX 1.5% biocide may be added to protect the xanthan gum. Those skilled in the art will recognize that other preservatives may be used to prevent biological degradation of the xanthan gum. Those skilled in the art will also recognize that the step of adding stabilizing agents may alternatively occur prior to, during, or after the collection process (at step 5702).

For example, the stabilizing agent could be added prior to the creation of the suspended biochar solution by mixing or spraying the agents on dry biochar particles either prior or post micro particle collection process. In fact, they could even be added or infuse into the biochar during the treatment processes. This could allow for the production, transport, and/or sale of a dry or semi-dry biochar product that could then be turned into a solution after production, for example at the time of sale or just prior to application at say the farm where it will be applied. Similarly, the process of adjusting the density of the biochar can be combined with the process of adding stabilizing agents or thickeners.

Depending on the thickener or stabilizing agent used at step 5708, a preservative may also be added to ensure an optimal product with long shelf life. Choosing the right preservative is important as the biochar itself can absorb certain preservatives and thus allow unwanted microbiological growth in the solution over time. Potential preservatives that may be used are polymeric preservatives such as poly quats or formaldehyde emitter preservatives. Chlorine based preservatives are not generally used as the biochar can degrade chlorine in a short amount of time. Another option to avoid biochar solution degradation is to choose a stabilizing agent that will not rot or encourage microbiological growth in the solution. One example of this is clay based thickeners such as Attagel and Veegum. An exception to this would be cases in which microbial agents are to be inoculated on or suspended with the biochar itself. A third option is to not create the solution until right before it will be used, for example at the time of sale or at the time of application. The shorter shelf-life reduces chances of solution degradation.

Optionally, growth enhancing additives, including but not limited to, fertilizers, liquid micronutrients, liquid manure, liquefied compost or compost “tea”, compost extract and beneficial microbes can be added to the biochar solution. These additives may be added either prior, during, or after the suspended biochar solution is created. For example, the additive may be infused into the biochar prior to creating the solution using vacuum infiltration or a surfactant as further described above. Alternatively, or in addition to infusing the biochar with additives, additives may be included with the biochar solution described above prior, during or after creation of the biochar solution.

Other additives, such as fungicides, insecticides, nematicides, plant hormones, beneficial microbial spores, or secondary signal activators, may also be added to the solution in a similar manner as a fertilizer, the inclusion of which does not depart from the scope of the invention. Additionally, beneficial macro- and micro-nutrients such as nitrogen, phosphorous, potassium, calcium, magnesium, sulfur, boron, zinc, iron, manganese, molybdenum, copper and chloride can be added to the suspended biochar solution. As set forth above, in addition to adding these to solution, such additives can be infused into the biochar prior to creating the solution.

Examples of compounds, in addition to fertilizer, that may be mixed with the biochar solution or infused into the biochar prior to creating the solution include, but are not limited to: 2,1,3-Benzothiadiazole (BTH), an inducer of systemic acquired resistance that confers broad spectrum disease resistance (including soil borne pathogens); signaling agents similar to BTH in mechanism or structure that protects against a broad range or specific plant pathogens; biopesticides; herbicides; and fungicides.

### C. Biochar Slurry

An alternative method for creating a biochar solution is to instead make a biochar slurry using a process similar to hydromulching or hydroseeding. With this method the size reduction step can be reduced or eliminated since the process is typically applicable for larger particle sizes in which the resulting slurry is applied through pumps and sprays. For this application method typically the granular biochar will be mixed with water, fiber mulch, and optionally a tackifier at time of application and then sprayed to area needed. In addition, it can be mixed with fertilizer, seeds, or other additives including dyes to help aid in uniform distribution. Typical hydroseeding and hydromulching equipment may be used and generally include a tank mounted truck that is equipped with a special pump and continuous agitation system. The pump then pushes the slurry though a hose and nozzle for application. To create a biochar slurry for this application the fiber mulch is usually a cellulose based material which can be made from shredded waste paper sources and can include dyes, binders, or other additives. The optional tackifier can include but is not limited to guar gum, xanthan gum, plantago gum, methyl cellulose, pectin, lignin, seedmeals, such as camelina or lesquerella, polysaccharide gums, or starches, such as corn starch. The addition of a tackifier increases the biochar slurry's effectiveness especially when applied on a slope, on an area that is erosion prone, or other areas that would cause concern of the biochar application being washed away due to rain or irrigation. If the slurry is to be made significantly prior to application then a preservative would likely be needed as well to ensure a longer shelf life. Otherwise the biochar, fiber, and tackifier can be mixed dry and then turned into a slurry just prior to application or even onsite, similarly to current practices of hydromulching and hydroseeding. This biochar slurry may be particularly useful in turf and landscape applications where hydroseeding or hydromulching is already being used. In the case of turf particularly, it could be either mixed with grass seeds prior to application or applied immediately prior to the hydroseeding application. A process similar to this can be used for mixing the biochar with manure to create a manure slurry, either in lagoons, or at any point prior to application of the manure.

### D. Aggregate Biochars

It has been discovered that the same benefits can be achieved through the production and application of biochar aggregate particles as biochar particles that have not been aggregated. The creation of biochar aggregate particles, however, allows for easier product distribution for in various applications including industrial agricultural equipment, and provides a highly beneficial use for the biochar dust and fines, which are generally discarded. In this same manner, biochar aggregate particles may be produced for use for consumption by animals or use in composting.

In one example of an implementation, the biochar aggregate particles may be created from pyrolyzed wood or cellulosic biomass, as described above. The resulting biochar fines or dust are then removed from the other biochar particles. The fines may optionally be washed with a treatment solution, as described in detail above. The treatment solution may, for example, be added to neutralize the biochar pH levels, as needed, depending upon the pH of the biochar fines. A neutralized biochar slurry is then exposed to a de-watering station and a flocculent is added to coagulate the fines or dust for de-watering. To dewater the flocculent slurry, a belt filter press or other equipment known to the art may be used. Once dewatered, a starch or another suitable binder is added to the biochar particles. Other additives may also be added to the biochar particles during this step. The biochar particles are again de-watered and the slurry becomes a thicker slurry or paste. The de-watered biochar paste may then be formed into aggregate solids by, for example, the use of an extruder. The aggregate particles are then dried.

### E. Other Applications

Those skilled in the art will recognize that there are many other mechanisms and processes that may be used to produce biochars, biochar aggregates, biochar solutions, biochar slurries and biochar extracts without departing from the scope of the invention. Those skilled in the art will further recognize that the present invention can be used on any type of seed, plant, or soil application, including, but not limited to, the following: row crops, specialty crops, fiber crops, cover crops, oilseed crops, biofuel crops, turf grasses, potted plants, flowering plants, cannabis, annuals, perennials, evergreens and seedlings.

When solution based, extracts or solutions can uniformly apply the solution or extract through the use of pumps, sprays and various other types of equipment capable of handling liquid dispersion. For example, sprayers, booms, and misting heads can be an efficient way to apply the biochar solution to a large area, while backpacks or hose sprayers can be sufficient for smaller applications. Aside from spraying applications, biochar solution or extracts may also be pumped through the ground to eliminate the potential for wind erosion while allowing for faster infiltration into the soil. Furthermore, biochar solution and extracts can be used in connection with a variety of equipment used for hydroseeding, manure spreading (either solid or liquid), foliar spraying, irrigation, or other liquid application technologies. As there are so many different options to apply biochar suspended solutions or solution, much time and expense can be saved.

In addition, the use of a biochar extracts and biochar suspended solution can allow for more efficient and focused applications to ensure the biochar treatment stays in the root zone, or is deployed in the vicinity of juvenile or developing root tissue, thus reducing the amount of biochar needed on a cubic yard per acre basis. For example, if the biochar solution is put through irrigation tape that is laid directly in a row crop bed the biochar will only be treating the root zones of said crop in the beds and not the row crop furrows nor above or below the root zone in the bed. Not only does this lessen the cost by reducing the amount of biochar needed it also can lessen the cost of the application method itself as it can be applied using the same equipment that may already be available for irrigation and liquid fertilizer application.

The application of the biochar solution can be used for trees, row crops, vines, turf grasses, potted plants, flowering plants, annuals, perennials, evergreens and seedlings. The biochar solution may be incorporated into or around the root zone of a plant at ratios of between 1:999 to 1:1. However, an application does not necessarily need to be restricted or limited to these ratios. Biochar can be added to soil at a concentration of 0.01% up to 99% depending upon the application, plant type and plant size. As most trees, rows, and specialty crops extract greater than 90% of their water from the first twenty-four inches below the soil surface, the above applications will generally be effective incorporating the biochar around the root zone from the top surface of the soil and up to a depth of 24″ below the top surface of the soil, depending on the plant type and species, or alternatively, within a 24″ radius surrounding the roots regardless of root depth or proximity from the top surface of the soil. When the plant roots are closer to the surface, the incorporation of the biochar within the top 2-6″ inches of the soil surface may also be effective. Greater depths are more beneficial for plants having larger root zones, such as trees.

The biochar suspended solution may also be applied to animal pens, bedding, and/or other areas where animal waste is present to reduce odor and emission of unpleasant or undesirable vapors. Furthermore it may be applied to compost piles to reduce odor, emissions, and temperature or even to areas where fertilizer or pesticide runoff is occurring to slow or inhibit leaching and runoff. In some instances, it may even be mixed with animal feed, fed to animals directly as a liquid, or used in aquaculture applications.

Biochar solution may also be utilized and applied through irrigation equipment for both low flow and high flow irrigation systems. For the purpose of this application, “low flow system” includes but is not limited to micro sprays, drip emitters, and drip lines and “high flow systems” includes but is not limited to fixed sprays, rotors, bubblers, and soaker hoses. Although the utilization of the chemical and physical properties of biochar for optimal plant growth would ideally be most effective when applied to plants during their peak growing cycle, all of the applications discussed above can be applied at any time during the different stages of plant growth or ground preparation as needed. Similarly, the methods of application can be repeated as many times as needed from year to year depending on factors not limited to plant type, climate, soil properties, topography, and light. In summary, when any type of liquid is applied to the plants such as water or liquid fertilizer, the suspended biochar solution can be added to the liquid in order to provide further soil enhancement characteristics.

### J. Use and Application of Biochar Extract

With particular regard to biochar extract, as set forth above, a key application of extracts is to promote plant growth. FIGS. 643a-g, show results from biochar extracts used in germination and growth tests with cucumbers, tall fescue, and corn seeds. The extract was shown to statistically improve cucumber biomass growth 14 days after seeding and turf biomass growth 14 days after seeding when flood irrigated or top down irrigated. The extract also showed improved corn seed germination rates.

As shown above, different biomass sources and different post-treatment process may be more effective than others for use on different cultivars and varieties of plants as well as at what stage of development for the plant, such as at seed germination, early plant development, at transplant, at propagation through cuttings, or in conjunction with certain microbials. The biomass, the biochar extract source and the post-treatment processes, including extraction and purification steps, may also be varied to achieve different results depending upon the purpose for which the biochar or extract is being used which may include improvement of germination, early plant development and growth, or enhanced plant-microbial interactions.

When improved germination and early plant growth are desired, a liquid biochar extract could be applied directly to seeds as a seed treatment, either in an upstream, commercial setting or downstream by a seed conditioner or retail applicator. It could also be applied directly to soil, either broadcast or in-furrow, at the time of planting. These applications could be stand alone or could be applied in combination with fertilizers, fungicides, insecticides, plant growth regulators, biostimulants, biologicals, or biorationals.

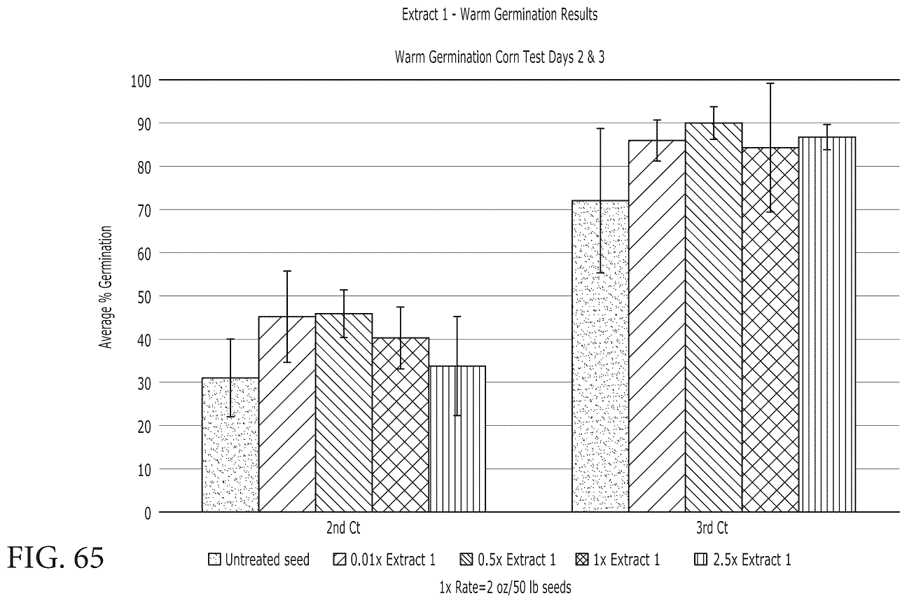

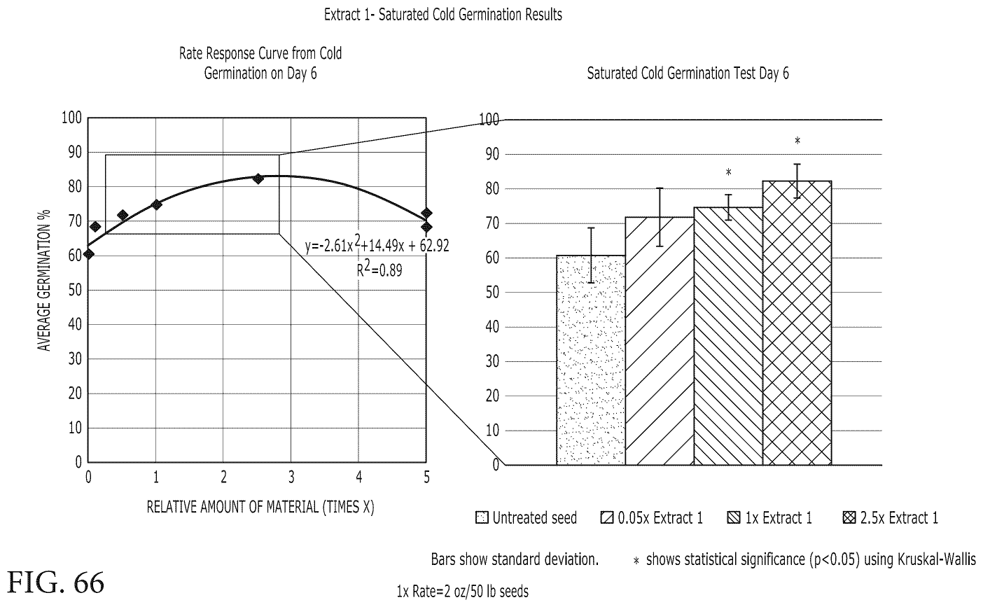

To test seed treatment application, corn seeds were treated (coated) with various biochar extracts and then put into standard replicated warm and saturated cold germination tests, where daily counts and evaluations were made through first 6 days of germination. Quicker germination was seen with Extract 1 treated seeds at various application rates versus the untreated seeds, particularly when comparing average percent of germinated seeds on days 2 & 3 as depicted in FIG. 65. The best performing rate in this test for this extract, which was not concentrated or diluted after extraction, was 2 oz of extract per 50 lbs of corn seed, but there was not a strong rate response seen. However, as seen in FIG. 66, the same extract in the saturated cold germination test showed a strong rate response on day 6 and the most improved germination was seen with the 5 oz/50 lbs of corn seed. Germination improvement on day 6 for both the 5 oz/50 lbs and the 2 oz/50 lbs of Extract 1 were statistically significant.

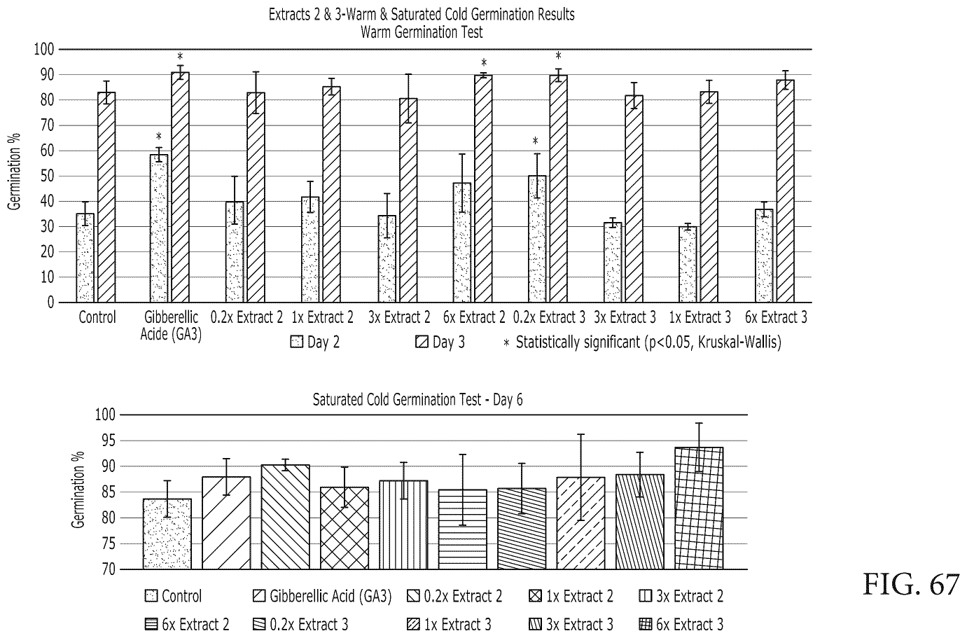

An additional test was done to compare two biochar extracts made from two different biochars (different biomass feedstocks and different pyrolysis methods) and two different extraction methods. The chosen extraction method was specifically developed for each biochar to find the best germination-promoting extract for that specific biochar without additional purification for corn seeds. In addition, the biochar extract treated seeds were compared to both untreated seeds and a commercially available gibberellic acid (GA3), a plant hormone that regulates growth and currently used to improve germination. Results from warm germination testing and saturated cold germination testing are depicted in FIG. 67. As can be seen in the results, Extract 2 and Extract 3 were able to outperform the untreated seed control at different application rates. A 1× rate here is equivalent to 1 oz of extract/50 lb seeds. Even though the two extracts had different compounds, different starting biochars, and different extraction methods, a customized extraction process could be made to get improved results in the warm and saturated cold germination tests over the control, that were similar to GA3.

These tests show that commercially viable extracts can be made for seed treatment application at application rates that are commonly used by seed companies. An individual signaling compound's or combined signaling compounds' concentrations in a biochar extract can be as low as 1 ppt, 1 ppb, or 0.01 ppm and can be as high as 10 ppm, 100 ppm, or 1000 ppm. In addition, a biochar extract application rate for seed treatment could be as high as 10 oz/100 lb seeds, 502/100 lb seeds, 2 oz/100 lb seeds and as low as 0.01 oz/100 lb seeds, 0.1 oz/100 lb seeds, or 0.5 oz/100 lb seeds. For in-furrow application to soil and seeds at planting, similar concentrations for individual or combined signaling compounds in a biochar extract can be used: as low as 1 ppt, 1 ppb, or 0.01 ppm and can be as high as 10 ppm, 100 ppm, or 1000 ppm. In-furrow application rates can be as low as 0.1 oz/acre, 0.5 oz/acre, or 1 oz/acre and as high as 25 oz/acre, 10 oz/acre, or 5 oz/acre.

Besides applying biochar extracts directly to seeds or soil, by itself, they could also be applied in combination with other agricultural products, such as fertilizers, fungicides, insecticides, plant growth regulators, biostimulants, biologicals, or biorationals. Another option would be to apply a biochar extract to another agricultural product after production or include it into the production of the other agricultural product, prior to application of the agricultural product. These agricultural products could include but are not limited to granular fertilizers, compost, biochar, or inert carriers (e.g. clay, cellulose, peat). Again the extract could be combined with other agricultural products, such as microbial inoculants, insecticides, fungicides, fertilizers, plant growth regulators, biostimulants, biologicals, or biorationals.

Biochar extracts could also be applied to plant roots prior to transplant (i.e., root dip) or broadcast as a foliar spray alone or in combination with other agricultural products as described above, for example, as part of water irrigation system. This is particularly useful in systems such as hydroponics and vertical farming.

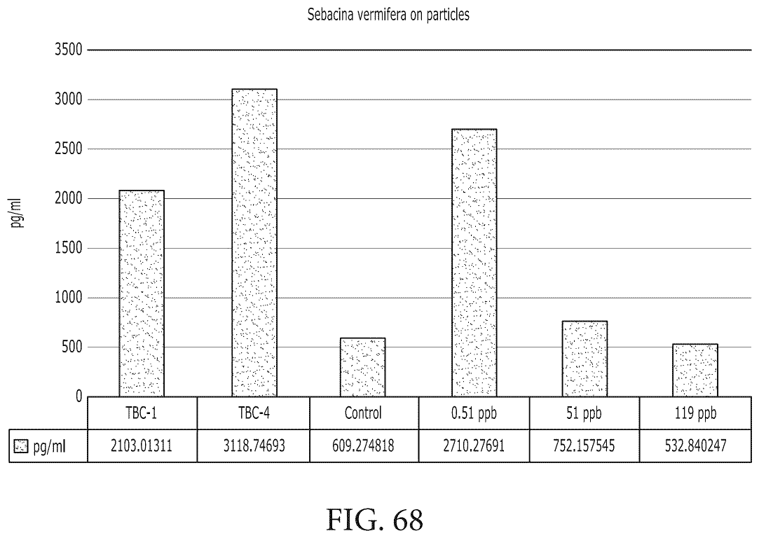

Biochar extracts with signaling compounds could be designed for specific plants or crops, including but not limited to row crops like corn, cotton, soybeans, wheat, rice and other cercal crops as well as vegetable crops, like tomatoes, bell peppers, carrots, broccoli, and lettuce, to nursery and ornamental plants, and to turf and forage grasses. Signaling compounds may have other applications other than promoting plant growth directly. Previous research has shown that signaling compounds, such as karrikins, may also modulate plant-microbial interactions, such as with arbuscular mycorrhizal fungi or bacteria. See Gutjahr C, et al., Rice perception of symbiotic arbuscular mycorrhizal fungi requires the karrikin receptor complex, Dec. 18, 2015, Science and Mandabi A., et al, Karrikins from plant smoke modulate bacterial quorum sensing, May 25, 2014, Chem Commun (Camb). FIG. 68 shows results of an experiment growing a mycorrhizal fungus, Sebacina vermifera, which is known for its plant growth promoting abilities. Treated Biochar 1 (TBC-1) and Treated Biochar 4 (TBC-4) were compared to glass bead controls and glass beads loaded with a reference karrikin (KAR₁) at various concentrations (0.51 ppb, 51 ppb, and 119 ppb). A plug of Sebacina vermifera was placed in the middle of each material (biochar or glass beads) and incubated for three weeks. Following incubation, RNA was extracted from the material and analyzed through qPCR to determine the amount of Sebacina vermifera in pg/ml on each material. As seen in FIG. 68, both vacuum treated biochars, from different biomass feedstocks, and the reference karrikin at 0.5 showed an order of magnitude improvement in sebacina growth over the glass bead control, whereas the references with higher levels of karrikin showed similar levels of growth to the control. In addition, TBC-4 showed almost 50% more growth than TBC-1 and slightly more growth than the 0.51 ppb KAR₁ reference. Recalling FIG. 32, TBC-1 had 47 ppb KAR₁ and Biochar 4, prior to treatment, had approximately 0.49 ppb. These results again likely point to karrikin availability in the biochars, inhibitor compound interactions, or being a factor as TBC-1 significantly outperformed the 51-ppb reference despite having similar amounts of KAR₁. These results highlight the potential for soluble signaling molecules to impact microbial growth, but they may need to be available at lower levels for impact.

In summary, as shown above, biochar and biochar extracts can be produced with higher levels of karrikins than previously found to exist by selecting the biomass and controlling the pyrolysis parameters and processes. By controlling the biomass from which the biochar is created and by establishing predetermined, pyrolysis processes and parameters proved to yield the highest soluble signaling compounds bound to the biochar, biochar with soluble signaling compounds may be achieved. For example, as illustrated above, it is possible to create biochars with concentrations of more than 10 ng/g, more than 20 ng/g, more than 40 ng/g, or more than 100 ng/g of KAR₁. These soluble signaling compounds in the biochars or in extracts from the biochars can be used to enhance seed germination and early plant development or microbial growth. Further, post-treatment processing of biochar can be used to adjust the levels of these signaling compounds, such as karrikins, and increase their availability in order to make the resulting biochars more effective. Such post-treatment process may include all the various treatments described above, which may include, but are not limited to, vacuum treatment, surfactant treatment, solvent extraction, placing the biochar in suspension or in a slurry, introducing further additives and/or adding of the extracts back with, on, or into the biochars. The biochar or extracts from the biochar can also be used in creating products in a granular, slurry, or liquid form that can be used in various applications including but not limited to soil treatments, plant treatments, or seed treatments.

Both signaling compounds and other residual biochar compounds may lend themselves to other applications. One example is creating a biochar extract to add to an inert microbial carrier, such as biochar, peat, clay, cellulose, or another material, prior to or in conjunction with inoculation to improve microbial loading or reduce the decay curve, thus improving shelf-life of the microbial product. Another example is to create a biochar extract that is designed as an anti-microbial or anti-fungal additive. Another example is to be able to create a biochar extract that is a natural or organic insecticide, fungicide, or herbicide. Other uses may come in incorporating into animal feed or into composting process, to get similar results seen from adding biochar itself.

As set forth above, the biochars or the biochar extracts outlined herein, of the present invention may be used in various agriculture activities, as well as other activities and in other fields. Additionally, the biochars or extracts may be used, for example, with: farming systems and technologies, operations or activities that may be developed in the future; and with such existing systems, operations or activities which may be modified, in part, based on the teachings of this specification. Further, the various biochars, extracts, and treatment processes set forth in this specification may be used with each other in different and various combinations. Thus, for example, the processes and resulting biochar compositions provided in the various examples provided in this specification may be used with each other; and the scope of protection afforded the present inventions should not be limited to any particular example, process, configuration, application or arrangement that is set forth in a particular example or figure.

Although this specification focuses on applications related to the production and optimization of biochars and their extracts, it should be understood that the materials, compositions, structures, apparatus, methods, and systems, taught and disclosed herein, may have applications and uses for many other activities in addition to agriculture for example, in pharmaceuticals, as additives, and in remediation activities, among other things. It is understood that one or more of these may be preferred for one application, and another of these may be preferred for a different application. Thus, these are only a general list of preferred features and are not required, necessary and may not be preferred in all applications and uses.

It is noted that there is no requirement to provide or address the theory underlying the novel and groundbreaking functionality, performance or other beneficial features and properties that are the subject of, or associated with, implementations of the present inventions. Nevertheless, to the extent that various theories are provided in this specification it is done to further advance the art in this important area. These theories put forth in this specification, unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the functionality, performance or other beneficial features and properties that are the subject of, or associated with, embodiments of the methods, articles, materials, and devices of the present inventions; and such later developed theories shall not limit the scope of protection afforded the present inventions.

Those skilled in the art will recognize that there are other methods that may be used to create, treat, and use biochar in a manner that creates and uses desirable residual chemicals without departing from the scope of the invention. The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. A method for producing biochar having bio stimulating effects, the method comprising steps of:
obtaining a biomass source from the group consisting of woods, straw, corn stover, bagasse, and nut shells;
pyrolyzing the biomass source at two or more distinct heating temperatures where the first heating temperature results in a biomass surface temperature of at least 375° C. for a hold time that does not heat the center of biomass source above 250° C., and where at least one subsequent heating temperature results in the core of the biomass reaching no more than 350° C.
collecting biochar produced by pyrolyzing the biomass source.

2. The method of claim 1 where pyrolyzing the biomass at the first heating temperature includes the step of placing the biomass source in a reactor at a temperature ranging from 400 to 600° C. and where in the at least one subsequent heating temperature the reactor temperature is cooler than the first heating temperature.

3. The method of claim 2, where the at least one subsequent heating temperature ranges from 200-500° C.

4. The method of claim 1 further including the step of adding raw biomass to the biomass being pyrolyzed before heating the biomass source the at least one subsequent heating temperature.

5. The method of claim 4 where the raw biomass is wood.

6. The method of claim 1 where the obtained biomass source is coconut shells or wood.

7. (canceled)

8. The method of claim 1 where the collected biochar is oxidized after the biomass is pyrolyzed.

9. The method of claim 8 where the biochar is oxidized through drying the biochar at temperatures of at least 100° C.

10. The method of claim 1 where during the step of pyrolyzing the biomass source an inert sweep gas is introduced to reduce vapor residence time and dilute oxygen is added to assist with maintaining pyrolysis temperature.

11. Biochar that has been produced in accordance with the method of claim 43 to have increased bio stimulating effects, the biochar comprising:
biochar that has been pyrolyzed from a selected biomass source from the group consisting of woods, straw, corn stover, bagasse, and nut shells and pyrolyzed to at conditions to engineer the biochar production to cause the biochar to have a total acid number of 1.0 to 100 mg KOH/g biochar.

12. The biochar of claim 11 where the biochar has a total acid number of 10 to 50 mg KOH/g biochar.

13. The biochar of claim 11 where more than 40% of the Total Acid Number of the provided biochar is attributed to carboxylic groups.

14. The biochar of claim 11 where at least 50% of the Total Acid Number of the provided biochar is attributed to carboxylic groups.

15. The biochar of claim 11 where at least 60% of the Total Acid Number of the provided biochar is attributed to carboxylic groups.

16. (canceled)

17. (canceled)

18. (canceled)

19. Biochar that has been produced in accordance with the method of claim 43 to have increased bio stimulating effects, the biochar comprising:
biochar that has been pyrolyzed from a selected biomass source from the group consisting of woods, straw, corn stover, bagasse, and nut shells and pyrolyzed to at conditions to engineer the biochar production to cause the biochar, based upon the deconvolution of a TGA spectrum to contain volatile matter content ranging from 20-40% of the biochar.

20. The biochar of claim 19 where the volatile matter content ranges from 25-35% of the biochar.

21. The biochar of claim 19 where the percentage of the volatile matter content in the biochar is composed of the following:
10-35% of volatile mater as cellulose/hemicellulose
10-35% of volatile matter as Lignin
10-35% of highly volatile biochar
<15% volatile biochar
Less than 5% low molecular weight volatile compounds.

22. The biochar of claim 21 where the percentage of the volatile matter content in the biochar is composed of the following:
15-30% cellulose/hemicellulose
15-30% Lignin
15-30% highly volatile biochar
<10% Volatile biochar
And less than 3% as low molecular weight volatile compounds.

23. Biochar that has been produced in accordance with the method of claim 43 to have increased bio stimulating effects, the biochar comprising:
biochar that has been pyrolyzed from a selected biomass source from the group consisting of woods, straw, corn stover, bagasse, and nut shells and pyrolyzed to at conditions to engineer the biochar production to cause the biochar to having levels of heavy metals, heavy metals, polycyclic aromatic hydrocarbons (PAHs), and polychlorinated biphenyls (PCBs) at or below regulatory limits.

24. Biochar that has been produced in accordance with the method of claim 43 to have increased bio stimulating effects, the biochar comprising:
biochar that has been pyrolyzed from a selected biomass source from the group consisting of woods, straw, corn stover, bagasse, and nut shells and pyrolyzed to at conditions to engineer the biochar production to cause the biochar to have one or more of the following compounds: salicylic acid, jasmonic acid, abscisic acid, cytokinins, auxins, gibberellic acids and ethylene.

25. The biochar of claim 24, where the biochar is used for one of more of the following: seed treatment, particle coating, agricultural applications and horticultural applications.

26-42. (canceled)

43. A method for producing biochar having bio stimulating effects, the method comprising steps of:
obtaining a biomass source from the group consisting of woods, straw, corn stover, bagasse, and nut shells;
pyrolyzing the biomass source at at least a first and second distinct heating temperature where raw biomass is added to the biomass source pyrolized at a first heating temperature before heating the biomass source at the second distinct heating temperature; and
collecting biochar produced by pyrolyzing the biomass source.

44. The method of claim 43, where the raw biomass is wood.

45. The method of claim 43 where the obtained biomass source is coconut shells or wood.

46. (canceled)

47. Biochar that has been produced in accordance with the method of claim 43 to having increased bio stimulating effects, the biochar comprising:
biochar that has been pyrolyzed from a selected biomass source from the group consisting of woods, straw, corn stover, bagasse, and nut shells and pyrolyzed to at conditions to engineer the biochar production to cause the biochar to have one or more of the following compounds: butenolides, anhydrosugars, carboxylic acids, fatty acids, alkanes, phenols, ketones, aldehydes, phenylpropanoids, phenylalanine, coumarins, flavonoids, sterols, terpenes, terpenoids, and tannins⋅salicylic acid, jasmonic acid, abscisic acid, cytokinins, auxins, gibberellic acids and ethylene.

48. The biochar of claim 47, where the biochar is used for one of more of the following: seed treatment, particle coating, agricultural applications and horticultural applications.

49. (canceled)

50. (canceled)
